(19) United States
(12) Patent Application Publication
(10) Pub. No.: US 2026/0094995 A1
(43) Pub. Date: Apr. 2, 2026

(54) RELIABLE, VERSATILE, MODULAR ELECTRICAL CONNECTOR AND MODULE THEREOF

(71) Applicant: Amphenol East Asia Electronic Technology (Shenzhen) Co., Ltd., Shenzhen (CN)

(72) Inventors: Danren He, Shenzhen (CN); Zhenbo Liu, Shenzhen (CN); Koen Maddens, Hofstade (BE)

(73) Assignee: Amphenol East Asia Electronic Technology (Shenzhen) Co., Ltd., Shenzhen (CN)

(21) Appl. No.: 19/341,372

(22) Filed: Sep. 26, 2025

(30) Foreign Application Priority Data
Sep. 30, 2024 (CN) 202411403126.3
Sep. 30, 2024 (CN) 202422404537.6
Jan. 8, 2025 (CN) 202510031746.7
Jan. 8, 2025 (CN) 202520059262.9

(51) Int. Cl. H01R 13/629; H01R 12/72; H01R 13/504; H01R 13/627; H01R 13/641; H01R 27/02

(52) U.S. Cl. CPC H01R 13/62944; H01R 12/722; H01R 13/504; H01R 13/6271; H01R 13/62977; H01R 13/62994; H01R 13/641; H01R 27/02

(57) ABSTRACT

Reliable, versatile, modular electrical connectors and modules thereof. A connector includes a housing and multiple types of modules. The housing includes latches for retaining the modules in position and key members for module type indication and preventing insertion of wrong modules. A module can include multiple types of power terminals and one or more types of signal terminals. Module housing can be configured for retaining the multiple types of terminals in position. For a plug configuration, the connector can include a cover attached to the housing, a locking member attached to the cover and pivotable between a pre-locked position and a locked position, a slider movable by the locking member in a direction perpendicular to a connector mating direction after the insertion of a mating component, and a CPA movable from a pre-installed position to an installed position for retaining the locking member at the locked position.

### CROSS-REFERENCE TO RELATED APPLICATIONS

This application claims priority to and the benefit of Chinese Patent Application No. 202520059262.9, filed on Jan. 8, 2025. This application also claims priority to and the benefit of Chinese Patent Application No. 202510031746.7, filed on Jan. 8, 2025. This application also claims priority to and the benefit of Chinese Patent Application No. 202411403126.3, filed on Sep. 30, 2024. This application also claims priority to and the benefit of Chinese Patent Application No. 202422404537.6, filed on Sep. 30, 2024. The contents of these applications are incorporated herein by reference in their entirety.

### TECHNICAL FIELD

The present application relates generally to interconnection systems, such as those including electrical connectors, used to interconnect electronic assemblies, and more specifically to electrical connectors for harsh environments, such as in a vehicle.

### BACKGROUND

Electrical connectors are used in many electronic systems. It is generally easier and more cost effective to manufacture an electronic system as separate electronic assemblies, which may be joined together with electrical connectors. Electrical connectors may be used to interconnect assemblies so that the assemblies may operate together as part of the electronic system. For example, the electrical connectors may be mounted on circuit boards within two assemblies, and the two assemblies are connected by mating the electrical connectors. In other electronic systems, it may not be practical to join circuit boards by directly mating electrical connectors on two circuit boards. For example, when assembling an electronic system, these circuit boards may be spaced apart by a very large distance, and direct connections cannot be made between the electrical connectors mounted on these circuit boards.

In some electronic systems, connections between assemblies may be made by cables. The cables may be terminated with an electrical connector, which may be mated with an electrical connector mounted on a circuit board. In this way, connections between assemblies may be made by plugging an electrical connector, which is part of a cable assembly, into an electrical connector mounted on the circuit board. In other electronic system architectures, an electrical connector terminated with a cable may be mated with another electrical connector terminated with another cable.

An example of an electronic system in which assemblies are connected by cables is a modern automobile. For example, automobiles include electronic control units (ECUs) for controlling a variety of different vehicle systems, such as those for engines, transmission control units (TCUs), security systems, emissions control, lighting, advanced driver assistance systems (ADASs), entertainment systems, navigation systems, and cameras. These electronic control units may be manufactured as separate assemblies and connected over one or more vehicle networks formed with cables routed between these assemblies. To simplify the manufacture of an automobile, the assemblies may be manufactured separately and then connected via cables terminated with electrical connectors, which enable connections to mating electrical connectors terminated with other cables or attached to circuit boards within the assemblies.

Such electrical connectors are typically designed and manufactured according to specific specifications to achieve mating with each other and to meet signal and/or power transmission requirements. Designing electrical connectors that meet the needs of a specific application brings a variety of challenges. Electrical connectors must have a variety of characteristics that meet the mechanical requirements of the electronic system.

### SUMMARY

Aspects of the present disclosure relate to reliable, versatile, modular electrical connectors and modules thereof.

Some embodiments relate to an electrical connector. The electrical connector may comprise a housing comprising a groove elongated in a longitudinal direction, a first constraint structure at least partially in the groove, and a space with openings at a front and a rear of the housing; a cover attached to the rear of the housing; a locking member attached to the cover and pivotable between a pre-locked position and a locked position; and a slider disposed in the groove of the housing and movable in the longitudinal direction between a first position and a second position by the locking member, the slider comprising a second constraint structure configured to engage the first constraint structure of the housing such that the slider may be constrained to the first position before the second constraint structure of the slider is disengaged from the first constraint structure of the housing.

Optionally, the first constraint structure of the housing and the second constraint structure of the slider are configured to be disengaged from each other by a mating component to the electrical connector.

Optionally, the first constraint structure protrudes into the groove of the housing; and the second constraint structure comprises a resilient arm latched to the first constraint structure at the first position of the slider.

Optionally, the slider comprises a plurality of cam slots extending at an angle to the longitudinal direction, the plurality of cam slots each open at the front of the housing at the first position of the slider so as to receive cam pins of a mating component to the electrical connector, and blocked at the front of the housing at the second position of the slider so as to retain the cam pins of the mating component therein.

Optionally, the cover comprises a side wall, first and second protrusions protruding outwardly from the side wall and positioned such that the locking member is pivotable between the first and second protrusions.

Optionally, the cover comprises a third protrusion configured to engage the locking member and generate an indication that the locking member is at the pre-locked position.

Optionally, the cover comprises a groove and an overhanging structure above the groove; and the electrical connector comprises a connector position assurance (CPA) device disposed in the groove of the cover and partially below the overhanging structure, the CPA device movable between a pre-installed position and an installed position.

Optionally, the CPA device is configured to be held in the pre-installed position by the cover and movable to the installed position by pivoting the locking member to the locked position.

Optionally, the CPA device comprises a resilient arm configured to engage the overhanging structure of the cover so as to be held in the pre-installed position and disengage from the overhanging structure of the cover by the locking member pivoted to the locked position.

Optionally, the electrical connector comprises a plurality of modules disposed in the space of the housing, each of the plurality of modules comprising a module housing and a plurality of conductive terminals held by the module housing, wherein the housing comprises a plurality of latches each configured to engage a respective modules of the plurality of modules.

Optionally, the cover is hinged to the housing so as to permit opening the rear of the housing to exchange a module without disengaging the hinge.

Some embodiments relate to an electrical connector. The electrical connector comprises a housing comprising a plurality of cavities each having opening at a front and a rear of the housing, and a plurality of latches each extending into a respective cavity of the plurality of cavities; a plurality of types of modules, each module of the plurality of types of modules comprising a module housing and a plurality of conductive terminals held by the module housing, each module of the plurality of types of modules engaging a respective latch of the plurality of latches in the respective cavity of the plurality of cavities of the housing; and a plurality of key members removably held by the housing above the plurality of cavities, each of the plurality of key members comprising an identification feature indicating the type of module in a respective cavity of the plurality of cavities.

Optionally, the plurality of key members are disposed adjacent the openings of the plurality of cavities and configured to shape respective openings for respective modules so as to prevent wrong modules from being inserted.

Optionally, the plurality of key members are aligned in a first row in a longitudinal direction and adjacent the rear of the housing; and the plurality of latches of the housing are aligned in a second row adjacent and parallel to the first row.

Optionally, the housing comprises a groove elongated in the longitudinal direction; the electrical connector comprises a slider disposed in the groove of the housing and movable in the longitudinal direction between a first position and a second position; and the slider comprises a plurality of cam slots extending at an angle to the longitudinal direction.

Optionally, the housing comprises a plurality of cam pins aligned in a third row parallel to the first row and separated from the first row of key members by the second row of latches; and each of the plurality of cam pins is disposed between adjacent cavities of the plurality of cavities.

Some embodiments relate to an electrical connector. The electrical connector may comprise a housing member; a plurality of conductive terminals at least partially disposed in the housing member; a locking member attached to the housing member and pivotable between a pre-locked position and a locked position; and a connector position assurance (CPA) device disposed on the housing member, wherein the CPA device is constrained in a pre-installed position by the housing member and movable to an installed position by pivoting the locking member to the locked position.

Optionally, the housing member comprises a groove and an overhanging structure above the groove; and the CPA device comprises a first resilient arm configured to engage the overhanging structure of the housing member so as to be held in the pre-installed position and disengage from the overhanging structure of the housing member by the locking member pivoted to the locked position.

Optionally, the overhanging structure is configured to restrain the locking member in the locked position.

Optionally, the locking member comprises protrusions configured to engage the first resilient arm of the CPA device so as to disengage the first resilient arm of the CPA device from the overhanging structure of the housing member and release the CPA device from the pre-installed position.

Optionally, the housing member comprises a recess configured to limit the movement of a second resilient arm of the CPA so as to restrain the CPA device in the locked position.

Optionally, the overhang structure of the housing member comprises an engagement portion configured to extending into an opening of the CPA device so as to restrain the CPA device in the locked position.

Some embodiments relate to a module for an electrical connector. The module may comprise a housing comprising a plurality of channels extending therethrough; and a plurality of terminals disposed in the plurality of channels of the housing, each of the plurality of terminals comprising a mating end, a tail end, and an intermediate portion between the mating end and the tail end, wherein the plurality of terminals comprise a plurality of types of power terminals, comprising a first type having a first width in a longitudinal direction perpendicular to a mating direction of the module, and a second type having a second width less than the first width in the longitudinal direction; and a plurality of signal terminals having a third width less than the second width in a longitudinal direction.

Optionally, the housing comprises a plurality of resilient arms extending into respective channels of the plurality of channels and engaging respective terminal disposed in the respective channels so as to retain the respective terminals in the respective channels.

Optionally, the module comprises a terminal position assurance (TPA) device attached to a front of the housing, the TPA device comprising a plurality of projections extending to contact respective resilient arms of the housing to restrict deflection of the respective resilient arms.

Optionally, the plurality of resilient arms of the housing are disposed in pairs with a first resilient arm extending into an upper channel and a second resilient arm extending into a lower channel; and the plurality of projections of the TPA device extend between the first and second resilient arms of same pairs.

Some embodiments relate to a method for manufacturing a module housing for an electrical connector. The method may comprise providing a plurality of types of tool pins, each type of the plurality of types of tool pins corresponding to one of a plurality of types of terminals configured to be disposed in the module housing; aligning the plurality of types of tool pins according to desired locations of the plurality of types of terminals; and flowing a housing material around the aligned plurality of types of tool pins to form the module housing.

Optionally, aligning the plurality of types of tool pins according to desired locations of the plurality of types of terminals comprises stacking the plurality of types of tool pins in an organizer.

Optionally, stacking the plurality of types of tool pins in an organizer comprises providing one or more spacers to fill any gap between the plurality of types of tool pins and the organizer.

Optionally, the plurality of types of tool pins comprise a first plurality of types of tool pin, each type of the first plurality of types of tool pins corresponding to one of a first plurality of types of terminals configured to be disposed in a first portion of the module housing, and a second plurality of types of tool pins, each type of the second plurality of types of tool pins corresponding to one of a second plurality of types of terminals configured to be disposed in a second portion of the module housing.

Optionally, the first plurality of types of tool pins are stacked in a first direction; the second plurality of types of tool pins are stacked in the first direction; the first portion and the second portion of the module housing are stacked in a second direction perpendicular to the first direction; and the second plurality of types of tool pins are the same or different from the first plurality of types of tool pins.

Optionally, providing the plurality of types of tool pins comprises providing the plurality of types of tool pins according to the equation:

$$A * {W}_{T 1} + B * {W}_{T 2} + C * {W}_{T 3} + D * {W}_{T 4} \leq {W}_{Max}$$

wherein A is the number of a first-type tool pin, B is the number of a second-type tool pin, C is the number of a third-type tool pin, D is the number of a fourth type tool pin, W_{T1} is a width of the first-type tool pin in the first direction, W_{T2} is a width of the second-type tool pin in the first direction, W_{T3} is a width of the third-type tool pin in the first direction, W_{T4} is a width of the fourth-type tool pin in the first direction, and W_{Max} is equal to a width of a slot of the organizer in the first direction.

Optionally, each of W_{T1}, W_{T2}, W_{T3}, W_{T4} is in a range of 1 mm to 6 mm.

Optionally, W_{Max} is in a range of 20 mm to 25 mm.

Some embodiments relate to an electrical connector. The electrical connector may be configured to establish an electrical connection with a second electrical connector and comprise: a first housing configured for mating with a second housing of the second electrical connector in a mating direction; and a slider disposed in the first housing and configured to be slidable relative to the first housing between a first position and a second position in a sliding direction intersecting the mating direction, the slider comprising a cam slot configured, when the slider is in the first position, to receive a cam pin provided on the second housing so that the second housing is positioned in an initial mating position. The slider is capable of being constrained in the first position by the first housing before the second housing is positioned in the initial mating position.

Optionally, the first housing comprises a first constraint structure, and the slider comprises a second constraint structure, the first constraint structure and the second constraint structure engage with each other when the slider is in the first position and before the second housing is positioned in the initial mating position, so as to restrict the slider from sliding from the first position toward the second position in the sliding direction.

Optionally, one of the first constraint structure and the second constraint structure is configured to be contacted by a release structure provided on the second housing to disengage from the other of the first constraint structure and the second constraint structure when the second housing is positioned in the initial mating position, thereby allowing the slider to slide from the first position toward the second position in the sliding direction.

Optionally, the first housing further comprises a sliding groove configured to accommodate the slider, and the first constraint structure is a beam extending into the sliding groove; the second constraint structure is a resilient arm; and the resilient arm engages with the beam when the slider is in the first position and before the second housing is positioned in the initial mating position, and the resilient arm is contacted by the release structure of the second housing so as to be biased to disengage from the beam when the second housing is positioned in the initial mating position.

Optionally, the first housing further comprises a first receiving groove communicated with the sliding groove and configured to receive the release structure of the second housing when the second housing is positioned in the initial mating position; and a portion of the resilient arm extends into the first receiving groove when the slider is in the first position and before the second housing is positioned in the initial mating position, and the portion of the resilient arm is contacted by the release structure of the second housing when the second housing is positioned in the initial mating position, so that the resilient arm is biased to disengage from the beam.

Optionally, the resilient arm comprises a barb, the barb engages with the beam and extends into the first receiving groove when the slider is in the first position and before the second housing is positioned in the initial mating position, and the barb is contacted by the release structure of the second housing when the second housing is positioned in the initial mating position, so that the resilient arm is biased to disengage from the beam; and a portion of the barb for being contacted by the release structure is formed with a chamfered surface.

Optionally, the first housing further comprises an accommodation portion enclosing an accommodation space for receiving the second housing; the first receiving groove is recessed into the accommodation portion from the accommodation space in a vertical direction perpendicular to the mating direction, and extends in the mating direction; and the release structure is a rib disposed on the second housing and extending in the mating direction.

Optionally, the engagement between the first constraint structure and the second constraint structure further restricts the slider from sliding from the first position in the sliding direction and away from the second position when the slider is in the first position.

Optionally, the slider further comprises a third constraint structure, when the slider is in the first position, the third constraint structure engages with the first constraint structure to restrict the slider from sliding from the first position in the sliding direction and away from the second position.

Optionally, the housing further comprises a fourth constraint structure, when the slider is in the first position, the second constraint structure engages with the fourth constraint structure to restrict the slider from sliding from the first position in the sliding direction and away from the second position.

Optionally, the first housing further comprises a sliding groove extending in the sliding direction and configured to accommodate the slider, when viewed from a cross section perpendicular to the sliding direction, the sliding groove has a first narrower section and a second wider section extending from the first section; and a cross section of the slider perpendicular to the sliding direction and a cross section of the sliding groove perpendicular to the sliding direction match each other in shape, so that the slider is held in the sliding groove and guided by the sliding groove to slide.

Optionally, the first housing further comprises an accommodation portion enclosing an accommodation space for receiving the second housing, the first section of the sliding groove is recessed into the accommodation portion from the accommodation space in a vertical direction perpendicular to the mating direction, and the second section extends from the first section in the vertical direction and away from the accommodation space.

Optionally, the sliding direction is perpendicular to the mating direction.

Optionally, the cam slot is configured to urge the cam pin received in the cam slot to move relative to the first housing in the mating direction when the slider is slid from the first position to the second position, so that the second housing moves from the initial mating position to a mated position in the mating direction.

Optionally, the first housing comprises a sliding groove, a mating face, and an opening, the sliding groove is configured to accommodate the slider, the first housing is configured to be mated with the second housing of the second electrical connector at the mating face, and the opening is recessed into the first housing from the mating face in the mating direction and is in communication with the sliding groove; and the cam slot comprises an entry section, the entry section is aligned with the opening in the mating direction to receive the cam pin of the second housing when the slider is in the first position, and the entry section is offset from the opening in the mating direction when the slider is slid away from the first position.

Optionally, the electrical connector further comprises: a cover mounted to the first housing; and a locking member pivotably mounted to the cover and coupled to the slider to drive the slider to slide according to a pivoting operation; wherein the slider cannot be driven by the locking member when the slider is constrained in the first position by the first housing.

Optionally, the cover comprises a side wall and a pivot shaft protruding outwardly from the side wall; the locking member comprises an arm pivotably mounted on the pivot shaft at a first end of the arm, so that the arm is pivotable about the pivot shaft between a pre-locked position and a locked position, the first end is formed with gear teeth; the slider is formed with rack teeth at a location opposite to the first end; and the gear teeth mesh with the rack teeth so that the slider is driven to slide between the first position and the second position when the arm is pivoted between the pre-locked position and the locked position.

Optionally, the cover further comprises a first protrusion protruding outwardly from the side wall, the first protrusion is configured to engage with the arm when the arm is in the pre-locked position, to restrict the arm from being pivoted beyond the pre-locked position and further away from the locked position.

Optionally, the cover further comprises a second protrusion protruding outwardly from the side wall, the second protrusion is configured to engage with the arm when the arm is in the locked position, to restrict the arm from being pivoted beyond the locked position and further away from the pre-locked position.

Optionally, the cover further comprises a resilient tab protruding outwardly from the side wall, the resilient tab is configured to be capable of being depressed by the arm when the arm is pivoted away from the locked position and toward the pre-locked position, allowing the arm to pass over the resilient tab to the pre-locked position, and is configured to be capable of resetting and blocking the arm from being pivoted from the pre-locked position toward the locked position when the arm is in the pre-locked position, the resilient tab is further configured to be capable of being manually depressed to allow the arm to be pivoted from the pre-locked position toward the locked position.

Optionally, the cover further comprises a third protrusion protruding outwardly from the side wall; the arm further comprises an opening; and the third protrusion of the cover is received in the opening of the arm when the arm is pivoted to the pre-locked position, to provide at least one of audible, visual, and tactile indications indicating that the arm is pivoted to the pre-locked position.

Optionally, the pivot shaft comprises a shaft body extending in an axial direction and a protrusion protruding radially from the shaft body, the protrusion is spaced apart from the side wall of the cover in the axial direction; the first end comprises a bearing portion having a bore extending through the bearing portion in the axial direction and a notch recessed into the bearing portion in the radial direction from the bore; the shaft body extends through the bore and the bearing portion is supported on the shaft body between the protrusion of the pivot shaft and the side wall of the cover; and the notch and the protrusion match each other in shape so that the notch and the protrusion are aligned with each other in the axial direction only when the arm is in a locking position between the pre-locked position and the locked position, allowing the first end to be mounted to and removed from the pivot shaft, and are offset from each other in the axial direction when the arm is in other pivot positions, to block mounting and removal of the first end to and from the pivot shaft.

Optionally, the first housing comprises a mating face and a rear face opposite to each other in a mating direction, the first housing is for mating with the second housing of the second electrical connector at the mating face; and the cover is pivotably mounted to the first housing and is pivotable relative to the first housing between a closed position and an open position, the cover blocks the rear face of the first housing when in the closed position and allows access to the rear face of the first housing when in the open position.

Optionally, the cover comprises a first pivot structure at a first corner; the first housing further comprises a side wall extending between the mating face and the rear face and a second pivot structure provided at the side wall; and the first pivot structure and the second pivot structure are coupled to each other so that the cover is pivotably mounted to the side wall of the first housing.

Optionally, the electrical connector further comprises at least one module accommodated in the first housing, cables of the at least one module extend out of the first housing at the rear face; the cover comprises a first exit structure at a second corner disposed diagonally from the first corner and the first housing comprises a second exit structure, when the cover is in the closed position, the first and second exit structures collectively define a cable exit through which the cables of the at least one module are led out of the electrical connector; and the cover further comprises a first snap structure disposed adjacent to and/or at the first exit structure, the first housing further comprises a second snap structure disposed adjacent to and/or at the second exit structure, the first snap structure and the second snap structure are configured to cooperate with each other when the cover is in the closed position, to hold the cover in the closed position.

Optionally, the electrical connector further comprises a plurality of modules having first identification features different from each other; the first housing comprises a plurality of cavities each configured to accommodate a corresponding one of the plurality of modules, each cavity has an entrance; and a plurality of key members having second identification features different from one another, each of the plurality of key members is disposed at the entrance of a corresponding one of the plurality of cavities; wherein the second identification feature of the key member disposed at the entrance of each cavity is associated with the first identification feature of a corresponding one of the plurality of modules to be mounted to the cavity, indicating a corresponding mounting relationship between the cavity and the corresponding module.

Optionally, the first identification features of the plurality of modules are in the form of colors, symbols, graphs, texts, or combinations thereof.

Optionally, the second identification features of the plurality of key members are in the form of colors, symbols, graphics, texts, or combinations thereof.

Optionally, for each module, the module comprises a module housing, and the first identification feature is a first structural feature provided at the module housing, for each key member, the second identification feature is a second structural feature configured to define a portion of a perimeter of the entrance of the corresponding cavity, and the second structural feature is complementary in shape to the first structural feature of the corresponding module to only allow the corresponding module to enter the cavity through the entrance.

Some embodiments relate to an electrical connector. The electrical connector may comprises: a plurality of modules having first identification features different from each other; a housing comprising a plurality of cavities each configured to accommodate a corresponding one of the plurality of modules, each cavity having an entrance; and a plurality of key members having second identification features different from one another, each of the plurality of key members disposed at the entrance of a corresponding one of the plurality of cavities. The second identification feature of the key member disposed at the entrance of each cavity is associated with the first identification feature of a corresponding one of the plurality of modules to be mounted to the cavity, indicating a corresponding mounting relationship between the cavity and the corresponding module.

Optionally, the first identification features of the plurality of modules are in the form of colors, symbols, graphs, texts, or combinations thereof.

Optionally, the second identification features of the plurality of key members are in the form of colors, symbols, graphics, texts, or combinations thereof.

Optionally, for each module, the module comprises a module housing, and the first identification feature is a first structural feature provided at the module housing; and for each key member, the second identification feature is a second structural feature configured to define a portion of a perimeter of the entrance of the corresponding cavity, and the second structural feature is complementary in shape to the first structural feature of the corresponding module to only allow the corresponding module to enter the cavity through the entrance.

Optionally, the first structural feature is in the form of a protrusion protruding outwardly from the module housing, a groove recessed into the module housing, or a combination thereof; and the second structural feature is in the form of a protrusion protruding outwardly from the key member, a groove recessed into the key member, or a combination thereof.

Optionally, each of the plurality of key members is removably disposed at the entrance of a corresponding one of the plurality of cavities.

Optionally, the housing comprises a notch recessed into the housing at the entrance of each of the plurality of cavities, and a first retention portion and a second retention portion opposing to each other across the notch; and each key member is disposed in the notch at the entrance of the corresponding cavity and is held by the first retention portion and the second retention portion therebetween.

Optionally, for each cavity, the entrance is recessed into the housing in a lateral direction, the first retention portion and the second retention portion are opposing to each other in a longitudinal direction perpendicular to the lateral direction, and each comprises a slot extending in the lateral direction and a bayonet disposed at the slot; each key member comprises a body, a first insertion portion and a second insertion portion respectively protruding from two opposite ends of the body in the longitudinal direction, the first insertion portion and the second insertion portion each have a protrusion protruding in a vertical direction perpendicular to the lateral direction and the longitudinal direction; and the first insertion portion and the second insertion portion of each key member are respectively inserted into the slots of the first retention portion and the second retention portion at the entrance of the corresponding cavity, so that the protrusion of the first insertion portion and the protrusion of the second insertion portion snap into the bayonet of the first retention portion and the bayonet of the second retention portion, respectively.

Optionally, the housing comprises a mating face and a rear face opposite to each other in a lateral direction, the entrances of the plurality of cavities are recessed into the housing from the rear face in the lateral direction, and for each cavity: the housing comprises a flange structure protruding into the cavity to engage with a module housing of a module when the module is installed into the cavity, thereby restricting further movement of the module toward the mating face; and/or the housing comprises a snap structure protruding into the cavity to engage with a module housing of a module when the module is installed into the cavity, thereby restricting movement of the module back toward the entrance.

Optionally, for at least one of the plurality of modules, the module comprises a module housing having a sub-cavity and a terminal subassembly holding one or more conductive terminals and removably disposed in the sub-cavity.

Optionally, the plurality of modules comprise one or more of a signal module, a power module, and a hybrid module.

Some embodiments relate to an electrical connector. The electrical connector may comprises: a housing comprising a sliding groove; a locking member mounted to the cover and configured to be pivotable relative to the cover between a pre-locked position and a locked position; and a connector position retention (CPA) device disposed in the sliding groove and configured to be slidable relative to the cover between a pre-installed position and an installed position. Before the locking member is pivoted to the locked position, the CPA device can be constrained in the pre-installed position by the cover, and when the locking member is in the locked position, the locking member can release the CPA device to allow the CPA device to slide from the pre-installed position toward the installed position.

Optionally, the CPA device comprises a base and at least one first resilient arm extending from the base; the cover further comprises an overhanging structure disposed above the CPA device and comprising at least one stopping structure; and when the CPA device is in the pre-installed position and before the locking member is pivoted to the locked position, each of the at least one first resilient arms engages with a corresponding one of the at least one stopping structures to restrict the CPA device from sliding from the pre-installed position toward the installed position.

Optionally, when the CPA device is in the pre-installed position and the locking member is in the locked position, the locking member contacts the at least one first resilient arm to bias each of the first resilient arms to disengage from a corresponding stopping structure, thereby allowing the CPA device to slide from the pre-installed position toward the installed position.

Optionally, the at least one stopping structure of the overhanging structure comprises at least one opening, when the CPA device is in the pre-installed position and before the locking member is pivoted to the locked position, a portion of each of the at least one first resilient arm is received in a corresponding one of the at least one opening, to restrict the CPA device from sliding from the pre-installed position toward the installed position; and the locking member comprises at least one release protrusion, when the CPA device is in the pre-installed position and the locking member is in the locked position, each of the at least one release protrusion enters a corresponding one of the at least one opening and is in contact with the portion of the corresponding first resilient arm to push the portion of the corresponding first resilient arm out of the opening.

Optionally, for each first resilient arm, the portion of the first resilient arm is a first protrusion disposed on the first resilient arm.

Optionally, the cover comprises a pivot shaft and the locking member comprises an arm pivotably mounted on the pivot shaft, the at least one release protrusion is disposed on the arm.

Optionally, the at least one release protrusion engages with the cover when the locking member is in the pre-locked position, to restrict the locking member from being pivoted beyond the pre-locked position and further away from the locked position.

Optionally, the CPA device further comprises a second resilient arm extending from the base; the sliding groove comprises a bottom for carrying the CPA device, and the cover further comprises a stop recess recessed into the cover from the bottom of the sliding groove; and the second resilient arm engages with a wall of the stop recess when the CPA device is in the pre-installed position, to restrict the CPA device from sliding from the pre-installed position away from the installed position.

Optionally, the CPA device further comprises a third resilient arm extending from the base, the third resilient arm comprises a second protrusion having a rounded shape; the sliding groove comprises a bottom for carrying the CPA device, and the cover further comprises a first receiving recess and a second receiving recess recessed into the cover from the bottom of the sliding groove; and the second protrusion is received in the first receiving recess when the CPA device is in the pre-installed position, and the second protrusion is received in the second receiving recess when the CPA device is in the installed position.

Optionally, the overhanging structure further comprises a fourth resilient arm configured to be capable of being depressed by the locking member when the locking member is pivoted away from the pre-locked position toward the locked position, allowing the locking member to pass over the fourth resilient arm to the locked position, and configured to be capable of resetting and blocking the locking member from being pivoted from the locked position toward the pre-locked position when the locking member is in the locked position, the fourth resilient arm is further configured to be capable of being manually depressed to allow the locking member to be pivoted from the locked position toward the pre-locked position.

Optionally, the fourth resilient arm extends above the sliding groove; and the CPA device allows the fourth resilient arm to be depressed when in the pre-installed position, and blocks the fourth resilient arm from being depressed when in the installed position.

Optionally, the sliding groove comprises a bottom for carrying the CPA device; the fourth resilient arm comprises a fixed end fixed above the sliding groove, a free end opposite to the fixed end, and an engagement portion disposed adjacent to or at the free end and protruding from the fourth resilient arm toward the bottom of the sliding groove; and when the CPA device is in the installed position, the base is positioned below the engagement portion to block the fourth resilient arm from being depressed.

Optionally, the base of the CPA device is provided with an opening, when the CPA device is in the pre-installed position, the opening is aligned with the engagement portion to allow the engagement portion to move toward the bottom of the sliding groove and at least partially into the opening when the fourth resilient arm is depressed toward the bottom of the sliding groove, when the CPA device is in the installed position, the opening is offset from the engagement portion and the base blocks the engagement portion from moving toward the bottom of the sliding groove.

Optionally, the engagement portion is pressed against the base when the CPA device is in the installed position.

Optionally, the cover comprises a pair of pivot shafts; the locking member comprises a crossbar portion and a pair of arms, each arm comprises a first end and a second end opposite to each another, the first end of each of the pair of arms is pivotably mounted on a corresponding one of the pair of pivot shafts, and the second ends of the pair of arms are connected by the crossbar portion; and the fourth resilient arm further comprises a stop portion disposed adjacent to or at the free end and protruding from the fourth resilient arm oppositely to the engagement portion, when the locking member is pivoted away from the pre-locked position toward the locked position, the crossbar portion contacts the stop portion to depress the fourth resilient arm, and when the locking member is in the locked position, the fourth resilient arm resets and the stop portion blocks the crossbar portion from being pivoted from the locked position toward the pre-locked position. Optionally, the overhanging structure is an integrally formed portion of the cover.

Optionally, a first housing configured for mating with a second housing of a second electrical connector in a mating direction; and a slider disposed in the first housing and configured to be slidable relative to the first housing between a first position and a second position in a sliding direction intersecting the mating direction, the slider comprises a cam slot configured to receive a cam pin provided on the second housing when the slider is in the first position, so that the second housing is positioned in an initial mating position, the cam slot is further configured to urge the cam pin received in the cam slot to move relative to the first housing in the mating direction when the slider is slid from the first position to the second position, so that the second housing is moved from the initial mating position to a mated position in the mating direction; wherein the cover is attached to the first housing, the locking member is coupled to the slider to drive the slider to slide according to a pivoting operation, when the locking member is pivoted between the pre-locked position and the locked position, the slider is driven to slide between the first position and the second position.

Some embodiments relate to a module for an electrical connector. The module may comprise: an insulative module housing including a plurality of terminal channels each extending in a mating direction; and multiple types of terminals each having a mating end at least partially disposed in a corresponding one of the plurality of terminal channels so that the terminals are held by the module housing. The multiple types of terminals comprises: a first terminal having a mating end with a first width in a longitudinal direction perpendicular to the mating direction; a second terminal having a mating end with a second width in the longitudinal direction, the second width being greater than the first width; and a third terminal having a mating end with a third width in the longitudinal direction, the third width being greater than the second width.

Optionally, the multiple types of terminals further comprise a fourth terminal having a mating end with a fourth width in the longitudinal direction, the fourth width is greater than the third width.

Optionally, the multiple types of terminals are arranged in a plurality of groups spaced apart from each other in the longitudinal direction, each group has a single terminal or a pair of terminals, wherein the pair of terminals are terminals of the same type, and mating ends of the pair of terminals are aligned with and spaced apart from each other in a vertical direction perpendicular to the mating direction and the longitudinal direction.

Optionally, the module housing further comprises a mating face and a rear face opposite to each other in the mating direction, each terminal channel extends through the module housing from the rear face to the mating face; a mating end of each terminal is configured to be inserted into the corresponding terminal channel from the rear face and comprises a first stop portion; and the module housing further comprises a plurality of resilient arms each having a second stop portion and protruding into a corresponding one of the plurality of terminal channels, so that the second stop portion engages with the first stop portion of the mating end disposed in the corresponding terminal channel, thereby restricting the mating end from being withdrawn toward the rear face in the mating direction.

Optionally, the module further comprises a TPA device mounted to the module housing, wherein: (i) a first group of the plurality of groups comprises a pair of first terminals, the plurality of resilient arms comprise a pair of first resilient arms disposed between mating ends of the pair of first terminals in the vertical direction, the pair of first resilient arms are spaced apart from each other in the vertical direction and respectively protrude toward the mating ends of the corresponding first terminals, the module housing further comprises a first receiving channel extending from the mating face to a position between the pair of first resilient arms, the TPA device comprises a first projection inserted into the first receiving channel and in contact with the pair of first resilient arms to restrict deflection of the pair of first resilient arms away from the mating ends of the corresponding first terminals; and/or (ii) a second group of the plurality of groups comprises a pair of second terminals, the plurality of resilient arms comprise a pair of second resilient arms disposed between mating ends of the pair of second terminals in the vertical direction, the pair of second resilient arms are spaced apart from each other in the vertical direction and respectively protrude toward the mating ends of the corresponding second terminals, the module housing further comprises a second receiving channel extending from the mating face to a position between the pair of second resilient arms, the TPA device comprises a second projection inserted into the second receiving channel and in contact with the pair of second resilient arms to restrict deflection of the pair of second resilient arms away from the mating ends of the corresponding second terminals; and/or (iii) a third group of the plurality of groups comprises a pair of third terminals, the plurality of resilient arms comprise a pair of third resilient arms disposed between mating ends of the pair of third terminals in the vertical direction, the pair of third resilient arms are spaced apart from each other in the vertical direction and respectively protrude toward the mating ends of the corresponding third terminals, the module housing further comprises a third receiving channel extending from the mating face to a position between the pair of third resilient arms, the TPA device comprises a third projection inserted into the third receiving channel and in contact with the pair of first resilient arms to restrict deflection of the pair of third resilient arms away from the mating ends of the corresponding third terminals; and/or (iv) a fourth group of the plurality of groups comprises a single fourth terminal, the plurality of resilient arms comprise a pair of fourth resilient arms disposed on both sides of a mating end of the fourth terminal in the vertical direction, the pair of fourth resilient arms respectively protrude toward the mating end of the fourth terminal, the module housing further comprises a pair of fourth receiving channels, each of the pair of fourth receiving channels extends from the mating face to a side of a corresponding one of the pair of fourth resilient arms facing away from the mating end of the fourth terminal, the TPA device comprises a pair of fourth projections, each of the pair of fourth projections is inserted into a corresponding one of the pair of fourth receiving channels and is in contact with a corresponding fourth resilient arm to restrict deflection of the corresponding fourth resilient arm away from the mating end of the fourth terminal.

Optionally, each terminal channel has a first opening at the mating face; and the module housing comprises a third stop portion extending into the terminal channel at the first opening of each terminal channel, the third stop portion engages with a tip portion of the mating end disposed in the terminal channel to restrict the mating end from being removed out of the first opening in the mating direction.

Optionally, the TPA device comprises a body and a plurality of second openings extending through the body in the mating direction, the body is placed on the mating face, and each of the plurality of second openings is aligned with the first opening of a corresponding one of the plurality of terminal channels in the mating direction.

Optionally, the plurality of groups comprises at least one first group, at least one second group, at least one third group, and at least one fourth group, each first group has a pair of first terminals, each second group has a pair of second terminals, each third group has a pair of third terminals, and each fourth group has a single fourth terminal; a mating end of one first terminal of each first group, a mating end of one second terminal of each second group, and a mating end of one third terminal of each third group are aligned in a first line parallel to the longitudinal direction, and a mating end of another first terminal of each first group, a mating end of another second terminal of each second group, and a mating end of another third terminal of each third group are aligned in a second line parallel to the first line; and a mating end of the fourth terminal of each fourth group is disposed between the first line and the second line in the vertical direction.

Optionally, the mating end of each terminal is configured to be in the form of a receptacle and is entirely disposed in a corresponding terminal channel, and a width of the mating end in the longitudinal direction is an internal width of the receptacle in the longitudinal direction.

Optionally, each terminal further has a tail end opposite to the mating end and configured to attach a cable.

Optionally, the module housing further comprises a slot recessed into the module housing from the mating face in the mating direction and elongated in the longitudinal direction, the slot is configured to receive a protruding portion of a mating module when the module is mated with the mating module.

Optionally, the mating end of each terminal is configured to be in the form of a pin and partially protrudes from the mating face in the mating direction, and a width of the mating end in the longitudinal direction is a width of the pin in the longitudinal direction.

Optionally, each terminal further has a tail end opposite to the mating end and configured for mounting to a circuit board.

Optionally, the module housing further comprises a protruding portion protruding from the mating face beyond mating ends of the multiple types of terminals in the mating direction and elongated in the longitudinal direction, the protruding portion is configured to be inserted into a slot of a mating module when the module is mated with the mating module.

Optionally, a housing portion of the module housing for disposing the multiple types of terminals is divided into a plurality of sub-portions, the plurality of sub-portions are continuous in the longitudinal direction, each of the plurality of sub-portions forms a terminal channel for disposing a mating end of a terminal of a corresponding one of the plurality of groups; and the plurality of groups comprises a first group having the first terminal, a second group having the second terminal, a third group having the third terminal, and a fourth group having the fourth terminal, the number of the first group, the second group, the third group, and the fourth group satisfies the following equation:

$$A * {W}_{1} + B * {W}_{2} + C * {W}_{3} + D * {W}_{4} \leq {W}_{Max}$$

wherein A is the number of the first group, B is the number of the second group, C is the number of the third group, D is the number of the fourth group, W₁ is the minimum width of the first sub-portion of the plurality of sub-portions corresponding to the first group in the longitudinal direction, W₂ is the minimum width of the second sub-portion of the plurality of sub-portions corresponding to the second group in the longitudinal direction, W₃ is the minimum width of the third sub-portion of the plurality of sub-portions corresponding to the third group in the longitudinal direction, W₄ is the minimum width of the fourth sub-portion of the plurality of sub-portions corresponding to the fourth group in the longitudinal direction, and W_{Max} is 22.86 mm.

Optionally, W₁ is 2 mm.

Optionally, W₂ is 2.54 mm.

Optionally, W₃ is 3 mm.

Optionally, W₄ is 5.5 mm.

Optionally, the module is configured to be removably disposed in a housing of the electrical connector.

Optionally, the first terminal is a signal terminal.

Optionally, the second terminal is a signal terminal or a power terminal.

Optionally, the third terminal is a power terminal.

Optionally, the fourth terminal is a power terminal.

Some embodiments relate to a method for manufacturing a module housing for a module of an electrical connector. The method may comprise providing multiple types of tool pins, each of the multiple types of tool pins corresponding to one of multiple types of terminals to be disposed in the module housing; aligning the multiple types of tool pins according to terminal locations at which the multiple types of terminals are to be disposed in the module housing; and flowing a housing material around the multiple types of tool pins to form the module housing.

Optionally, each tool pin comprises a base, and aligning the multiple types of tool pins according to the terminal positions comprises providing an organizer comprising a slot extending in a longitudinal direction; and stacking the bases of the multiple types of tool pins in the slot in the longitudinal direction according to the terminal positions.

Optionally, the bases of the multiple types of tool pins have different base widths from each other in the longitudinal direction, and the base of each type of tool pin has a fixed base width; the slot has a fixed slot width in the longitudinal direction; and stacking the bases of the multiple types of tool pins in the slot comprises making a width of the stack of the bases of the multiple types of tool pins in the longitudinal direction to be less than or equal to the slot width.

Optionally, stacking the bases of the multiple types of tool pins in the slot further comprises providing a spacer to fill a gap between the stack and an end wall of the slot when the width of the stack is less than the slot width.

Optionally, the module housing comprises a plurality of terminal channels each extending in a mating direction perpendicular to the longitudinal direction, each terminal of the multiple types of terminals has a mating end to be at least partially disposed in a corresponding one of the plurality of terminal channels; the slot width is equal to a maximum width, in the longitudinal direction, of a housing portion of the module housing allowing for disposing the plurality of terminal channels; and for each tool pin, the base width of the base is equal to a minimum width of a sub-portion of the housing portion in the longitudinal direction, wherein the sub-portion is used to form a terminal channel for disposing the mating end of the terminal corresponding to the tool pin.

Optionally, the multiple types of terminals are to be arranged in the module housing in a plurality of groups spaced apart from each other in the longitudinal direction, each group has a single terminal or a pair of terminals, wherein the pair of terminals are terminals of the same type, and mating ends of the pair of terminals are aligned with and spaced apart from each other in a vertical direction perpendicular to the mating direction and the longitudinal direction; the plurality of groups comprises a first group having a first terminal, a second group having a second terminal, a third group having a third terminal, and a fourth group having a fourth terminal; the housing portion is divided into a plurality of the sub-portions in the longitudinal direction, the plurality of sub-portions are continuous in the longitudinal direction, each sub-portion is used to form a terminal channel for disposing the mating end of the terminal of a corresponding one of the plurality of groups; and providing the multiple types of tool pins comprises providing the multiple types of tool pins according to the equation:

$$A * {W}_{T 1} + B * {W}_{T 2} + C * {W}_{T 3} + D * {W}_{T 4} \leq {W}_{Max}$$

wherein A is the number of the first tool pin corresponding to the first group, B is the number of the second tool pin corresponding to the second group, C is the number of the third tool pin corresponding to the third group, D is the number of the fourth tool pin corresponding to the fourth group, W_{T1} is the base width of the first tool pin, W_{T2} is the base width of the second tool pin, W_{T3} is the base width of the third tool pin, W_{T4} is the base width of the fourth tool pin, and W_{Max} is the slot width and is equal to 22.86 mm.

Optionally, W_{T1} is 2 mm.

Optionally, W_{T2} is 2.54 mm.

Optionally, W_{T3} is 3 mm.

Optionally, W_{T4} is 5.5 mm.

Optionally, the module housing comprises a plurality of terminal channels each extending in a mating direction perpendicular to the longitudinal direction, each terminal of the multiple types of terminals has a mating end to be at least partially disposed in a corresponding one of the plurality of terminal channels; each tool pin further comprises at least one beam extending from the base in the mating direction, each of the at least one beam is contoured to conform a shape of the terminal channel for disposing the mating end of the terminal corresponding to the tool pin; and flowing the housing material around the multiple types of tool pins comprises flowing the housing material around the beams of the multiple types of tool pins to form the plurality of terminal channels.

Optionally, the multiple types of terminals are to be arranged in the module housing in a plurality of groups spaced apart from each other in the longitudinal direction, each group has a single terminal or a pair of terminals, wherein the pair of terminals are terminals of the same type, and mating ends of the pair of terminals are aligned with and spaced apart from each other in a vertical direction perpendicular to the mating direction and the longitudinal direction; and each tool pin corresponds to a group of the plurality of groups, and the number of the at least one beam of the tool pin corresponds to the number of the mating end of the terminal of the corresponding group.

Optionally, a first group of the plurality of groups comprises a pair of first terminals; the module housing further comprises a pair of first resilient arms to be disposed between and to engage with the mating ends of the pair of first terminals in the vertical direction; the multiple types of tool pins comprises a first tool pin corresponding to the first group, the at least one beam of the first tool pin comprises a pair of first beams; the method further comprises providing a first complementary tool pin and positioning a first portion of the first complementary tool pin between the pair of first beams of the first tool pin in the vertical direction to define a first space between each first beam and the first portion, each first space has a shape corresponding to a shape of a corresponding first resilient arm of the module housing; and forming the module housing comprises flowing the housing material into the first space.

Optionally, a second group of the plurality of groups comprises a single second terminal; the module housing further comprises a pair of second resilient arms to be disposed on both sides of the mating end of the second terminal in the vertical direction and to engage with the mating end; the multiple types of tool pins comprises a second tool pin corresponding to the second group, the at least one beam of the second tool pin comprises a single second beam; the method further comprises providing a second complementary tool pin, and positioning a second portion and a third portion of the second complementary tool pin on both sides of the second beam of the second tool pin in the vertical direction, respectively, to define a second space between the second portion and the second beam, and to define a third space between the third portion and the second beam, the shapes of the second space and the third space correspond to the shapes of the corresponding second resilient arms of the module housing, respectively; and forming the module housing includes flowing the housing material into the second space and the third space.

These techniques may be used individually or in any suitable combination. The preceding summary is provided by way of illustration and is not meant to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of a portion of an electronic system including a first electrical connector (e.g., plug connector), a second electrical connector (e.g., receptacle connector), and a circuit board, according to some embodiments, looking toward a mating interface of the first electrical connector, showing the first electrical connector and the second electrical connector in a separated state and the second electrical connector mounted to the circuit board;

FIG. 1B is another perspective view of the electronic system of FIG. 1A, looking toward a mating interface of the second electrical connector;

FIG. 2A is a perspective view of the electronic system of FIG. 1A, illustrating the first electrical connector and the second electrical connector in an initial mating state;

FIG. 2B is a top view of the electronic system of FIG. 2A;

FIG. 2C is a cross-sectional view taken along a line marked “2C-2C” in FIG. 2A;

FIG. 3A is another perspective view of the electronic system of FIG. 1A, illustrating the first electrical connector and the second electrical connector in a partial mating state;

FIG. 3B is a top view of the electronic system of FIG. 3A;

FIG. 3C is a cross-sectional view taken along a line marked “3C-3C” in FIG. 3A;

FIG. 4A is yet another perspective view of the electronic system of FIG. 1A, illustrating the first electrical connector and the second electrical connector in a mated state;

FIG. 4B is a top view of the electronic system of FIG. 4A;

FIG. 4C is a cross-sectional view taken along a line marked “4C-4C” in FIG. 4A;

FIG. 5A is a cross-sectional view taken along a line marked “5A-5A” in FIG. 1A;

FIG. 5B is an enlarged view of an area within a dashed box marked “5B” in FIG. 5A;

FIG. 5C is an enlarged view of the area 5B, showing the second housing 21 in the initial mating position;

FIG. 6 is an exploded perspective view of the first electrical connector shown in FIG. 1A, showing a first housing, two sliders, a locking member, a cover, a plurality of modules, a plurality of key members, and a connector position assurance (CPA) device;

FIG. 7A is a top, front perspective view of the first housing of the first electrical connector of FIG. 6;

FIG. 7B is a bottom, front perspective view of the first housing of FIG. 7A;

FIG. 7C is a top, rear perspective view of the first housing of FIG. 7A;

FIG. 7D is an enlarged view of an area within a dashed box marked “7D” in FIG. 7C;

FIG. 7E is a side, rear perspective view of the first housing of FIG. 7A;

FIG. 7F is an enlarged view of an area marked “7F” in FIG. 7E;

FIG. 7G is a rear view of the first housing of FIG. 7A;

FIG. 7H is a cross-sectional view taken along a line marked “7H-7H” in FIG. 7G;

FIG. 8A is a perspective view of the first housing of FIG. 7C, showing the key members shown in FIG. 6 assembled to the first housing;

FIG. 8B is an enlarged view of an area within a dashed box marked “8B” in FIG. 8A;

FIG. 8C is a perspective view of the first housing of FIG. 7E, showing the key members shown in FIG. 6 assembled to the first housing;

FIG. 8D is an enlarged view of an area within a dashed box marked “8D” in FIG. 8C;

FIG. 9A is a perspective view of the first housing of FIG. 7C, showing the key members and the modules assembled to the first housing;

FIG. 9B is a perspective view of the first housing of FIG. 7E, showing the key members and the modules assembled to the first housing;

FIG. 10A is a top, front perspective view of a first module of the plurality of connection modules;

FIG. 10B is a rear perspective view of a module housing of the first module of FIG. 10A;

FIG. 10C is an exploded perspective view of the first module of FIG. 10A, showing a first terminal subassembly, a second terminal subassembly, a module housing, and a TPA device;

FIG. 10D is an exploded perspective view of the first terminal subassembly shown in FIG. 10C, showing a terminal retention member, a plurality of conductive terminals, and a plurality of cables;

FIG. 10E is a front perspective view of the plurality of modules shown in FIG. 6;

FIG. 10F is a front perspective view of alternative modules that may be used in the first electrical connector;

FIG. 10G is a rear perspective view of the modules of FIG. 10F;

FIG. 10H is a front perspective view of another alternative module that may be used in the first electrical connector;

FIG. 10I is a partially exploded perspective view of the module of FIG. 10H;

FIG. 10J is a front perspective view of yet another alternative module that may be used in the first electrical connector;

FIG. 10K is a partially exploded perspective view of the module of FIG. 10J;

FIG. 11A is a top perspective view of an upper slider of the two sliders shown in FIG. 6;

FIG. 11B is a bottom perspective view of the upper slider of FIG. 11A;

FIG. 11C is a bottom view of the upper slider of FIG. 11A;

FIG. 12A is a perspective view of the cover shown in FIG. 6;

FIG. 12B is an enlarged view of an area within a dashed box marked “12B” in FIG. 12A;

FIG. 12C is another perspective view of the cover of FIG. 12A;

FIG. 12D is an enlarged view of an area within a dashed box marked “12D” in FIG. 12C;

FIG. 13A is a perspective view of the locking member shown in FIG. 6;

FIG. 13B is another perspective view of the locking member of FIG. 13A;

FIG. 14A is a perspective view of a first key member of the plurality of key members shown in FIG. 6;

FIG. 14B is another perspective view of the first key member of FIG. 14A;

FIG. 15A is a perspective view of the CPA device shown in FIG. 6;

FIG. 15B is another perspective view of the CPA device of FIG. 15A;

FIG. 16A is a perspective view of the first electrical connector, showing the CPA device in a pre-installed position and the locking member in a locked position;

FIG. 16B is an enlarged view of an area within a dashed box marked “16B” in FIG. 16A;

FIG. 16C is an enlarged view of the area 16B, showing the CPA device in an installed position;

FIG. 16D is a top view of the area 16B;

FIG. 16E is an enlarged view of an area marked “16E” in FIG. 16A;

FIG. 16F is an enlarged view of the area 16B, with the locking member hidden;

FIG. 16G is a perspective view of the first electrical connector of FIG. 16A, with the locking member and the CPA device hidden and showing the cover in a closed position;

FIG. 16H is a perspective view of the first electrical connector of FIG. 16G, showing the cover in an open position;

FIG. 17A is a cross-sectional view of the area 16B taken along a line marked “17A-17A” in FIG. 16D;

FIG. 17B is a cross-sectional view of FIG. 17A, showing the CPA device in the installed position;

FIG. 17C is a cross-sectional view of the area 16B taken along a line marked “17C-17C” in FIG. 16D;

FIG. 17D is a cross-sectional view of FIG. 17C, showing the CPA device in the installed position;

FIG. 17E is a cross-sectional view of the area 16B taken along a line marked “17E-17E” in FIG. 16D;

FIG. 17F is a cross-sectional view of FIG. 17E, showing the CPA device in the installed position;

FIGS. 18A-18C are front views of three alternative versions of the first electrical connector;

FIG. 19A is a bottom, rear perspective view of the second electrical connector shown in FIG. 1A;

FIG. 19B is a partially exploded, top, front perspective view of the second electrical connector of FIG. 19A, showing a second housing and a plurality of modules;

FIG. 20A is a front perspective view of the second housing shown in FIG. 19B;

FIG. 20B is a rear perspective view of the second housing of FIG. 20A;

FIG. 20C is a top, front perspective view of alternative modules that may be used in the second electrical connector;

FIG. 20D is a rear, bottom perspective view of the modules of FIG. 20C;

FIG. 20E is a cross-sectional view of the alternative modules of FIG. 20C, showing the alternative modules disposed in the second housing;

FIG. 21A is a perspective view of an alternative version of the second electrical connector;

FIGS. 21B-21C are front views of another two alternative versions of the second electrical connector;

FIG. 22A is a front perspective view of yet another alternative module that may be used in the first electrical connector;

FIG. 22B is a rear perspective view of the module of FIG. 22A;

FIG. 22C is an exploded perspective view of the module of FIG. 22A, showing a module housing, multiple types of terminals, and a terminal position retention (TPA) device, with relative positional relationship among the multiple types of terminals in the module housing;

FIG. 22D is a rear view of the module of FIG. 22C, with the multiple types of terminals hidden;

FIG. 22E is an enlarged view of an area within a dashed box marked “22E” in FIG. 22C;

FIG. 22F is a front view of the module of FIG. 22A;

FIG. 23 is a front view of the module of FIG. 22A, with the TPA device of the module hidden and showing a mating face of the module housing;

FIG. 24A is a cross-sectional view of the module of FIG. 22A taken along a line marked “24A-24A” in FIG. 22F;

FIG. 24B is an enlarged view of an area within a dashed box marked “24B” in FIG. 24A;

FIG. 24C is a cross-sectional view of the module of FIG. 22A taken along a line marked “24C-24C” in FIG. 22F;

FIG. 24D is an enlarged view of an area within a dashed box marked “24D” in FIG. 24C;

FIG. 24E is a cross-sectional view of the module of FIG. 22A taken along a line marked “24E-24E” in FIG. 22F;

FIG. 24F is an enlarged view of an area within a dashed box marked “24F” in FIG. 24E;

FIG. 24G is a cross-sectional view of the module of FIG. 22A taken along a line marked “24G-24G” in FIG. 22F;

FIG. 24H is an enlarged view of an area marked “24H” in FIG. 24G;

FIG. 25 is a front perspective view of the module housing shown in FIG. 22C;

FIG. 26 is a rear perspective view of the module housing of FIG. 25;

FIG. 27 is a rear perspective view of the TPA device shown in FIG. 22C;

FIG. 28A is a front perspective view of yet another alternative module that may be used in the second electrical connector;

FIG. 28B is a rear perspective view of the module of FIG. 28A;

FIG. 28C is an exploded perspective view of the module of FIG. 28A, showing a module housing, multiple types of terminals, a first retention member, and a second retention member;

FIG. 28D is another perspective view of the module of FIG. 28C;

FIG. 29A is a perspective view of a group of conductive terminals of the multiple types of terminals of FIG. 28C, showing the relative positional relationship of the group of conductive terminals in the module housing;

FIG. 29B is another perspective view of the group of conductive terminals of FIG. 29A;

FIG. 30A is a perspective view of a tool kit for manufacturing the module housing of FIG. 22C, showing the tool kit in an assembled or use state;

FIG. 30B is a perspective view of the tool kit of FIG. 30A, showing a module housing formed using the tool kit;

FIG. 30C is a cross-sectional perspective view taken along a line marked “30C-30C” in FIG. 30A;

FIG. 30D is a cross-sectional perspective view taken along a line marked “30D-30D” in FIG. 30B;

FIG. 30E is an enlarged perspective view of an area within a dashed box marked “30E” in FIG. 30C;

FIG. 30F is an enlarged perspective view of an area within a dashed box marked “30F” in FIG. 30D;

FIG. 31A is a partially exploded perspective view of the tool kit of FIG. 30A, showing a first organizer, a second organizer, multiple types of tool pins, multiple types of complementary tool pins, an outer mold, and a tool insert plate;

FIG. 31B is another perspective view of the tool kit of FIG. 31A;

FIG. 32 is an exploded perspective view of the first organizer, the multiple types of tool pins, and a spacer of the tool kit shown in FIG. 30A;

FIG. 33 is a rear view of an assembly of the first organizer, the multiple types of tool pins, and the spacer shown in FIG. 32;

FIG. 34A is a perspective view of a first tool pin shown in FIG. 33;

FIG. 34B is a perspective view of a second tool pin shown in FIG. 33;

FIG. 34C is a perspective view of a third tool pin shown in FIG. 33;

FIG. 34D is a perspective view of a fourth tool pin shown in FIG. 33; and

FIG. 35 is a perspective view of the multiple types of complementary tool pins and the tool insert plate, with the second organizer hidden and showing the relative positional relationship of the multiple types of complementary tool pins and the tool insert plate in the second organizer.

### DETAILED DESCRIPTION

The inventors have recognized and appreciated connector design techniques for providing reliable and cost effective electrical connectors and capable of operating in harsh environments, such as those encountered in automobiles. Cost effectiveness may be achieved by a modular connector, which can be readily adapted for multiple uses. The connector may include a connector housing configured to accommodate multiple types of modules, thereby allowing a common platform to support different electrical and mechanical configurations (e.g., interfaces). Each module may include a module housing configured to accommodate multiple types of terminals, such as power terminals, signal terminals, an/or ground terminals, thereby enabling the connector to be customized for specific applications while still relying on standardized components. This modularity both reduces manufacturing costs and inventory requirements and enhances reliability by allowing proven terminal designs to be reused across different connector systems. Furthermore, the modular design facilitates assembly, maintenance, and replacement in the field, which is particularly valuable for automotive applications where serviceability and long-term performance are critical.

The inventors have further recognized and appreciated various techniques applicable to components of a connector system for simultaneously providing reliable power in the vicinity of high speed signal transmission paths. Such techniques may enable electrical connectors and connector assemblies that are highly reliable, easy to assemble and maintain, and operable to achieve mating with another electrical connector, while satisfying mechanical requirements specified by standards such as USCAR.

According to aspects of the present disclosure, an electrical connector may be a modular hybrid electrical connector for providing signal transmission and/or power transmission. Such an electrical connector may be economically manufactured while still capable of operating reliably in harsh environments, such as those encountered in automobiles, and may be suitable for interconnecting assemblies in an automotive network. The techniques may enable modular electrical connector systems in which a group of components (e.g., modules or terminal subassemblies) may be combined to form an electrical connector in any of multiple configurations. This modularity may reduce costs associated with manufacturing electrical connectors of the types described herein.

According to aspects of the present disclosure, a connector may include a housing and multiple types of modules. The housing may include latches for retaining the modules in position and key members for module type indication and preventing insertion of wrong modules. A module may include multiple types of power terminals and one or more types of signal terminals. Module housing may be configured for retaining the multiple types of terminals in position. The connector may include a cover attached to the housing, a locking member attached to the cover and pivotable between a pre-locked position and a locked position, a slider movable by the locking member in a direction perpendicular to a connector mating direction after the insertion of a mating component, and a CPA movable from a pre-installed position to an installed position for retaining the locking member at the locked position.

According to aspects of the present disclosure, a first electrical connector may be configured to establish an electrical connection with a second electrical connector. The first electrical connector may include a first housing and a slider disposed in the first housing. The first housing may be configured to mate with the second housing of the second electrical connector in a mating direction. The slider may be movable relative to the first housing between a first position and a second position in a direction intersecting the mating direction. The slider may be configured to be constrained in the first position by the first housing before the second housing is positioned in the initial mating position. The slider may include a cam slot configured to receive a cam pin provided on the second housing when the slider is in the first position, and be blocked so as to retain the cam pin therein when the slider is in the second position.

Such a configuration may enable the cam pin of the second housing to be accurately and smoothly inserted into the corresponding cam slot of the slider without requiring adjustment of the slider when the second housing is positioned in the initial mating position. This configuration may facilitate mating of the first electrical connector with the second electrical connector, thereby improving connection reliability and assembly efficiency of the electronic system. Moreover, the configuration may enable the first electrical connector to satisfy the mechanical requirements specified by standards such as USCAR.

In some embodiments, the cam slot may be configured to urge the cam pin received therein to move relative to the first housing in the mating direction as the slider slides from the first position to the second position, thereby causing the second housing to move from the initial mating position to the mated position in the mating direction.

In some embodiments, the first electrical connector may include a cover attached to a rear of the first housing, and a locking member attached to the cover and pivotably between a pre-locked position and a locked position. The locking member may be coupled to the slider and configured to drive the slider to slide between the first position and the second position. With the combination of the slider and the locking member, the mating between the first electrical connector and the second electrical connector may be achieved with a lower mating force. For example, the slider and the locking member may be drivingly coupled to each other by, for example, gear teeth and rack teeth. When the slider is constrained in the first position by the first housing, the slider may not be driven by the locking member. The locking member may be constrained in the pre-locked position by the slider and prevented from pivoting.

The cover may include a side wall, first and second protrusions protruding outwardly from the side wall and positioned such that the locking member is pivotable between the first and second protrusions. The cover may further includes a third protrusion configured to engage the locking member and generate an indication that the locking member is at the pre-locked position. The cover may be hinged to the housing so as to permit opening the rear of the housing to exchange a module without disengaging the hinge.

Such a configuration may enable reliably holding the locking member in the pre-locked position before the second housing is positioned in the initial mating position. This configuration may make the mating of the first electrical connector with the second electrical connector easier to operate, thereby improving the connection and assembly efficiency of the electronic system. This configuration may prevent the locking member from over-pivoting beyond either the pre-locked position or the locked position.

In some embodiments, the first electrical connector may also include a connector position assurance (CPA) device. The CPA device may be disposed in a sliding groove of the cover and configured to be movable relative to the cover between a pre-installed position and an installed position. Before the locking member is pivoted to the locked position, the CPA device may be constrained in the pre-installed position by the cover, and when the locking member is in the locked position, the locking member can release the CPA device to allow the CPA device to move from the pre-installed position toward the installed position.

Such a configuration may enable the CPA device to be reliably held in the pre-installed position before the second electrical connector is moved relative to the first electrical connector to the mated position, thereby avoiding accidental movement of the CPA device. This configuration may enable the user to verify whether the locking member has reached the locked position.

In some embodiments, the first electrical connector may include key members removably held by the housing above cavities configured for holding the modules. Each key member may include an identification feature indicating the type of module in a respective cavity. The key members may be configured to shape respective openings for respective modules so as to prevent wrong modules from being inserted. The key members may be aligned in a first row adjacent the rear of the housing. Latches of the housing configured to retain the modules may be aligned in a second row adjacent and parallel to the first row.

Such a configuration may enable the user to determine a one-to-one corresponding mounting relationship more easily and quickly between the modules and the cavities of the first housing when assembling and/or maintaining the first electrical connector, thereby accurately assembling the modules into the corresponding cavities. This configuration may improve the assembly and/or maintenance efficiency of the first electrical connector at a low cost.

In some embodiments, the second electrical connector may include modules configured for mating with the modules of the first electrical connector. Two mated modules may include at least two types of conductive terminals configured to mate with each other, such as pin terminals and receptacle terminals. The conductive terminals may also have different versions of tails, where the tails may be configured to be attached to a circuit board or to conductors of cables. Different mating and mounting configurations may be used in combination to form a board-mounted module or a cable-termination module with a mating interface that allows mutual mating of the modules. For example, a board mount module may mate with a cable termination module, or two cable termination modules may mate with each other.

In some embodiments, a module may include a module housing having a sub-cavity and a terminal subassembly holding one or more conductive terminals and removably disposed in the sub-cavity. This configuration may enable conductive terminals of different shapes and/or types to be assembled into the module by replacing production mold parts, thereby improving the flexibility of use. Terminal subassemblies with conductive terminals of different shapes (including sizes) and/or types may share a single module housing, which may reduce labor associated with mold development. The module housing may also be reused by replacing terminal subassemblies carrying different types of conductive terminals, thereby conserving energy and reducing emissions.

In some embodiments, a module may include a module housing for holding multiple types of terminals. The terminals may be disposed at desired locations in the module housing as required by individual applications. The terminals may include multiple types of power terminals and one or more types of signal terminals. Different types of terminal may be identifiable by respective width in a direction perpendicular to the mating direction of the module. The module housing may include resilient arms extending into respective channels for retaining the terminal therein. A terminal position assurance (TPA) device may be attached to a front of the module housing. The TPA device may include projections extending to contact respective resilient arms of the housing to restrict deflection of the respective resilient arms.

In some embodiments, a module housing may be formed using stackable tool pins. Tool pins may be configured to “typeset” the number and location of terminals. The tool pins may be aligned in a mold at the desired locations of the respective terminals. The housing may be formed by injecting a housing material into the mold and flowing it around the tool pins.

Such a method and a tool kit may enable module housings for different terminal configurations to be manufactured by a single set of tool kit, thereby significantly reducing labor associated with mold development. Such a method and a tool kit may enable flexible customization of the module housing as desired by individual applications using one and the same set of tool kit. Such a method may enable reusing the tool kit, thereby reducing the development and manufacturing costs.

Some embodiments of the present application are described in detail below in conjunction with the accompanying drawings. It should be appreciated that these embodiments are not meant to form any limitations to the present application. Moreover, features in the embodiments of the present application can be combined with each other without conflict.

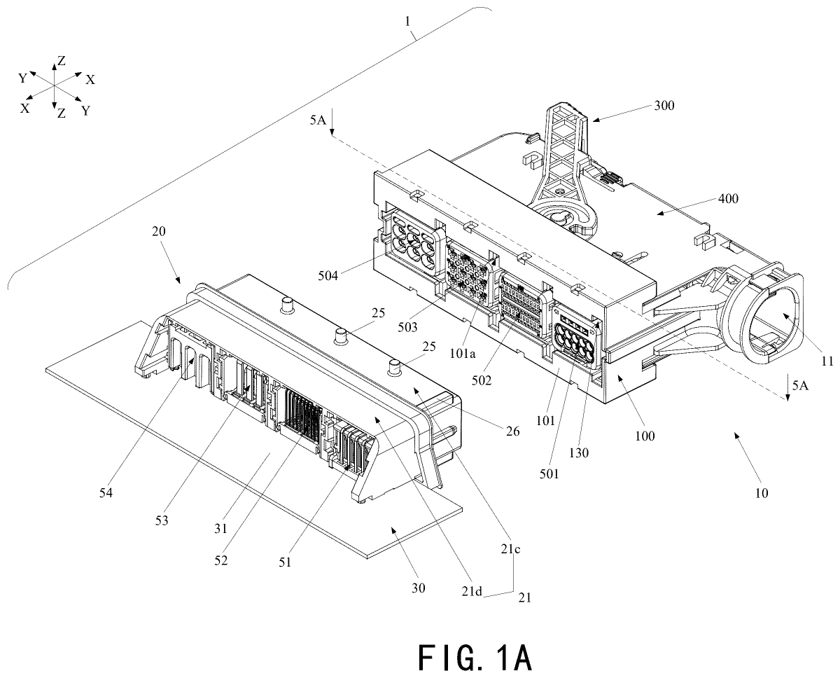

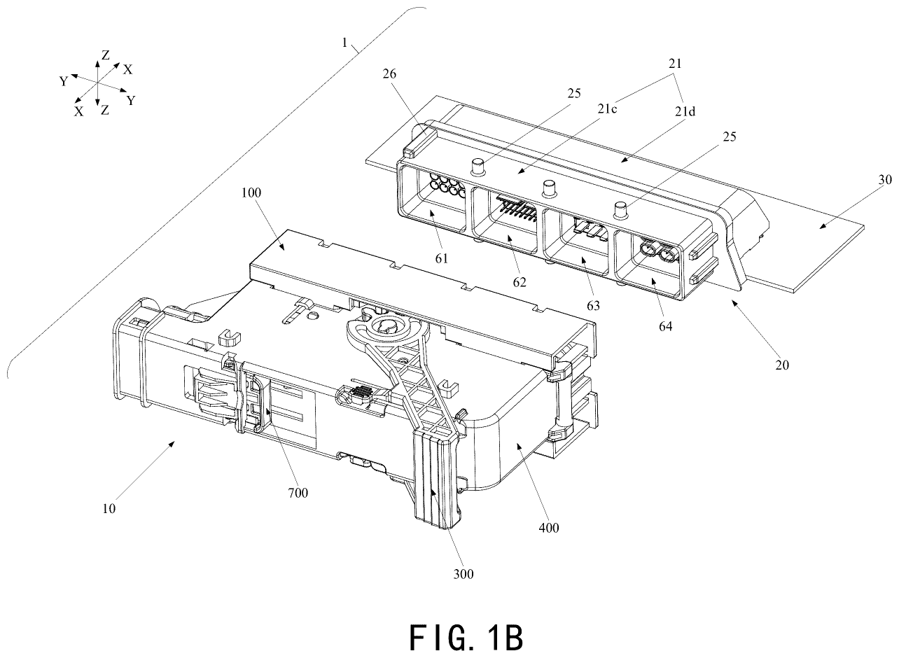

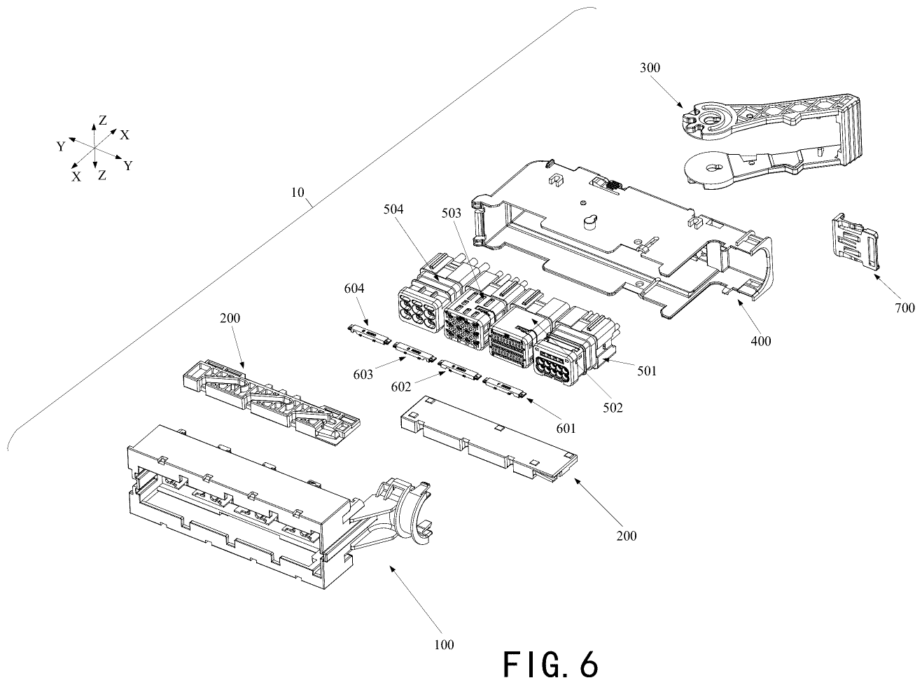

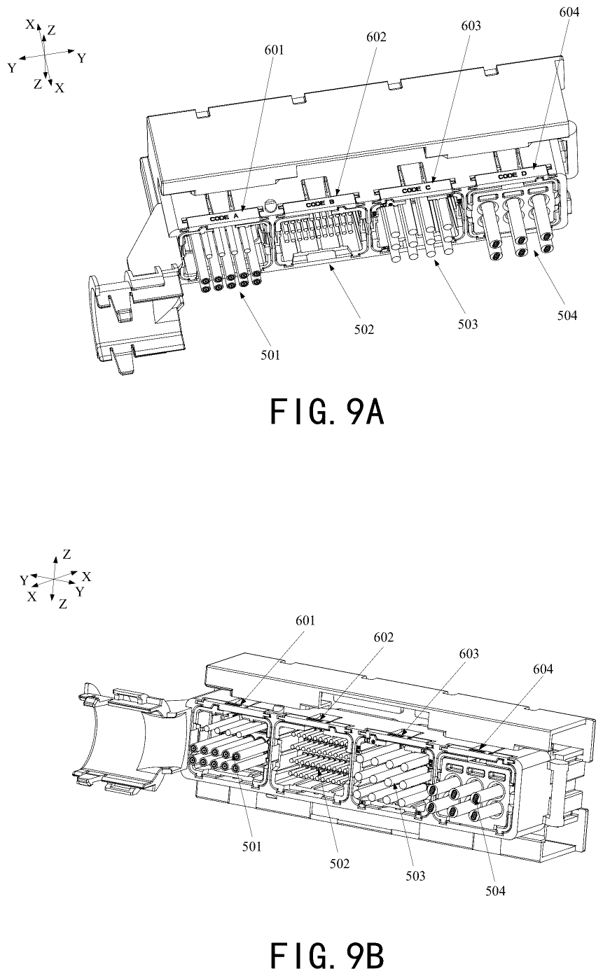

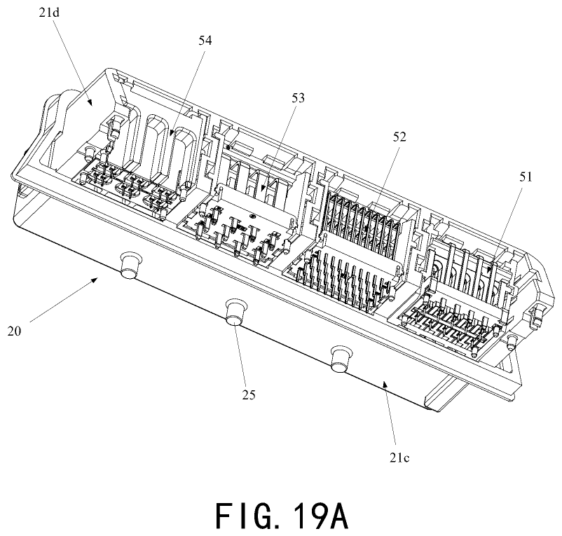

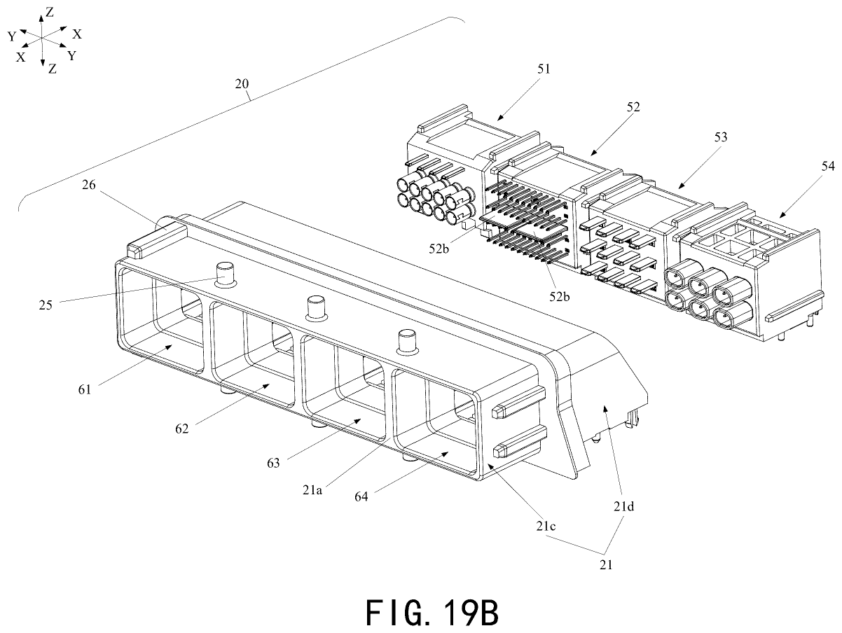

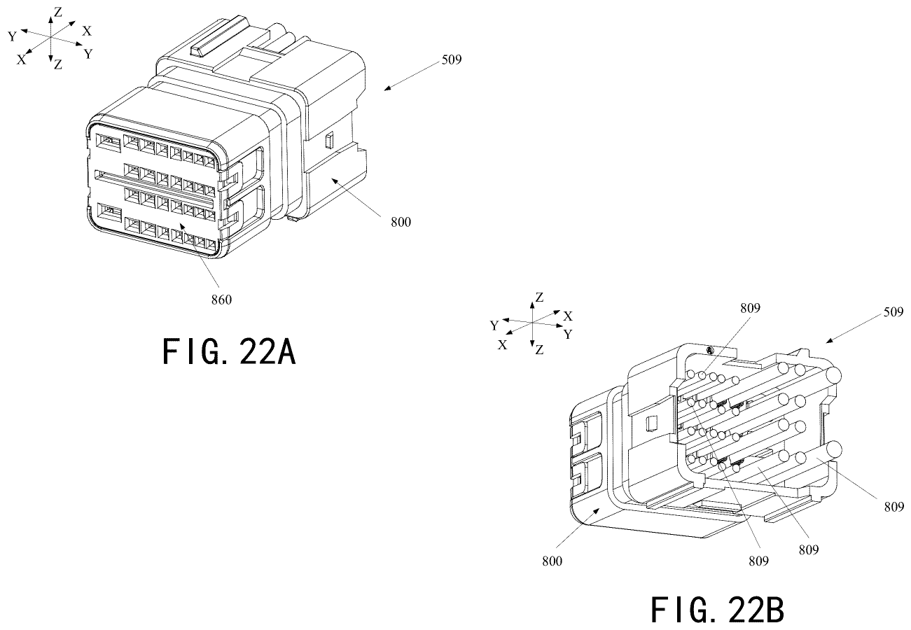

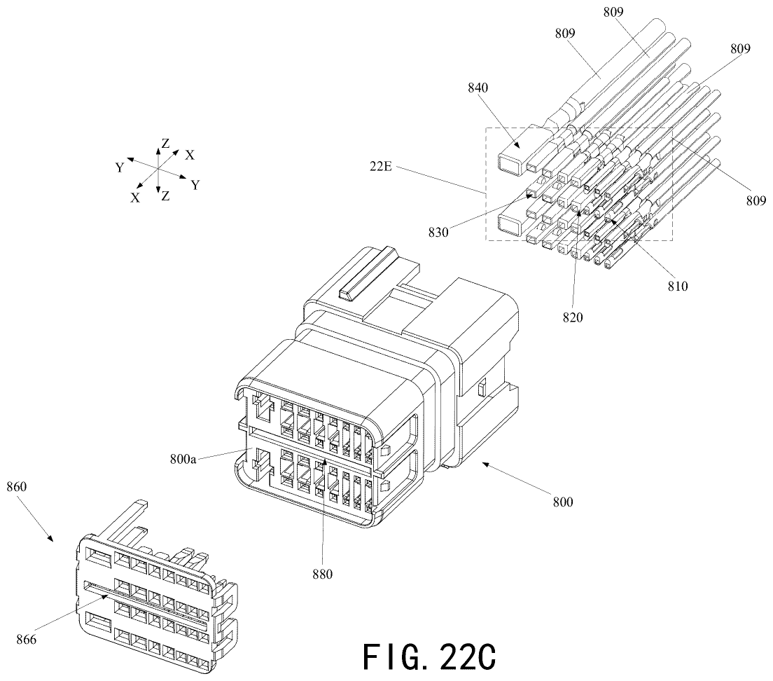

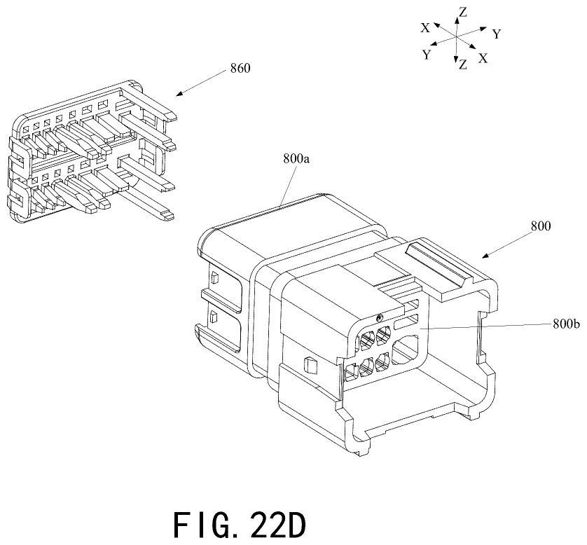

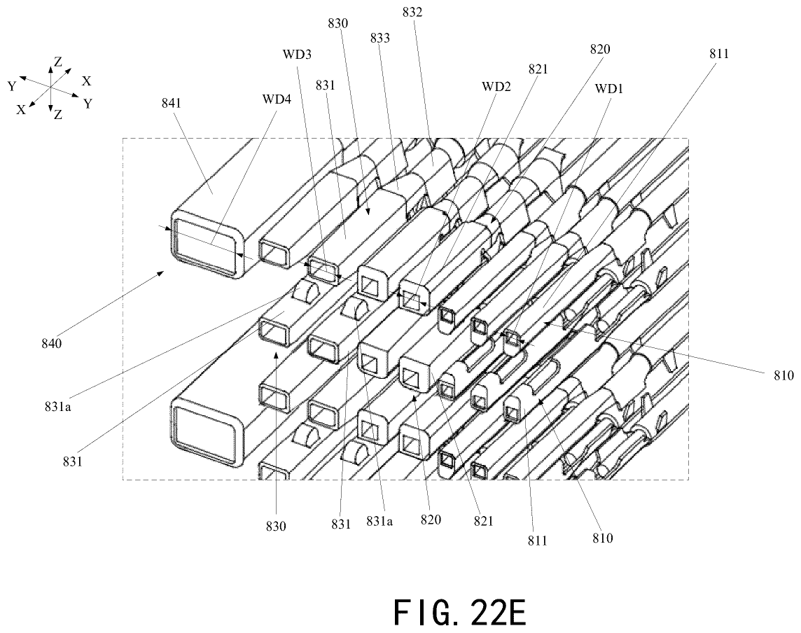

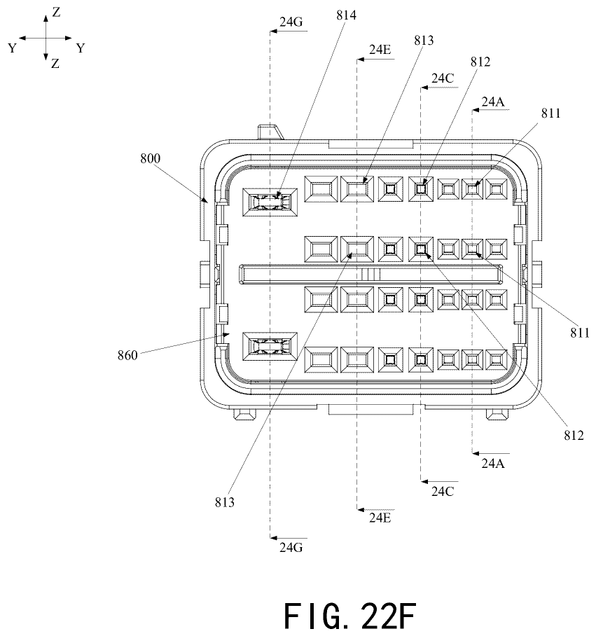

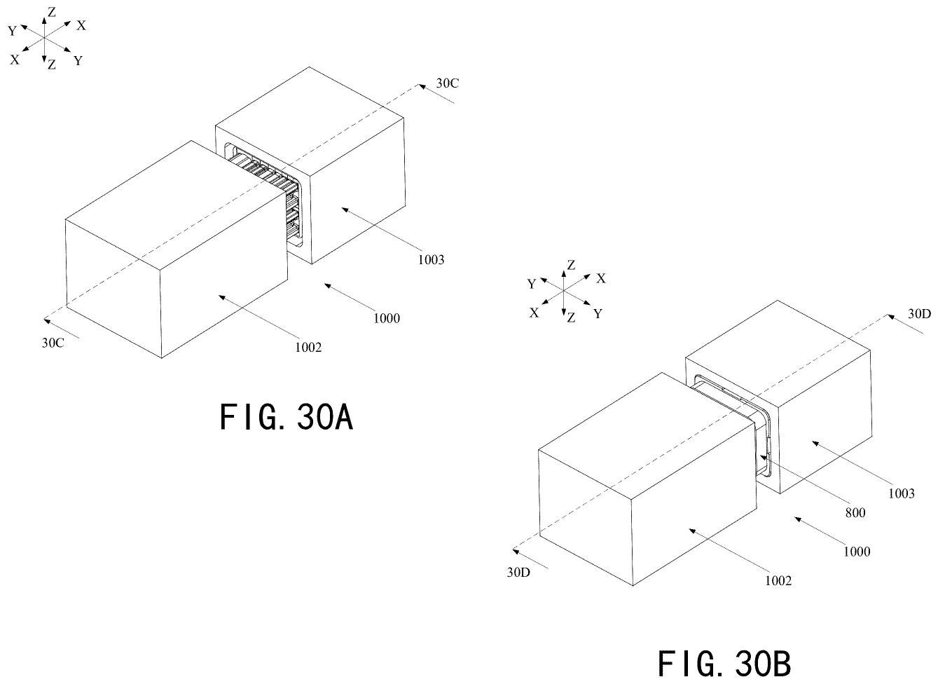

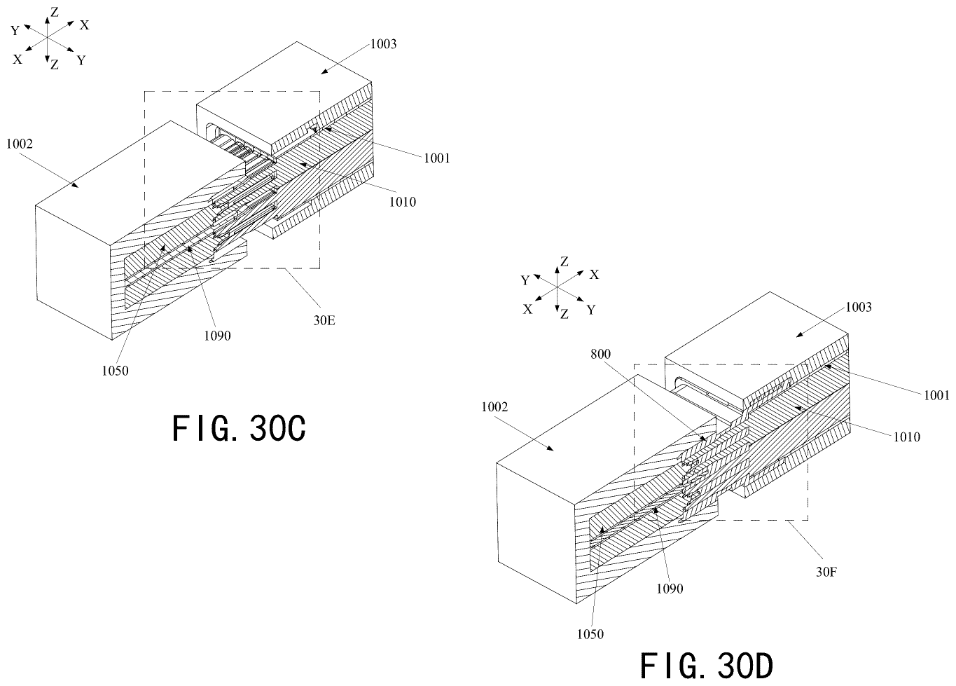

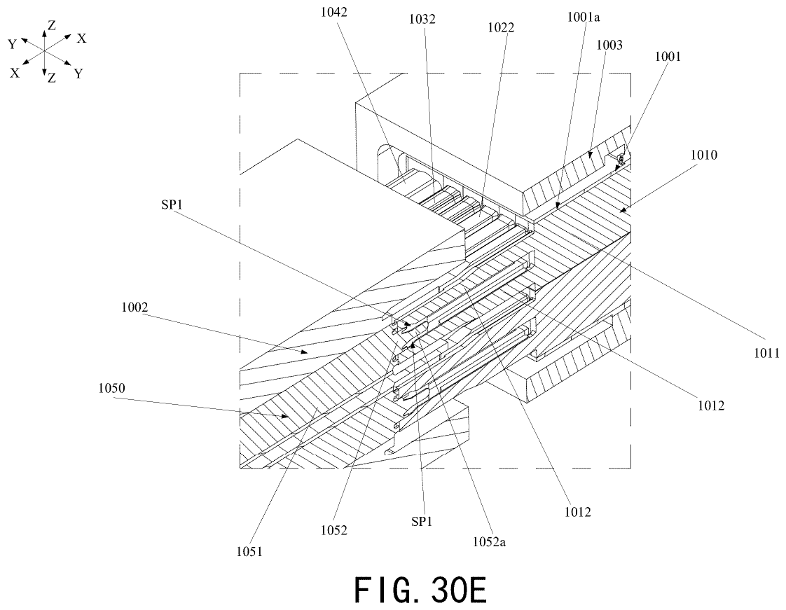

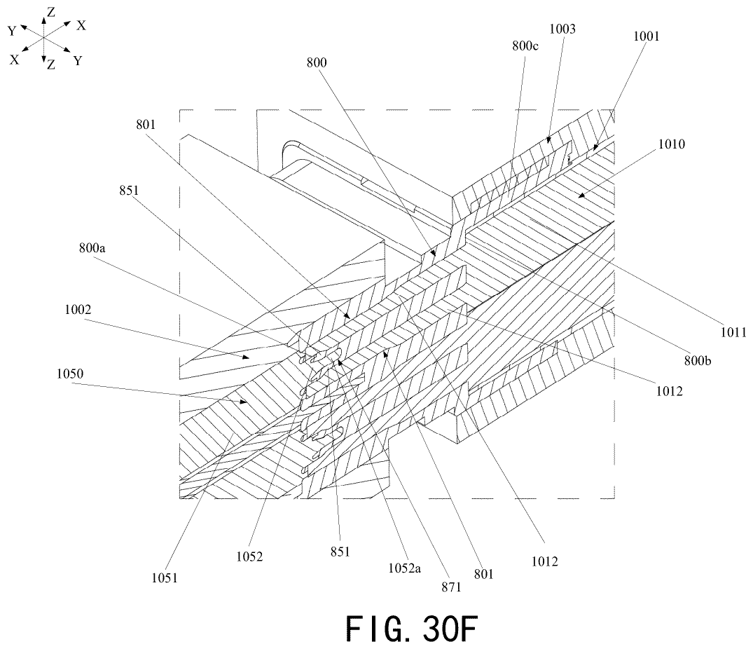

FIGS. 1A to 5C illustrate an electronic system 1 including a first electrical connector 10, a second electrical connector 20, and a circuit board 30, according to some embodiments. FIGS. 6 to 18C illustrate aspects of the first electrical connector 10. FIGS. 19A to 21C illustrate aspects of the second electrical connector 20. FIGS. 22A to 29B illustrate alternative versions of modules that may be used in the first electrical connector 10 and the second electrical connector 20. FIGS. 30A to 35 illustrate an exemplary method for manufacturing a module housing of a module.

For the sake of clarity and conciseness of the description, a lateral direction X-X, a longitudinal direction Y-Y, and a vertical direction Z-Z may be defined in FIGS. 1A to 35. The lateral direction X-X, the longitudinal direction Y-Y, and the vertical direction Z-Z may be perpendicular to each other. The lateral direction X-X may refer to a length direction of the first electrical connector 10 and the second electrical connector 20. The longitudinal direction Y-Y may refer to a width direction of the first electrical connector 10 and the second electrical connector 20. The vertical direction Z-Z may refer to a height direction of the first electrical connector 10 and the second electrical connector 20.

The electronic system 1 may be used for signal and/or power transmission applications. For example, the electronic system 1 may be used in applications such as automobiles. For example, the electronic system 1 may be part of a system of an automobile, such as a radar, a LiDAR, high-speed signal transmission systems (e.g., 5G), an engine, transmission control units (TCUs), security systems, emissions control, lighting, advanced driver assistance systems (ADASs), entertainment systems, navigation systems, and cameras. The first electrical connector 10 and the second electrical connector 20 may constitute a connector assembly for establishing an electrical connection between two electrical components to enable signal transmission (e.g., high data rate transmission) and/or power transmission therebetween.

For example, the first electrical component may be the circuit board 30 shown in the figures. In some embodiments, the circuit board 30 may be “a printed circuit board” or “PCB”. In some embodiments, the circuit board 30 may be a motherboard, such as a motherboard of an ECU of an automobile. The ECU may be configured to control a variety of different vehicle systems, such as a radar, a LiDAR, an engine, TCU, security systems, emissions control, lighting, ADASs, entertainment systems, navigation systems, and cameras. It should be appreciated that the circuit board 30 may be any suitable type of circuit board, and any suitable type of electronic component may be mounted on the circuit board 30. Further, only a portion of the circuit board 30 is shown in the figures.

The second electrical component may be any suitable electrical component to be connected to the first electrical component (e.g., the circuit board 30). For example, the second electrical component may be a sensor (for example, a camera, a radar, or a LiDAR), an actuator, a display, or any other device of the automobile.

Although the second electrical component is not shown, it should be appreciated that the second electrical component may be spaced apart from the first electrical component by a very far distance. The connection between the first electrical component and the second electrical component may be achieved by cables.

The first electrical connector 10 may include modules that may be terminated with cables, which may be connected to the second electrical component. In this way, the first electrical connector 10 may be electrically connected to the second electrical component via cables. The first electrical connector 10 may be a cable connector.

In some embodiments, as shown in FIGS. 1A and 1B, the second electrical connector 20 may be a board connector that is mounted on and connected to the circuit board 30. For example, the second electrical connector 20 may be mechanically fixed on a surface 31 of the circuit board 30 and establish an electrical connection with a conductive structure (not shown) of the circuit board 30, such as conductive through-holes or conductive pads. The second electrical connector 20 may also include modules that may be electrically connected (e.g., by surface mount technology (SMT) or through-hole technology (THT)) to corresponding conductive structures of the circuit board 30 to establish electrical connections between the second electrical connector 20 and the circuit board 30. The modules of the second electrical connector 20 may also provide an electrical interface for electrically connecting the first electrical connector 10 to the circuit board 30.

The first electrical connector 10 may be configured to be mated with the second electrical connector 20 to establish an electrical connection therebetween. For example, the modules of the first electrical connector 10 may be mated with the modules of the second electrical connector 20, and the housing structure of the first electrical connector 10 may be mated with the housing structure of the second electrical connector 20, thereby establishing electrical and mechanical connections between the first electrical connector 10 and the second electrical connector 20. In this way, the first electrical connector 10 and the second electrical connector 20 may establish an electrical connection between the first electrical component (e.g., the circuit board 30) and the second electrical component to achieve signal transmission and/or power transmission.

In the illustrated example, the first electrical connector 10, the second electrical connector 20, the first electrical component, and the second electrical component may together constitute the electronic system 1. The first electrical connector 10 may be a plug connector and the second electrical connector 20 may be a receptacle connector. It should be appreciated that the use of the electronic system 1 and the connector assembly according to the present application may not be limited to automotive applications, and may be used in any suitable application scenario.

The first electrical connector 10 and the second electrical connector 20 may be configured to mate with each other in a mating direction to establish electrical and mechanical connections therebetween. The mating direction may be parallel to the lateral direction X-X. It should be appreciated that the orientation of the mating direction may not be limited thereto.

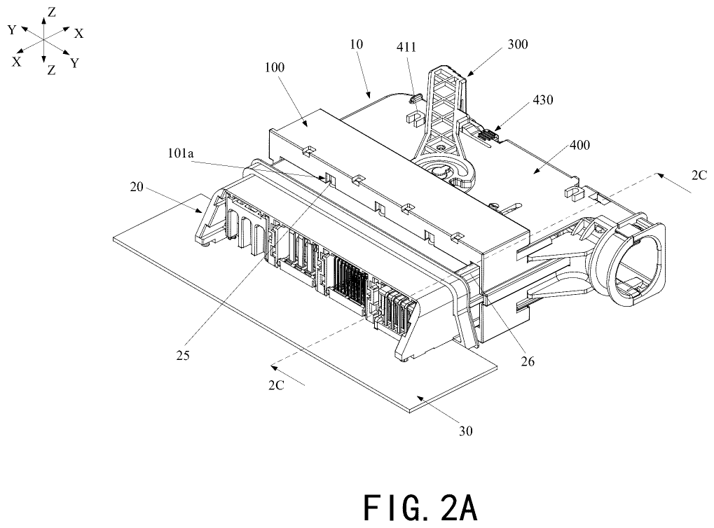

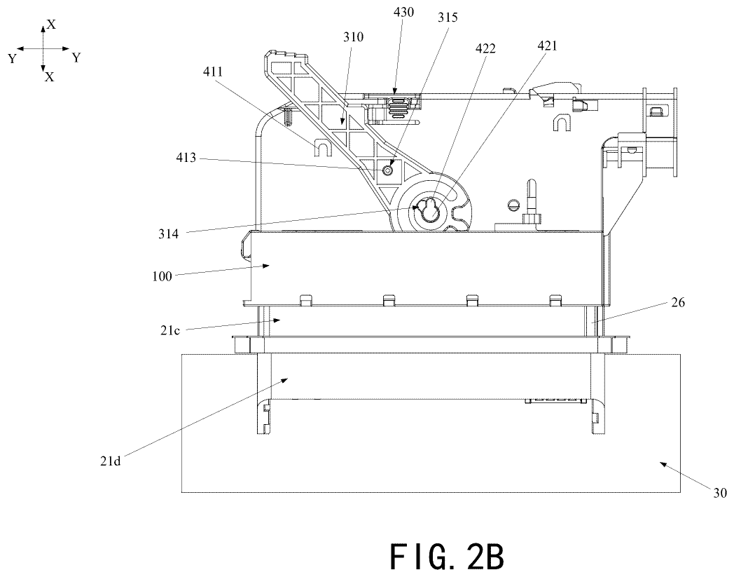

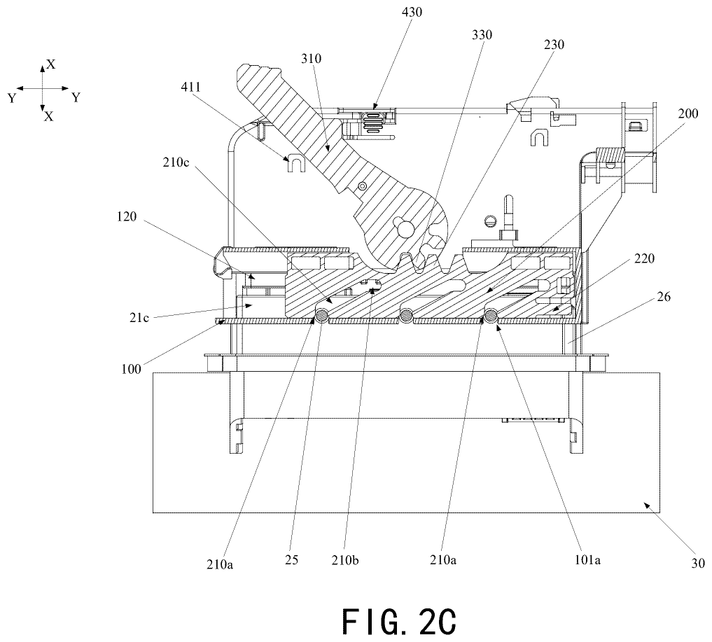

During the mating of the first electrical connector 10 with the second electrical connector 20, a user may first place the first electrical connector 10 and the second electrical connector 20 from a separated state (e.g., as shown in FIGS. 1A and 1B) into an initial mating state as shown in FIGS. 2A-2C. As shown in FIGS. 1A and 1B, the first electrical connector 10 and the second electrical connector 20 are separated from each other when in the separated state. For example, the separated state may be a state before mating the first electrical connector 10 with the second electrical connector 20. As shown in FIGS. 2A to 2C, the first electrical connector 10 and the second electrical connector 20 are placed in an initial mating state. In this case, the second electrical connector 20 is positioned in an initial mating position relative to the first electrical connector 10. It should be appreciated that positioning the second electrical connector 20 in the initial mating position relative to the first electrical connector 10 may be achieved by moving the first electrical connector 10 toward the second electrical connector 20, moving the second electrical connector 20 toward the first electrical connector 10, or moving the first electrical connector 10 and the second electrical connector 20 toward each other.

When the first electrical connector 10 and the second electrical connector 20 are placed in the initial mating state, the user may move the second electrical connector 20 relative to the first electrical connector 10 in the mating direction (which, as described above, may be parallel to the lateral direction X-X) to a mated position where the second electrical connector 20 is completely mated with the first electrical connector 10.

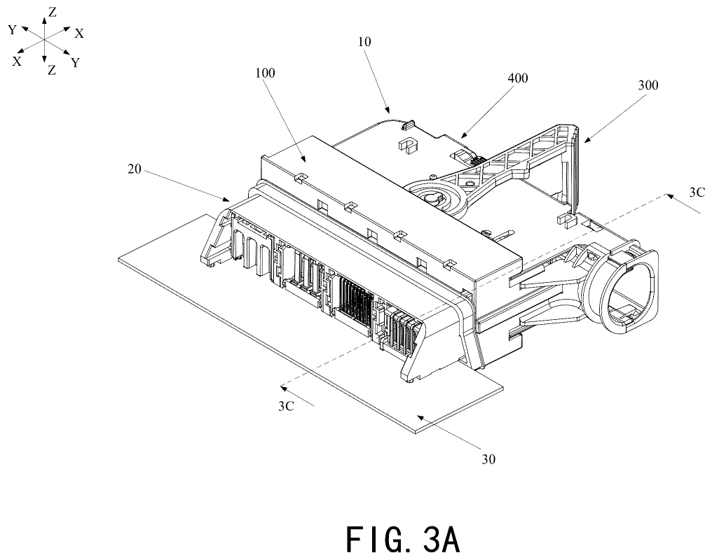

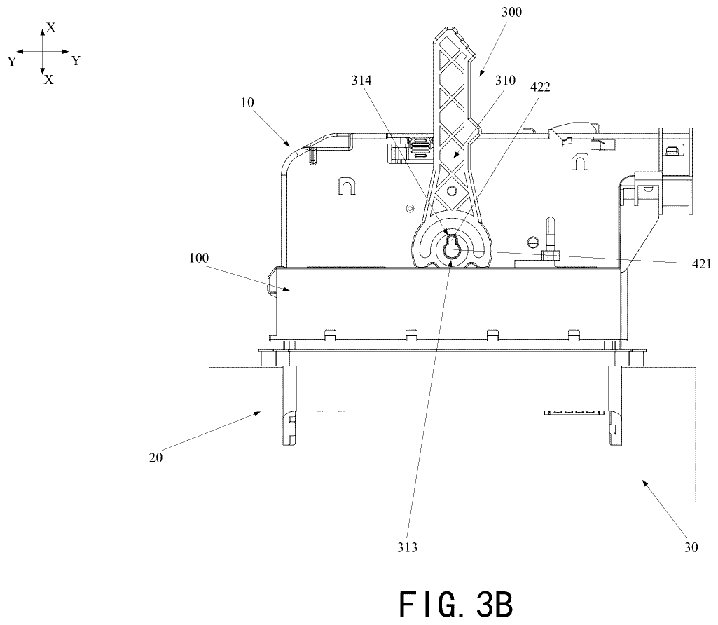

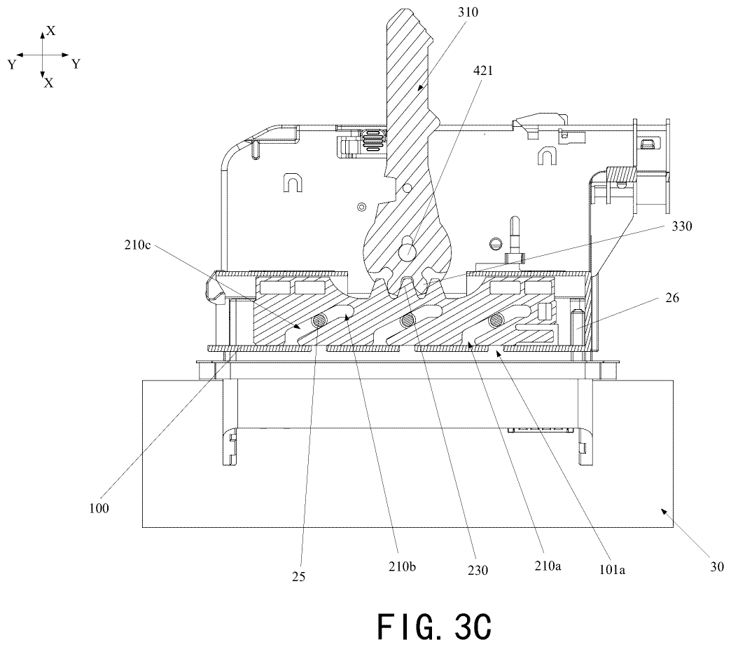

For example, the user may transition the first electrical connector 10 and the second electrical connector 20 from the initial mating state shown in FIGS. 2A-2C to the partial mating state shown in FIGS. 3A-3C. Compared with the initial mating state, in the partial mating state, the second electrical connector 20 is further closer to the first electrical connector 10 in the mating direction. The second electrical connector 20 is moved to a partial mating position relative to the first electrical connector 10.

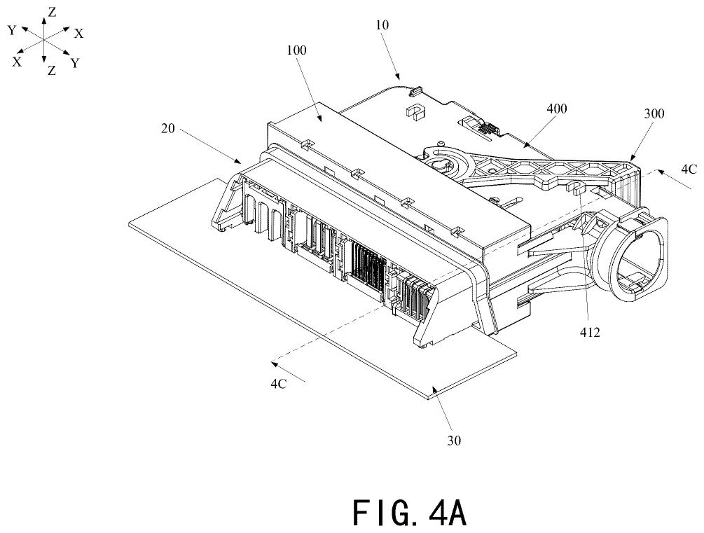

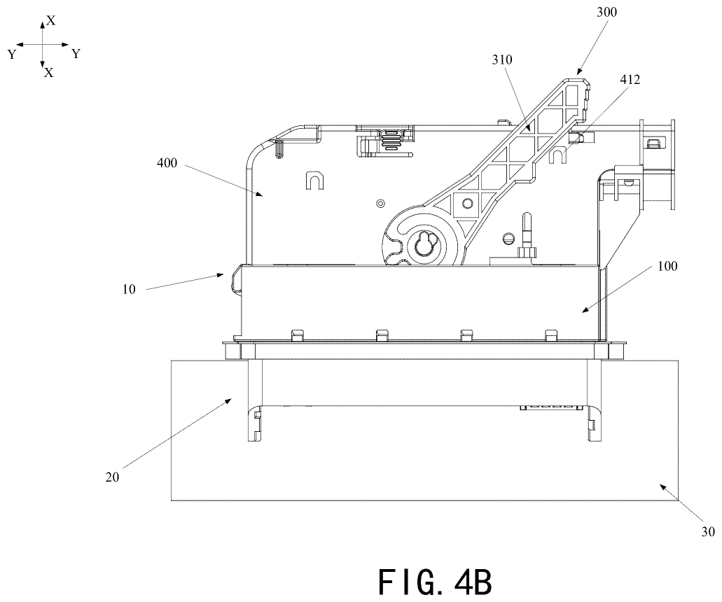

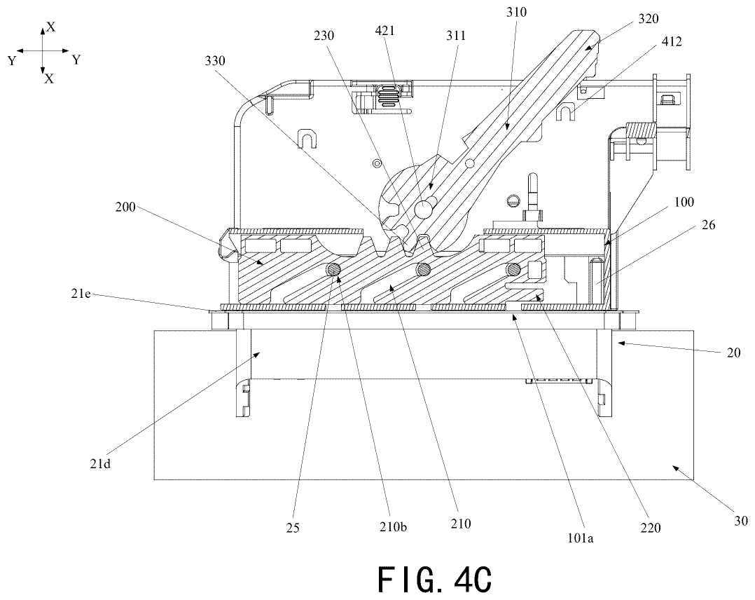

Next, the user may transition the first electrical connector 10 and the second electrical connector 20 from the partial mating state shown in FIGS. 3A to 3C to the mated state shown in FIGS. 4A to 4C. Compared with the partial mating state, in the mated state, the second electrical connector 20 is further closer to the first electrical connector 10 in the mating direction. The second electrical connector 20 is moved relative to the first electrical connector 10 to a mated position. The first electrical connector 10 and the second electrical connector 20 are completely mated with each other when in the mated state, thereby establishing reliable electrical and mechanical connections therebetween.

Further aspects of the first electrical connector 10 and the second electrical connector 20 will be described below.

FIGS. 1A to 4C illustrate the first electrical connector 10 assembled, and FIG. 6 illustrates the first electrical connector 10 partially exploded. As shown in FIGS. 1A to 4C and 6, the first electrical connector 10 may include a first housing 100, a slider 200, a locking member 300, a cover 400, a plurality of modules 501-504, a plurality of key members 601-604, and a connector position assurance (CPA) device 700.

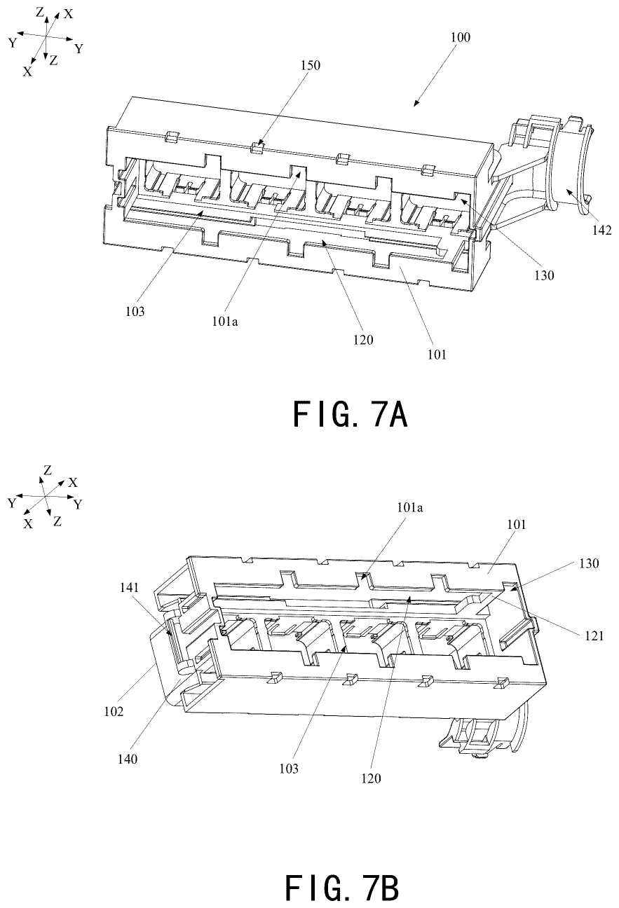

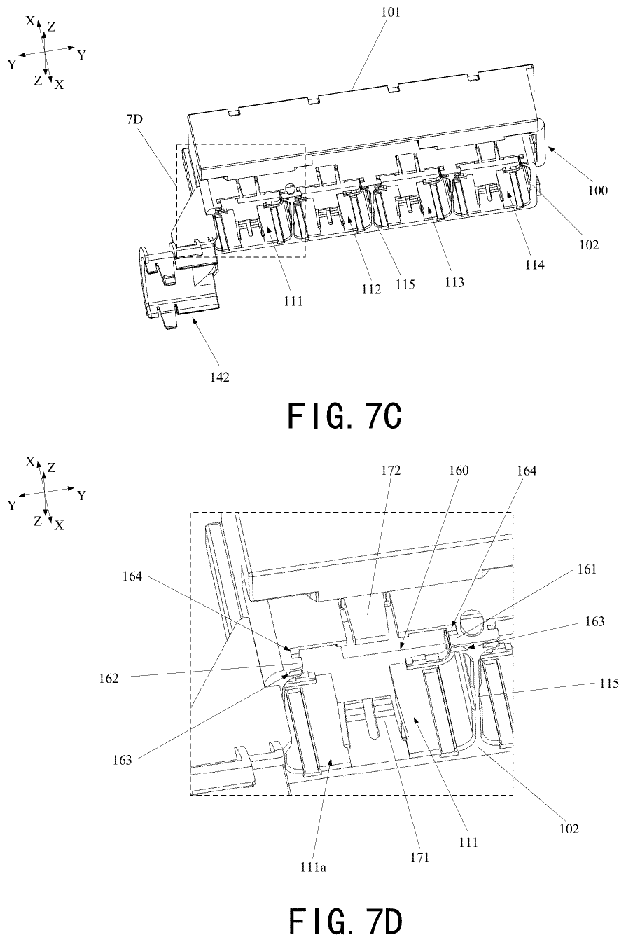

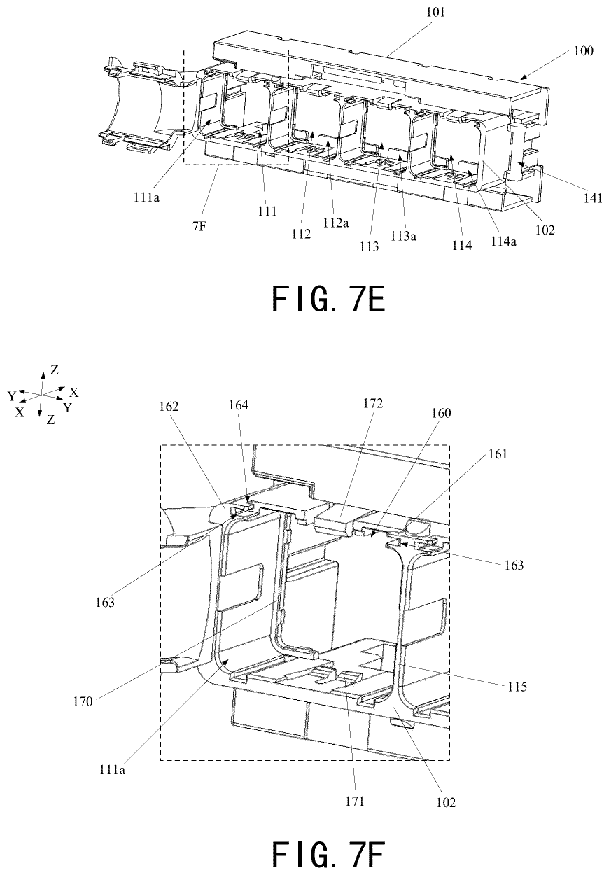

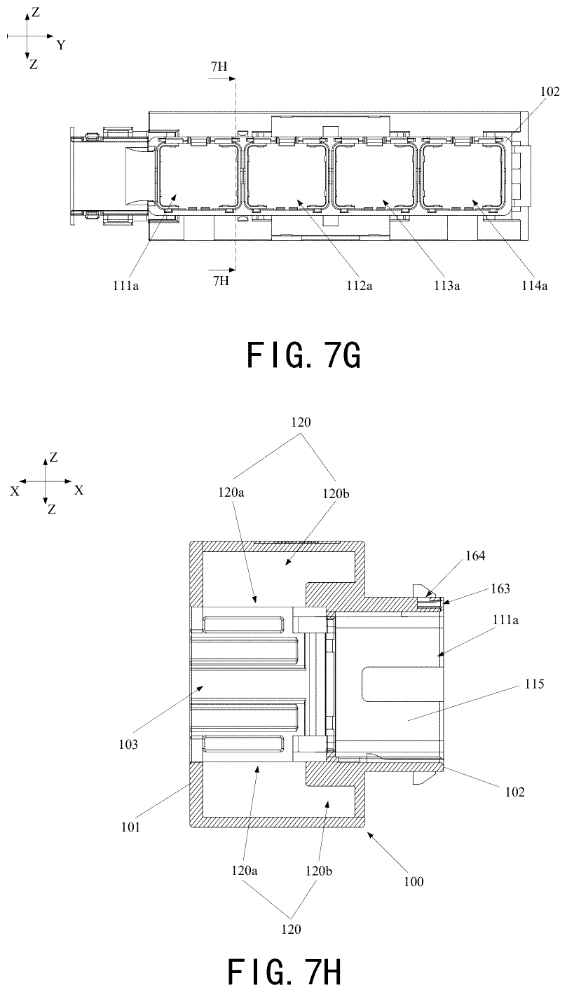

The first housing 100 may be formed from a metal material, an insulative material, or any other suitable material. As shown in FIG. 1A, the first housing 100 may be configured to accommodate the plurality of modules 501-504. As shown in FIGS. 7A-7H, the first housing 100 may include a mating face 101 and a rear face 102 opposite to each other in the lateral direction X-X. The first housing 100 may be configured to mate with the second housing 21 of the second electrical connector 20 at the mating face 101 to establish a mechanical connection between the first electrical connector 10 and the second electrical connector 20.

As shown in FIGS. 7A to 7H, the first housing 100 may further include an accommodation space 103 recessed into the first housing 100 in the lateral direction X-X from the mating face 101, and a plurality of cavities 111-114 recessed into the first housing 100 in the lateral direction X-X from the rear face 102. The plurality of cavities 111-114 may include a first cavity 111, a second cavity 112, a third cavity 113, and a fourth cavity 114. It should be appreciated that the number of cavities may not be limited thereto. Each of the plurality of cavities 111-114 may extend in the lateral direction X-X to communicate with the accommodation space 103 and be configured to accommodate a corresponding one of the plurality of modules 501-504. The portion of the first housing 100 defining the plurality of cavities 111-114 may be referred to as a base portion of the first housing 100, and the portion of the first housing 100 defining the accommodation space 103 may be referred to as an accommodation portion of the first housing 100. The accommodation portion of the first housing 100 is a portion enclosing the accommodation space 103. In the illustrated example, the plurality of cavities 111-114 are formed in the base portion of the first housing 100, and the accommodation space 103 is formed in the accommodation portion of the first housing 100. The accommodation portion of the first housing 100 extends from the base portion in the lateral direction X-X. The plurality of cavities 111-114 may be arranged in a row in the longitudinal direction Y-Y, and every two adjacent cavities may be separated by a separation wall 115 of the base portion of the first housing 100. It should be appreciated that the arrangement of the cavities may not be limited thereto. The accommodation space 103 may be a single space extending in the longitudinal direction Y-Y. The accommodation space 103 may be configured to receive a portion of the housing of the second electrical connector 20.

The first electrical connector 10 may be a modular hybrid electrical connector and may be a cable connector. For example, as shown in FIG. 6, the plurality of modules 501-504 may include a first module 501, a second module 502, a third module 503, and a fourth module 504. The first module 501, the second module 502, the third module 503, and the fourth module 504 are configured to be assembled into the first cavity 111, the second cavity 112, the third cavity 113, and the fourth cavity 114 of the first housing 100, respectively.

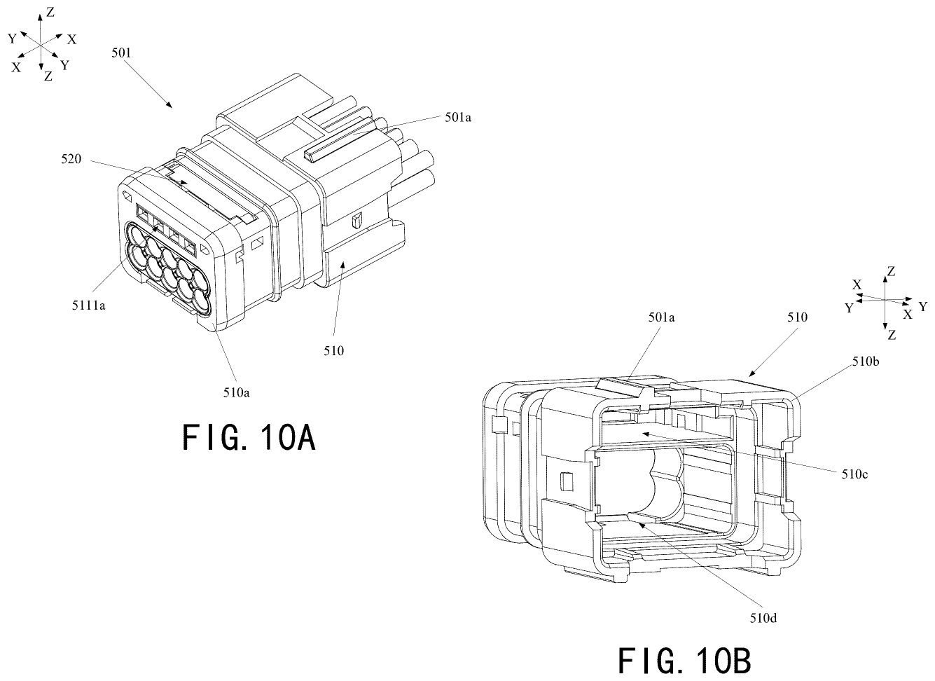

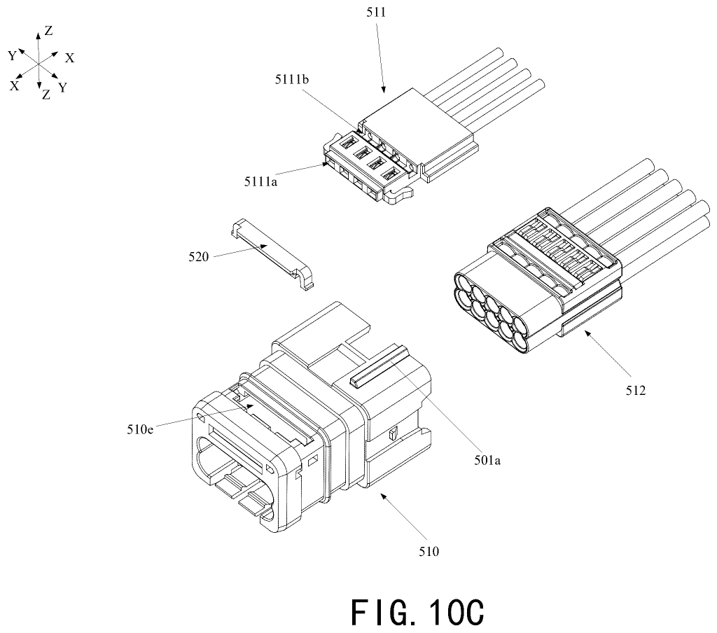

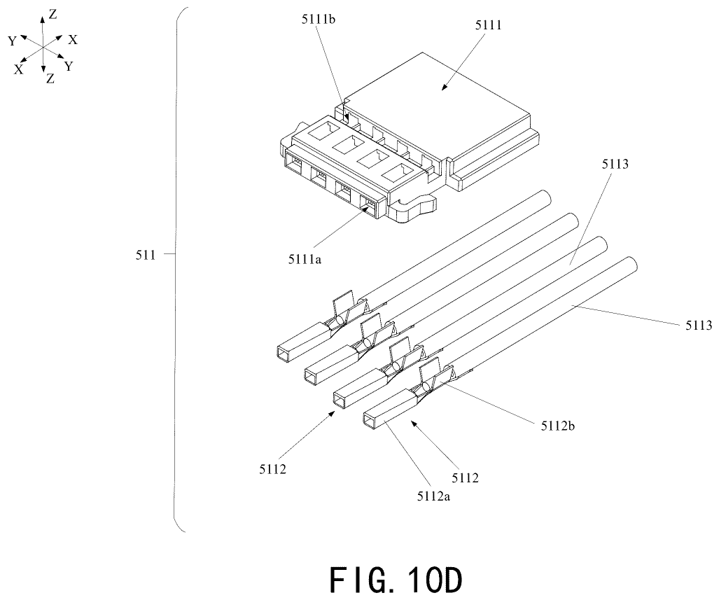

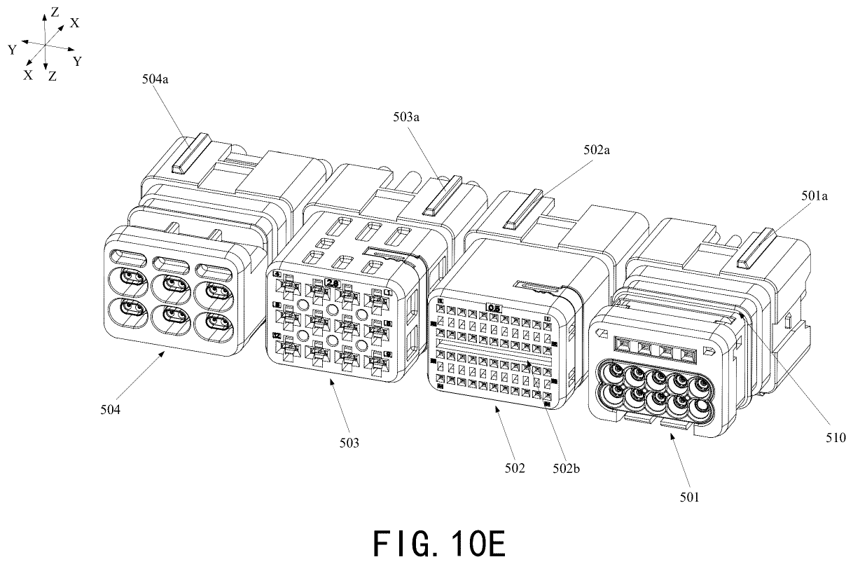

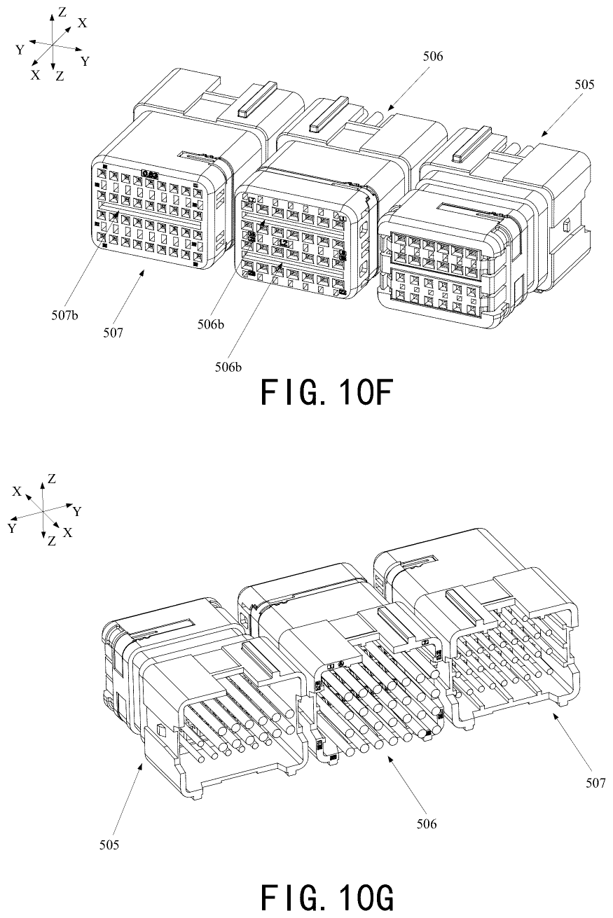

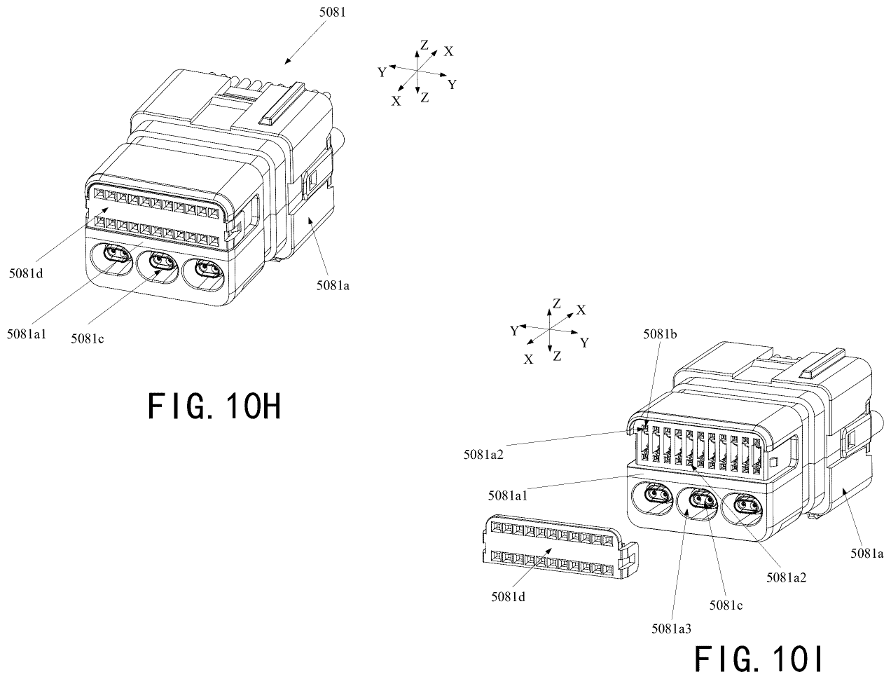

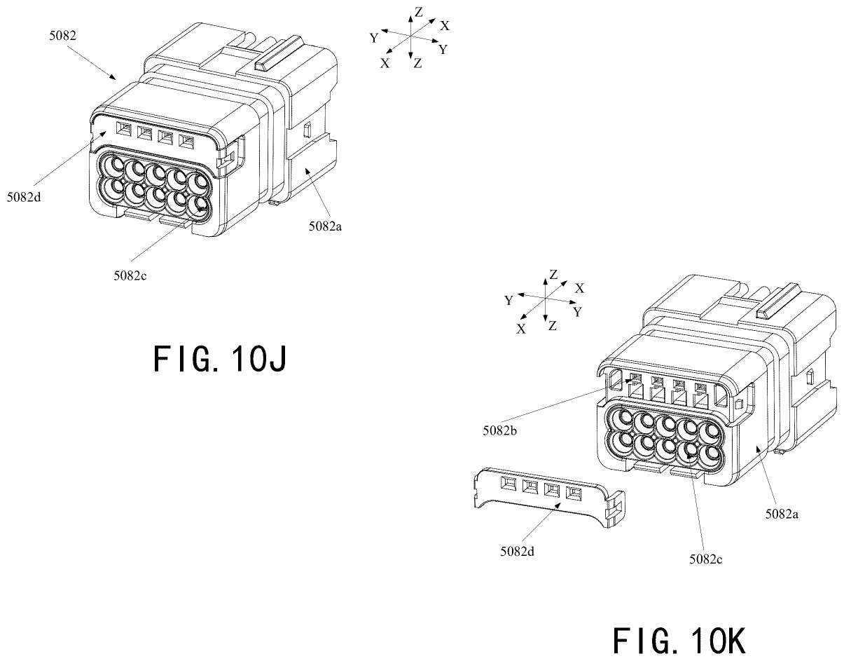

FIGS. 10A to 10D illustrate aspects of the first module 501. As shown in FIGS. 10A to 10D, the first module 501 may include a module housing 510 and at least one terminal subassembly disposed in the module housing 510, which includes two terminal subassemblies in this example, a first terminal subassembly 511 and a second terminal subassembly 512.

The module housing 510 may be formed from a metal material, an insulative material, or any other suitable material. The module housing 510 may include a mating face 510a and a mounting face 510b opposite to each other in the lateral direction X-X, and a first sub-cavity 510c and a second sub-cavity 510d each recessed into the module housing 510 in the lateral direction X-X from the mounting face 510b. The first sub-cavity 510c and the second sub-cavity 510d are each formed with an opening at the mating face 510a.

As shown in FIGS. 10C and 10D, the first terminal subassembly 511 may include a terminal retention member 5111, a plurality of conductive terminals 5112, and a plurality of cables 5113. The terminal retention member 5111 may be formed from an insulative material. The conductive terminal 5112 may be formed from a conductive material. For example, as shown in FIG. 10D, the conductive terminal 5112 may be in the form of a crimp terminal configured to be terminated with a cable 5113. The conductive terminal 5112 may include a mating end 5112a and a crimp end 5112b opposite to the mating end 5112a. One end of the conductor of the cable 5113 may be attached to and retained by the crimp end 5112b. In this way, mechanical and electrical connections may be established between the conductive terminal 5112 and the cable 5113. It should be appreciated that the connection manner between the conductive terminal 5112 and the cable 5113 may not be limited thereto, and other techniques such as soldering may be used. Only a segment of the cable 5113, rather than the entire cable 5113, is shown in the figures. It should be appreciated that the other end of the conductor of the cable 5113 may be connected to a corresponding conductive structure of the aforementioned second electrical component. Further, although the cable 5113 has been described herein as being part of the first terminal subassembly 511, it should be appreciated that the cable 5113 may also be a separate component. It should be appreciated that although the mating end 5112a of the conductive terminal 5112 is shown in the form of a receiving portion for receiving a pin in FIG. 10D, the specific form of the mating end of the conductive terminal may not be limited thereto.

As shown in FIG. 10C, the plurality of conductive terminals 5112 may be disposed in the terminal retention member 5111 to be held by the terminal retention member 5111. The mating ends 5112a of the conductive terminals 5112 may be exposed at apertures 5111a of the terminal retention member 5111 to enable the mating ends 5112a of the conductive terminals 5112 to mate with mating ends of mating conductive terminals of the second electrical connector 20. The crimp ends 5112b of the conductive terminals 5112 may be located in the terminal retention member 5111.

As shown in FIG. 10A, when the first terminal subassembly 511 is disposed in the first sub-cavity 510c, the apertures 5111a of the terminal retention member 5111 may be exposed by the opening of the first sub-cavity 510c at the mating face 510a, so that the mating ends 5112a of the conductive terminals 5112 can be mated with the mating ends of the mating conductive terminals of the second electrical connector 20. Although the mating ends 5112a of the conductive terminals 5112 are shown in the figures as being located within the apertures 5111a, it should be appreciated that the present application may not be limited thereto, and in some embodiments, the mating ends 5112a of the conductive terminals 5112 may protrude from the apertures 5111a.

In some embodiments, as shown in FIGS. 10C and 10D, the first terminal subassembly 511 may be configured to be removably disposed in the module housing 510. Such a configuration of the first module 501 allows conductive terminals of different shapes (including sizes) and/or types to be assembled to the first module 501 by the terminal retention members 5111 having identical or substantially identical external sizes. This may enable assembling conductive terminals of different shapes and/or types to the first module 501 by replacing production mold parts. This helps improve the use flexibility of the first module 501. Terminal subassemblies having conductive terminals of different shapes (including sizes) and/or types may share one and the same module housing 510, which may reduce the labor associated with mold development. The module housing 510 may enable reuse by replacing terminal subassemblies carrying conductive terminals of different shapes and/or types. In this way, energy can be saved and emissions can be reduced.

For example, the first terminal subassembly 511 may be removably assembled into the first sub-cavity 510c of the module housing 510 in a snap-fit manner. Alternatively or additionally, the first module 501 may include a terminal position retention (TPA) device 520 configured to releasably hold the first terminal subassembly 511 in the first sub-cavity 510c. As shown in FIGS. 10C and 10D, the first terminal subassembly 511 includes a first notch 5111b and the module housing 510 includes a second notch 510e. When the first terminal subassembly 511 is disposed in the first sub-cavity 510c, the first notch 5111b is aligned with the second notch 510e (e.g., in the vertical direction Z-Z). As shown in FIG. 10A, the TPA device 520 may be inserted into the first notch 5111b via the second notch 510e to hold the first terminal subassembly 511 in the first sub-cavity 510c. Further, the first terminal subassembly 511 can be released from the module housing 510 by removing the TPA device 520 from the first notch 5111b, allowing the first terminal subassembly 511 to be removed from the first sub-cavity 510c.

Although the first terminal subassembly 511 has been described above as being assembled into the first sub-cavity 510c from the opening at the mounting face 510b, it should be appreciated that the present application may not be limited thereto. In some embodiments, the first terminal subassembly 511 may also be assembled into the first sub-cavity 510c from the opening at the mating face 510a.

Although the first terminal subassembly 511 has been described above as holding the plurality of conductive terminals 5112, it should be appreciated that the present application may not be limited thereto, and in some embodiments, the first terminal subassembly 511 may hold a single conductive terminal.

Further, although the plurality of conductive terminals 5112 has been described above as being held in the module housing 510 by the first terminal subassembly 511, it should be appreciated that the present application may not be limited thereto. In some embodiments, the plurality of conductive terminals 5112 may be directly disposed in the module housing 510. In this case, the module housing 510 may be formed from an insulative material. The plurality of conductive terminals 5112 may be inserted directly into the module housing 510 or the module housing 510 may be overmolded around the plurality of conductive terminals 5112.

For example, FIGS. 10H to 10K illustrate two versions of modules 5081 and 5082, wherein conductive terminals thereof are disposed directly in the module housing. For example, as shown in FIGS. 10H and 101, the module 5081 includes a module housing 5081a, an upper row of terminals 5081b, a lower row of terminals 5081c, and a TPA (terminal position retention) device 5081d. Each terminal of the upper row of terminals 5081b may be assembled into a terminal channel 5081a2 of the module housing 5081a from an opening located at a mounting face of the module housing 5081a opposite to the mating face 5081a1. The TPA device 5081d may be attached to the module housing 5081a at the mating face 5081a1 and securely hold the upper row of terminals 5081b in the module housing 5081a. Regarding the detailed manner in which the TPA device 5081d of the module 5081 cooperates with the module housing 5081a and the upper row of terminals 5081b, reference may be made to the manner, as described below in connection with FIGS. 22A to 27, in which the TPA device of the module 509 cooperates with the module housing and the terminals. The lower row of terminals 5081c may also be assembled into the terminal channels 5081a3 of the module housing 5081a from an opening located at the mounting face.

Similar to the module 5081, as shown in FIGS. 10J and 10K, the module 5082 may include a module housing 5082a, an upper row of terminals 5082b, a lower row of terminals 5082c, and a TPA (terminal position retention) device 5082d. The upper row of terminals 5082b of the module 5082 shown in FIGS. 10J and 10K are identical to the plurality of conductive terminals 5112 of the module 501 shown in FIGS. 10C and 10D, but the upper row of terminals 5082b are disposed directly in the module housing 5082a. The upper row of terminals 5082b and the lower row of terminals 5082c of the module 5082 may be disposed in the module housing 5082a in a similar manner as the upper row of terminals 5081b and the lower row of terminals 5081c of the module 5081. For brevity, details of the similar parts may not be repeated.

Such configurations of the modules 5081 and 5082 enable conductive terminals of different shapes and/or types to be assembled to the modules 5081 and 5082 by replacing production mold parts. This helps to improve the use flexibility of the modules 5081 and 5082. Terminal subassemblies having conductive terminals of different shapes (including sizes) and/or types may share one and the same module housing, which may reduce the labor associated with mold development. The module housing may enable reuse by replacing terminal subassemblies carrying conductive terminals of different shapes and/or types. In this way, energy can be saved and emissions can be reduced.

As shown in FIG. 10C, the configurations of the second terminal subassembly 512 may be similar to those of the first terminal subassembly 511 and may be disposed in the second sub-cavity 510d of the module housing 510 in a similar manner to the first terminal subassembly 511. For brevity, details of the similar parts may not be repeated. The difference between the second terminal subassembly 512 and the first terminal subassembly 511 may be in that the shapes and/or types of the conductive terminals are different. For example, the first terminal subassembly 511 may include high-speed signal terminals, such as differential signal terminals, and the second terminal subassembly 512 may include low-speed signal terminals and/or power terminals.

As shown in FIG. 1A, the first module 501 may be disposed in the first cavity 111 of the first housing 100, and a portion of the first module 501 may extend into the accommodation space 103, so that the mating face 510a of the first module 501 is exposed in the accommodation space 103 of the first housing 100. When the first electrical connector 10 and the second electrical connector 20 are completely mated with each other, a corresponding module of the second electrical connector 20 may be mated with the first module 501 to establish an electrical connection therebetween.

As shown in FIG. 10E, configurations of the second module 502, the third module 503, and the fourth module 504 of the first electrical connector 10 may be respectively similar to those of the first module 501. The second module 502, the third module 503, and the fourth module 504 may be disposed in the corresponding cavities 112-114 in a similar manner to the first module 501. For brevity, details of the similar parts may not be repeated.

The difference between the first module 501, the second module 502, the third module 503, and the fourth module 504 of the first electrical connector 10 may be in that the shapes and/or types of conductive terminals or terminal subassemblies in the modules are different. It should be appreciated that the modules of the first electrical connector 10 may not be limited to including the modules 501-504. For example, as shown in FIGS. 10F and 10G, the modules 505, 506, and 507 are alternative versions of modules that may be used in the first electrical connector 10.

The plurality of modules 501-507 may include one or more of a signal module, a power module, and a hybrid module. As an example, the modules 501-507 may be one or more of a power/signal integration type, a NETbridge integration type, a Netbridge+power integration type, a Mini Fakra integration type, and a Mini Fakra+power integration type. The signal in the power/signal integration type may include one or more signals of a Controller Area Network (CAN) bus, a Local Interconnect Network (LIN) bus, a FlexRay bus, a Media Oriented System Transport (MOST) bus, and the like. As another example, the power terminal blade type in the modules 501-507 may be one or more of 0.5*0.4, 0.63*0.63, 1.2*0.6, 2.8*0.8, 9.5*1.2, or may be any suitable type.

The plurality of modules 501-507 may be held by one and the same housing (e.g., the first housing 100). The first housing 100 may serve as a carrier or an outer frame for holding the plurality of modules 501-507. When the first electrical connector 10 and the second electrical connector 20 are mated, the first housing 100 can ensure a precise alignment and a reliable lock of the plurality of modules 501-507 with the mating modules of the second electrical connector 20.

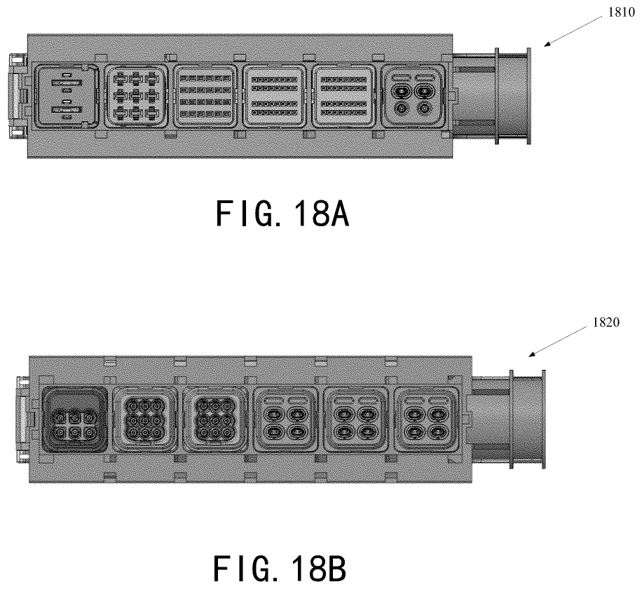

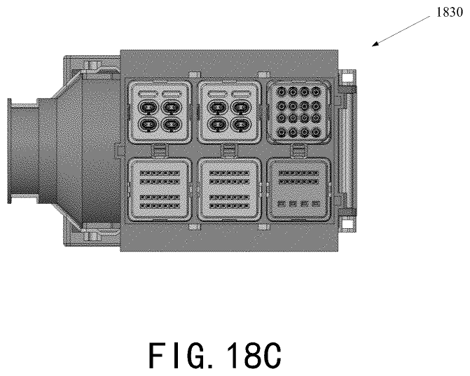

Although the modules 501-504 are shown in FIG. 1A as being arranged in a 1×4 array in the first electrical connector 10, it should be appreciated that the first electrical connector 10 may have any number and arrangement of modules. FIGS. 18A to 18C illustrate three variations of the first electrical connector 10. As shown in FIGS. 18A and 18B, the modules of the electrical connector 1810 may be arranged in a 1×6 array, and as shown in FIG. 18C, the modules of the electrical connector 1830 may be arranged in a 2×3 array. Further, the types of the modules of the electrical connector 1820 shown in FIG. 18B may be different from those of the modules of the electrical connector 1810.

FIGS. 1A to 4C and 19A illustrate the second electrical connector 20 assembled, and FIG. 19B illustrates the second electrical connector 20 partially exploded. As shown in FIGS. 1A to 4C, 19A, and 19B, the second electrical connector 20 may include a second housing 21 and a plurality of modules 51-54 disposed in the second housing 21.

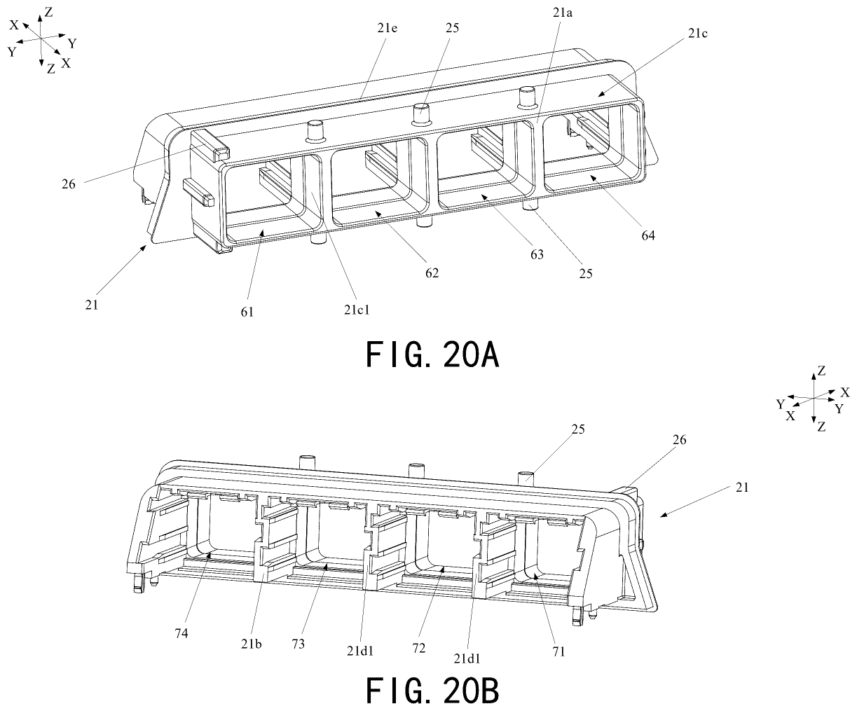

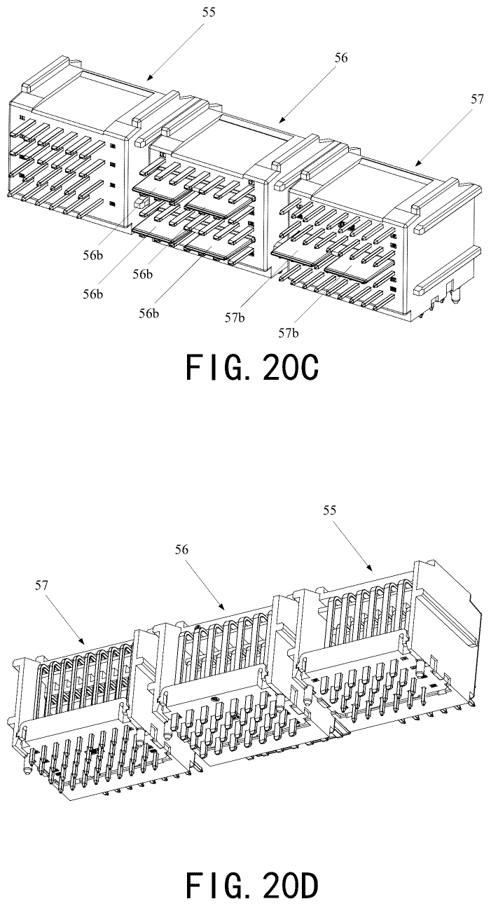

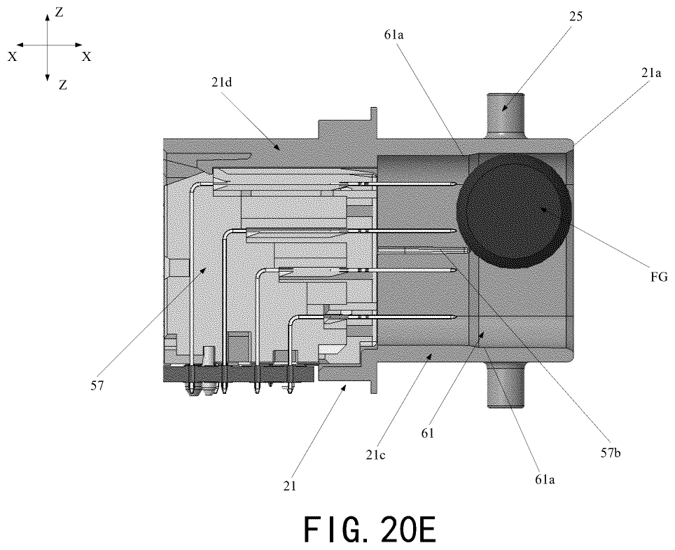

The second housing 21 may be formed from a metal material, an insulative material, or any other suitable material. As shown in FIGS. 1A, 1B, and 19A, the second housing 21 is configured to accommodate the plurality of modules 51-54. As shown in FIGS. 19B to 20B, the second housing 21 may include a mating face 21a and a rear face 21b opposite to each other in the lateral direction X-X, a plurality of accommodation spaces 61-64 recessed into the second housing 21 in the lateral direction X-X from the mating face 21a, and a plurality of cavities 71-74 recessed into the second housing 21 in the lateral direction X-X from the rear face 21b. The plurality of accommodation spaces 61-64 may include a first accommodation space 61, a second accommodation space 62, a third accommodation space 63, and a fourth accommodation space 64, and the plurality of cavities 71-74 may include a first cavity 71, a second cavity 72, a third cavity 73, and a fourth cavity 74. Each of the plurality of accommodation spaces 61-64 is in communication with a corresponding one of the plurality of cavities 71-74. Each of the plurality of accommodation spaces 61-64 is configured to accommodate a corresponding one of the plurality of modules 51-54. The portion of the second housing 21 defining the plurality of cavities 71-74 may be referred to as a base portion 21d of the second housing 21, and the portion of the second housing 21 defining the plurality of accommodation spaces 61-64 may be referred to as an accommodation portion 21c of the second housing 21. In the illustrated example, the plurality of cavities 71-74 are formed in the base portion 21d of the second housing 21, and the plurality of accommodation spaces 61-64 are formed in the accommodation portion 21c of the second housing 21. The accommodation portion 21c of the second housing 21 extends from the base portion 21d. The plurality of accommodation spaces 61-64 may be arranged in a row in the longitudinal direction Y-Y, and every two adjacent accommodation spaces may be separated by a separation wall 21cl (FIG. 20A) of the accommodation portion 21c of the second housing 21. The plurality of cavities 71-74 may be arranged in a row in the longitudinal direction Y-Y, and every two adjacent cavities may be separated by a separation wall 21d1 (FIG. 20B) of the base portion 21d of the second housing 21.

As shown in FIGS. 19A and 19B, the plurality of modules 51-54 may include a first module 51, a second module 52, a third module 53, and a fourth module 54. The first module 51, the second module 52, the third module 53, and the fourth module 54 are configured to be assembled into the first cavity 71, the second cavity 72, the third cavity 73, and the fourth cavity 74 of the second housing 21, respectively. The configurations of the modules 51-54 may be similar to those of the modules of the first electrical connector 10, respectively, and may be disposed in corresponding cavities in a similar manner. For brevity, details of the similar parts may not be repeated.

The first difference between the configurations of the modules of the second electrical connector 20 and the configurations of the modules of the first electrical connector 10 is in that the modules 51-54 of the second electrical connector 20 are configured to be mated with the modules 501-504 of the first electrical connector 10, respectively. For example, the mating ends of the conductive terminals of the modules 51-54 of the second electrical connector 20 are configured to establish electrical connections with the mating ends of the conductive terminals of the modules of the first electrical connector 10. For example, the mating ends of the conductive terminals of each of the modules 51-54 of the second electrical connector 20 and the mating ends of the conductive terminals of a corresponding module of the first electrical connector 10 may have shapes complementary to each other (for example, a male shape and a female shape). The module housings of the modules 51-54 of the second electrical connector 20 and the module housings of the modules 501-504 of the first electrical connector 10 may also have shapes complementary to each other (for example, a male shape and a female shape).

The second difference between the configurations of the modules of the second electrical connector 20 and the configurations of the modules of the first electrical connector 10 is in that the modules 51-54 of the second electrical connector 20 are configured to be mounted on the circuit board 30 to establish electrical connections with the circuit board 30. For example, ends (e.g., mounting ends and/or tail ends) of the conductive terminals of the modules 51-54 of the second electrical connector 20 opposite to the mating ends are configured to be suitable for being electrically connected (for example, by SMT or THT) to conductive structures on the circuit board 30, instead of being configured to be suitable for being terminated with cables, like the crimp ends of the conductive terminals of the modules of the first electrical connector 10.

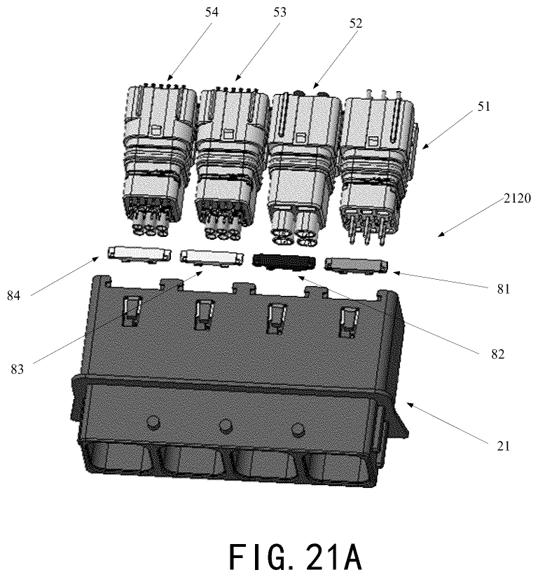

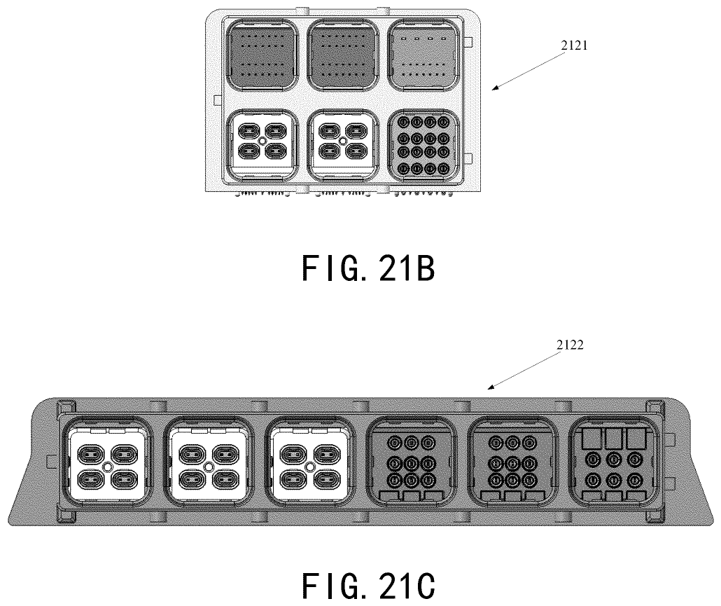

It should be appreciated that the modules of the second electrical connector 20 may also be cable modules. In this case, the second electrical connector 20 is also a cable connector. For example, FIG. 21A illustrates an exemplary version where the second electrical connector 20 is a cable connector.

The second electrical connector 20 is shown as a right angle connector. It should be appreciated that the present application may not be limited thereto, and in some embodiments, the second electrical connector 20 may be a vertical connector or a straddle mount connector.

It should be appreciated that the modules of the second electrical connector 20 may not be limited to including the modules 51-54. For example, as shown in FIGS. 20C and 20D, the modules 55, 56, and 57 are alternative versions of modules that may be used in the second electrical connector 20. The modules 55-57 may be configured to be mated with the aforementioned modules 505 to 507.

In some embodiments, the mating modules of the second electrical connector 20 may include protective structures or features for protecting the mating ends of the terminals in the form of pins. For example, as shown in FIGS. 19B and 20C, the modules 52, 56, and 57 may each have a protruding portion 52b, 56b, and 57b (e.g., which may be in the form of a tab) protruding from the module housing thereof. For example, there may be protruding terminal mating ends and the protruding portion 52b, 56b, and 57b at the mating face of each of the modules 52, 56, and 57. The protruding portion may extend beyond the terminal mating ends in the mating direction (e.g., the lateral direction X-X). When each of the modules 52, 56, and 57 is disposed in the second housing 21 of the second electrical connector 20, the protruding portion 52b, 56b, and 57b may define a sufficiently small gap between the protruding portion and the inner walls of the accommodation space (e.g., “61-64”) of the second housing 21 to prevent a user's finger or similar tool from touching the terminal mating ends when extending into the second housing 21 from the opening at the mating face 21a, thereby protecting the terminal mating ends from being damaged.

For example, FIG. 20E illustrates, from a cross-sectional perspective perpendicular to the longitudinal direction Y-Y, the case in which the module 57 of the second electrical connector 20 is disposed in the accommodation space 61 of the second housing 21. In FIG. 20E, the structure FG is configured to simulate the user's finger or similar tool extending into the accommodation space 61 of the second housing 21 from the opening at the mating face 21a. As shown in FIG. 20E, when the module 57 is disposed in the second housing 21, the protruding portion 57b may define a sufficiently small gap between the protruding portion 57b and the inner wall 61a of the accommodation space 61 of the second housing 21 to prevent the user's finger or similar tool (see, the structure FG) from touching the terminal mating ends when extending into the second housing 21 from the opening at the mating face 21a, thereby protecting the terminal mating ends from being damaged.

Accordingly, the modules of the first electrical connector 10 may include receiving structures or features for receiving the protruding portions 52b, 56b, and 57b of the mating modules of the second electrical connector 20. For example, as shown in FIGS. 10E and 10F, the modules 502, 506, and 507 may each have a slot 502b, 506b, and 507b recessed into the module housing. Protruding portions 52b, 56b, and 57b may be received by the slots 502b, 506b, and 507b, respectively, when the modules 502, 506, and 507 are mated with the modules 52, 56, and 57, respectively.

The mating modules of the first electrical connector 10 and the second electrical connector 20 may have the same types as each other.

The plurality of modules 51-57 may be held by one and the same housing (e.g., the second housing 21). The second housing 21 may serve as a carrier or an outer frame for holding the plurality of modules 51-57. When the first electrical connector 10 and the second electrical connector 20 are mated, the second housing 21 can ensure an accurate alignment and a reliable lock between the plurality of modules 51-57 and the mating modules of the first electrical connector 10.

Although the modules 51-54 are shown in FIG. 1B as being arranged in a 1×4 array in the second housing 21, it should be appreciated that the second electrical connector 20 may have any number and arrangement of modules. FIGS. 21B and 21C illustrate two variations of the second electrical connector 20. As shown in FIGS. 21B and 21C, the modules of the electrical connector 2121 may be arranged in a 2×3 array, and the modules of the electrical connector 2122 may be arrayed in a 1×6 array.

The first housing 100 of the first electrical connector 10 may be configured to mate with the second housing 21 of the second electrical connector 20 in the mating direction to establish a mechanical connection between the first electrical connector 10 and the second electrical connector 20.

For example, with reference to FIGS. 2A to 4C, when the first electrical connector 10 and the second electrical connector 20 are placed in the initial mating state shown in FIGS. 2A to 2C, the accommodation portion 21c of the second housing 21 of the second electrical connector 20 may be partially inserted into the accommodation space 103 of the accommodation portion of the first housing 100 of the first electrical connector 10 in the mating direction (here, the lateral direction X-X). In the illustrated example, the accommodation portion 21c of the second housing 21 of the second electrical connector 20 may be partially received in the accommodation space 103 of the accommodation portion of the first housing 100 of the first electrical connector 10 in the mating direction. The second electrical connector 20 is positioned in an initial mating position relative to the first electrical connector 10. In this case, for example, the plurality of modules 501-504 of the first electrical connector 10 may each be partially inserted into a corresponding one of the plurality of accommodation spaces 61-64 of the accommodation portion 21c of the second housing 21 of the second electrical connector 20 in the mating direction. There may be no contact between the mating ends of the conductive terminals of the modules 501-504 of the first electrical connector 10 and the mating ends of the conductive terminals of the modules 51-54 of the second electrical connector 20.

Turning to FIGS. 3A to 3C, compared with the initial mating state, in the partial mating state, the accommodation portion 21c of the second housing 21 of the second electrical connector 20 may be further inserted into the accommodation space 103 of the accommodation portion of the first housing 100 of the first electrical connector 10 in the mating direction. The second electrical connector 20 is moved to the partial mating position relative to the first electrical connector 10. In this case, the plurality of modules 501-504 of the first electrical connector 10 may each be partially inserted or further inserted into a corresponding one of the plurality of accommodation spaces 61-64 of the accommodation portion 21c of the second housing 21 of the second electrical connector 20 in the mating direction. In the partial mating state, an initial contact may be established between the mating ends of the conductive terminals of the modules 501-504 of the first electrical connector 10 and the mating ends of the corresponding conductive terminals of the module 51-54 of the second electrical connector 20.

Turning to FIGS. 4A to 4C, compared with the partial mating state, in the mated state, the accommodation portion 21c of the second housing 21 of the second electrical connector 20 may be further inserted into the accommodation space 103 of the accommodation portion of the first housing 100 of the first electrical connector 10 in the mating direction. For example, the vast majority or the entire of the accommodation portion 21c of the second housing 21 may be inserted into the accommodation space 103 of the accommodation portion of the first housing 100. The second electrical connector 20 is moved relative to the first electrical connector 10 to the mated position. In this case, the plurality of modules 501-504 of the first electrical connector 10 may each be further inserted into a corresponding one of the plurality of accommodation spaces 61-64 of the accommodation portion 21c of the second housing 21 of the second electrical connector 20 in the mating direction. In the mated state, a final or completed contact may be established between the mating ends of the conductive terminals of the modules 501-504 of the first electrical connector 10 and the mating ends of the corresponding conductive terminals of the module 51-54 of the second electrical connector 20, so that the first electrical connector 10 and the second electrical connector 20 are in the mated state.

In some embodiments, as shown in FIG. 20A, a ledge 21e may be provided at a joint portion between the accommodation portion 21c and the base portion 21d of the second housing 21. As shown in FIG. 4C, when the first electrical connector 10 and the second electrical connector 20 are in the mated state, the ledge 21e may contact a front end of the accommodation portion of the first housing 100 to prevent the second electrical connector 20 from being further moved toward the first electrical connector 10, thereby avoiding the first electrical connector 10 and the second electrical connector 20 from being damaged.

The first electrical connector 10 and the second electrical connector 20 may have mechanisms that cooperate to facilitate the mating of the first electrical connector 10 with the second electrical connector 20. With such mechanisms, the mating of the first electrical connector 10 with the second electrical connector 20 can be easier to operate, thereby improving the connection and assembly efficiency. Some examples of such mechanisms will be described below.

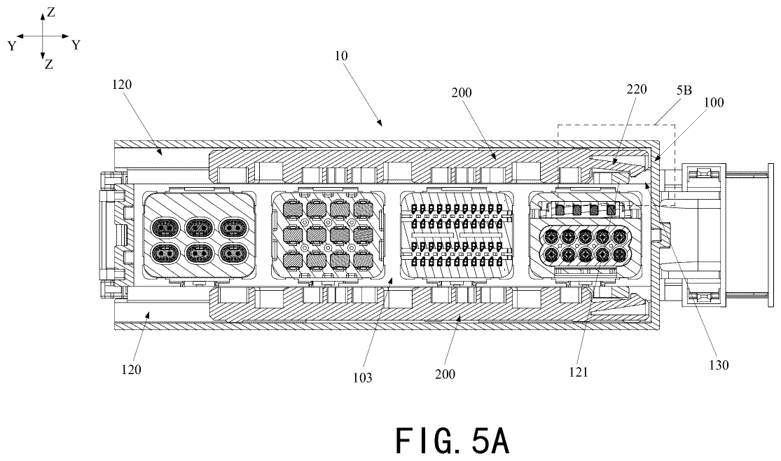

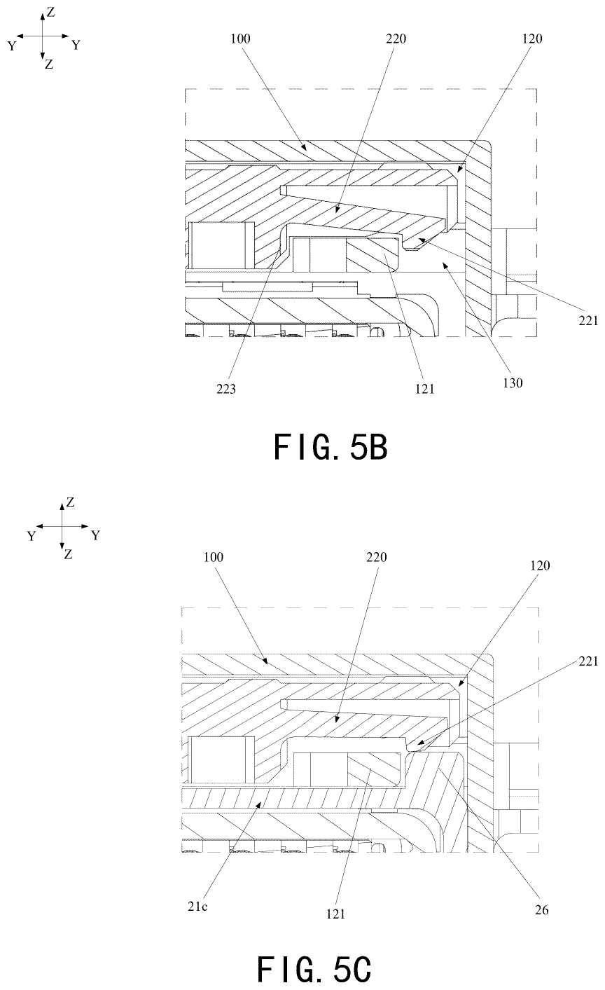

As shown in FIG. 6, the first electrical connector 10 may include two sliders disposed in the first housing 100. The slider 200 may be formed from any suitable material, such as a metal material or a plastic material. The two sliders 200 may serve as driving elements for driving the second electrical connector 20 to move in the mating direction. Each slider 200 may be configured to be slidable between a first position as shown in FIGS. 2C and 5A and a second position as shown in FIG. 4C in a sliding direction intersecting the mating direction (the lateral direction X-X) relative to the first housing 100. Each slider 200 can be driven (e.g., by a locking member 300) to slide. Although the sliding direction has been shown in FIGS. 2C and 4C as being oriented parallel to the longitudinal direction Y-Y, it should be appreciated that the present application may not be limited thereto, and the sliding direction may be any suitable direction intersecting the mating direction.

In the present application, unless otherwise stated, the first position of slider 200 refers to the position of the slider 200 as shown in FIGS. 2C and 5A, and the second position of the slider 200 refers to the position of the slider 200 as shown in FIG. 4C.

As shown in FIGS. 2C, 3C, 4C, 5A, and 7B, the first housing 100 may include two sliding grooves 120. Each sliding groove 120 is configured to accommodate a corresponding slider 200 and guide the slider 200 to slide therein. As best shown in FIG. 5A, the two sliders 200 may be arranged on opposite sides of the accommodation space 103 in the vertical direction Z-Z and opposing to each other in the vertical direction Z-Z. The configurations of the two sliders 200 may mirror each other. The slider 200 located above in FIG. 5A may be referred to as “an upper slider”. The slider 200 located below in FIG. 5A may be referred to as “a lower slider”. The configurations of the upper and lower sliders may mirror each other.

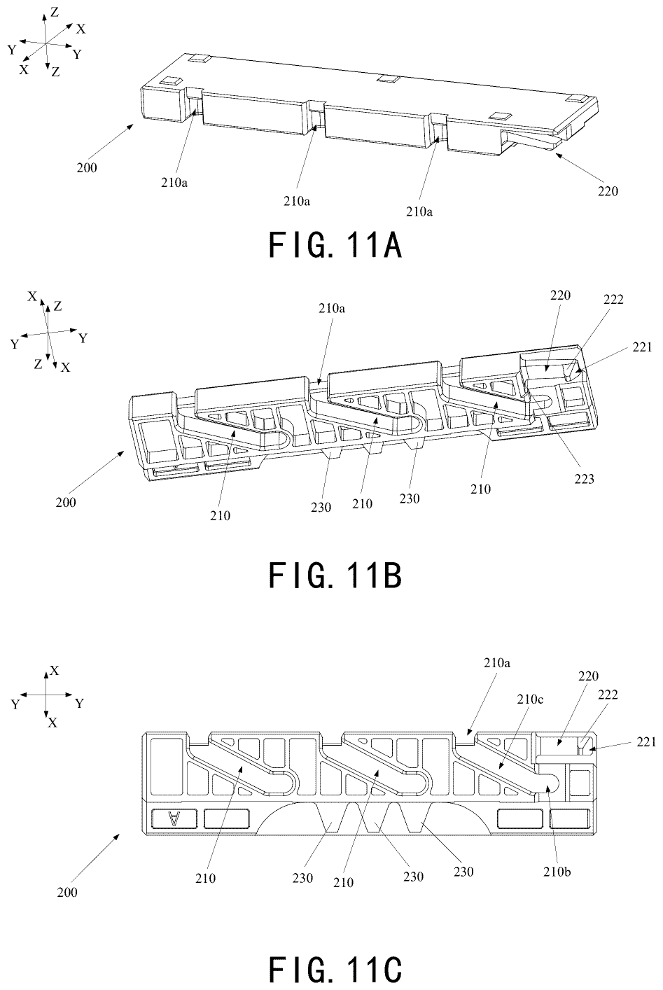

FIGS. 11A to 11C illustrate aspects of the upper slider 200. The upper slider 200 may include cam slots 210. The cam slots 210 may be configured to receive cam pins 25 provided on the second housing 21 of the second electrical connector 20 and to urge the cam pins 25 to move relative to the first housing 100 of the first electrical connector 10 in the mating direction (the lateral direction X-X).

As shown in FIGS. 1A, 1B, and 19A to 20B, the cam pins 25 may be provided on the accommodation portion 21c of the second housing 21 and protrude from an outer surface of the accommodation portion 21c. For example, the cam pins 25 may be integrally formed with the second housing 21. Actuation of the cam pins 25 may cause a movement of the second housing 21. The cam pins 25 may be equally spaced apart from each other in the longitudinal direction Y-Y, so that the force (which may be a pulling force when the second housing 21 is mated with the first housing 100 and a pushing force when the second housing 21 is unmated from the first housing 100) received by the second housing 21 is evenly distributed.

The upper slider 200 is shown as including three cam slots 210. The number of the cam pins 25 of the second housing 21 may correspond to the number of the cam slots 210. Each cam slot 210 may include an entry section 210a, a retention section 210b, and a guide section 210c extending between the entry section 210a and the retention section 210b. The entry section 210a may be open to the mating direction for receiving the cam pin 25 of the second housing 21. The retention section 210b is used for receiving and holding the cam pin 25 to limit a movement of the cam pin 25 in the mating direction. The retention section 210b may extend in the sliding direction (the longitudinal direction Y-Y). The guide section 210c may extend obliquely relative to the sliding direction, so that when the upper slider 200 is slid in the sliding direction, the guide section 210c may urge the cam pin 25 to move in the mating direction.

For example, as shown in FIG. 2C, when the upper slider 200 is in the first position, the cam slot 210 may receive the cam pin 25 of the second housing 21. The cam pin 25 is received in the entry section 210a of the cam slot 210. In this case, the second electrical connector 20 is positioned in the initial mating position relative to the first electrical connector 10, so that the first electrical connector 10 and the second electrical connector 20 are in the initial mating state. In this case, the second housing 21 is also positioned in the initial mating position relative to the first housing 100. For example, the cam slot 210 may be configured to receive the cam pin 25 of the second housing 21 when the upper slider 200 is in the first position as shown in FIG. 2C, so that the second housing 21 is positioned in the initial mating position.

Next, as shown in FIG. 3C, when the upper slider 200 is slid from the first position toward the second position in the sliding direction (the longitudinal direction Y-Y), the cam pin 25 enters the guide section 210c of the cam slot 210 and is pulled by the guide section 210c toward the first housing 100 in the mating direction (the lateral direction X-X), so that the second housing 21 is further inserted into the first housing 100 as described above. In this case, the first electrical connector 10 and the second electrical connector 20 are in the partial mating state.

Next, as shown in FIG. 4C, when the upper slider 200 reaches the second position, the cam pin 25 enters the retention section 210b of the cam slot 210 and is held by the retention section 210b. In this case, the second electrical connector 20 is moved to the mated position relative to the first electrical connector 10, so that the first electrical connector 10 and the second electrical connector 20 are in the mated state. In this case, the second housing 21 is also moved to the mated position relative to the first housing 100.

When the upper slider 200 is slid from the first position to the second position, the cam slot 210 may urge the cam pin 25 received therein to move in the mating direction relative to the first housing 100, so that the second housing 21 is moved from the initial mating position to the mated position relative to the first housing 100 in the mating direction. In this way, the first electrical connector 10 and the second electrical connector 20 can be placed in the mated state, e.g., the state in which they are mated with each other to establish a desired electrical connection.

It should be appreciated that when the first electrical connector 10 and the second electrical connector 20 are in the mated state, the first electrical connector 10 and the second electrical connector 20 may be unmated from each other by sliding the upper slider 200 from the second position shown in FIG. 4C to the first position shown in FIG. 2C in the sliding direction. This process is reverse to the process of moving the second housing 21 from the initial mating position to the mated position in the mating direction. For brevity, details of the similar contents may not be repeated.

As shown in FIG. 5A, the first housing 100 and the upper slider 200 of the first electrical connector 10 may be configured to cooperate with each other, so that the upper slider 200 can be constrained in the first position by the first housing 100 before the second housing 21 of the second electrical connector 20 is positioned in the initial mating position. For example, before the second housing 21 is positioned in the initial mating position, the upper slider 200 can be held in the first position by the first housing 100 without sliding. In this way, the upper slider 200 can be constrained in the first position before the first electrical connector 10 and the second electrical connector 20 are placed in the initial mating state, thereby ensuring that when the second housing 21 is positioned in the initial mating position, the cam pins 25 of the second housing 21 can be accurately and smoothly inserted into the corresponding cam slots 210 of the upper slider 200 without the need to adjust the position of the upper slider 200. Such a configuration can enable the mating of the first electrical connector 10 with the second electrical connector 20 to be easier to operate, thereby improving the connection and assembly efficiency of the electronic system 1. Such a configuration can enable the first electrical connector 10 to meet the mechanical requirements of specifications, such as USCAR.

As shown in FIGS. 2C and 5C, when the second housing 21 of the second electrical connector 20 is positioned in the initial mating position, the second housing 21 may cause the upper slider 200 to disengage from the first housing 100, thereby allowing the upper slider 200 to slide toward the second position from the first position in the sliding direction. In some embodiments, the second housing 21 may cause the upper slider 200 to disengage from the first housing 100 by contacting the upper slider 200. It should be appreciated that the present application may not be limited thereto, and in some embodiments, the second housing 21 may cause the upper slider 200 to disengage from the first housing 100 by contacting the first housing 100 or contacting both the upper slider 200 and the first housing 100.

In some examples, the first housing 100 may include a first constraint structure and the upper slider 200 may include a second constraint structure. When the upper slider 200 is in the first position and before the second housing 21 is positioned in the initial mating position (FIG. 5A), the first constraint structure and the second constraint structure engage with each other to restrict the upper slider 200 from sliding toward the second position from the first position in the sliding direction.

One of the first constraint structure and the second constraint structure may be configured to be contacted by a release structure provided on the second housing 21 to disengage from the other of the first constraint structure and the second constraint structure when the second housing 21 is positioned in the initial mating position, thereby allowing the upper slider 200 to slide toward the second position from the first position in the sliding direction.

In some embodiments, as shown in FIGS. 5A to 5C and 7B, the first constraint structure of the first housing 100 may be in the form of a beam 121 extending into the sliding groove 120. The beam 121 may, for example, extend in the lateral direction X-X. For example, the beam 121 may be integrally formed with the first housing 100. The beam 121 may be disposed adjacent to an end of the sliding groove 120 in the longitudinal direction Y-Y. When the upper slider 200 is in the first position, the upper slider 200 is closer to the end of the sliding groove 120 rather than to the opposite end of the sliding groove 120 in the longitudinal direction Y-Y. It should be appreciated that the present application may not be limited thereto.

As shown in FIGS. 5A to 5C and 11A to 11C, the second constraint structure of the upper slider 200 may be in the form of a resilient arm 220. The resilient arm 220 may extend in a cantilevered manner from a body of the upper slider 200. The resilient arm 220 may be integrally formed with the upper slider 200.

As shown in FIG. 5B, when the upper slider 200 is in the first position and before the second housing 21 is positioned in the initial mating position, the resilient arm 220 engages with the beam 121 to restrict the upper slider 200 from sliding toward the second position from the first position in the sliding direction. As shown in FIG. 5C, when the second housing 21 is positioned in the initial mating position, the resilient arm 220 is contacted by a release structure (“26” in FIG. 5C) of the second housing 21, so as to be biased to disengage from the beam 121. For example, the resilient arm 220 can be held in a position (FIG. 5B) engaged with the beam 121 by its own resiliency in the absence of the biasing force, and when contacted by the release structure of the second housing 21, the release structure can bias the resilient arm 220 to a position (FIG. 5C) disengaged from the beam 121 against the resilient force of the resilient arm 220.

In some embodiments, as shown in FIGS. 5B, 7A, and 7B, the first housing 100 may include a first receiving groove 130 communicated with the sliding groove 120 and configured to receive the release structure of the second housing 21 when the second housing 21 is positioned in the initial mating position. For example, the first receiving groove 130 may extend in the mating direction (the lateral direction X-X). The first receiving groove may be disposed adjacent to the beam 121.

As shown in FIG. 5B, when the upper slider 200 is in the first position and before the second housing 21 is positioned in the initial mating position, a portion of the resilient arm 220 may extend into the first receiving groove 130. As shown in FIG. 5C, when the second housing 21 is positioned in the initial mating position, the release structure of the second housing 21 may be received in the first receiving groove 130, and a portion of the resilient arm 220 is contacted by the release structure of the second housing 21, so that the resilient arm 220 is biased to disengage from the beam 121. The first receiving groove 130 may provide a guiding and registration function to ensure that the release structure of the second housing 21 can accurately and smoothly contact the resilient arm 220 when the second housing 21 is positioned in the initial mating position, thereby disengaging the resilient arm 220 from the beam 121.

In some examples, as shown in FIGS. 5B, 5C, 11B, and 11C, the resilient arm 220 may include a barb 221. The barb 221 may function as the aforementioned portion of the resilient arm 220. For example, as shown in FIG. 5B, when the upper slider 200 is in the first position and before the second housing 21 is positioned in the initial mating position, the barb 221 of the resilient arm 220 is engaged with the beam 121 and extends into the first receiving groove 130. As shown in FIG. 5C, when the second housing 21 is positioned in the initial mating position, the barb 221 is contacted by the release structure of the second housing 21, so that the resilient arm 220 is biased to disengage from the beam 121.

As shown in FIGS. 11B and 11C, the portion of the barb 221 for being contacted by the release structure may be formed with a chamfered surface 222. The chamfered surface 222 may face toward an entrance of the first receiving groove 130. Such a configuration may enable the release structure of the second housing 21 to contact and bias the resilient arm 220 with less force and less wear, thereby improving the operability and service life of the first electrical connector 10. For example, the barb 221 may be provided at the free end of the resilient arm 220. However, the present application may not be limited thereto. In some embodiments, the barb 221 may be disposed at any suitable portion of the resilient arm 220, for example, at an intermediate portion of the resilient arm 220.

It should be appreciated that the aforementioned portion of the resilient arm 220 may be a portion of the resilient arm 220 different from the barb 221, e.g., another protruding portion of the resilient arm 220.

In some examples, as shown in FIGS. 7A and 7B, the first receiving groove 130 of the first housing 100 may be recessed into the accommodation portion of the first housing 100 from the accommodation space 103 in a direction perpendicular to the mating direction (the vertical direction Z-Z), and extend in the mating direction. As shown in FIGS. 1A to 2C, 5C, and 19A to 20B, the release structure of the second housing 21 may be in the form of a rib 26 disposed on the second housing 21 and extending in the mating direction. The rib 26 may protrude outwardly from the accommodation portion 21c of the second housing 21.

When the second housing 21 is positioned in the initial mating position, the rib 26 may be received in the first receiving groove 130 and a portion of the resilient arm 220 is contacted by the rib 26, so that the resilient arm 220 is biased to disengage from the beam 121. Such a cooperation of the first receiving groove 130 with the rib 26 can guide the accommodation portion 21c of the second housing 21 to be inserted into the accommodation space 103 of the first housing 100. Such a configuration may prevent the second housing 21 from being inserted into the first housing 100 in a skewed orientation, and therefore provide protection for the components (e.g., the slider 200 and the cam pin 25, the mating ends of the mating modules described above) of the first electrical connector 10 and the second electrical connector 20.

It should be appreciated that the form of the release structure of the second housing 21 may not be limited to the rib 26. For example, it may be a protruding portion in any form or any other suitable structure.

Although it has been described above that the first constraint structure of the first housing 100 is in the form of the beam 121 and the second constraint structure of the upper slider 200 is in the form of the resilient arm 220, it should be appreciated that the present application may not be limited thereto. In some embodiments, the first housing 100 may include a resilient arm, which may be similar in structure to the resilient arm 220. The upper slider 200 may include a receiving portion (e.g., a recess or opening) configured to cooperate with the resilient arm. In this case, when the upper slider 200 is in the first position and before the second housing 21 is positioned in the initial mating position, the resilient arm of the first housing 100 can engage with the receiving portion of the upper slider 200 to restrict the upper slider 200 from sliding toward the second position from the first position in the sliding direction. When the second housing 21 is positioned in the initial mating position, the resilient arm of the first housing 100 is contacted by the release structure (e.g., the rib 26) provided on the second housing 21 to disengage from the receiving portion of the upper slider 200, thereby allowing the upper slider 200 to slide toward the second position from the first position in the sliding direction. It should be appreciated that in some embodiments, each of the first housing 100 and the upper slider 200 may have both a resilient arm and a receiving portion.

In some embodiments, the engagement between the first constraint structure of the first housing 100 and the second constraint structure of the upper slider 200 may also restrict the upper slider 200 from sliding from the first position in the sliding direction and away from the second position when the upper slider 200 is in the first position. For example, the barb 221 of the resilient arm 220 may snap into a recess recessed into the beam 121.

Alternatively or additionally, in some embodiments, the upper slider 200 may include a third constraint structure. When the upper slider 200 is in the first position, the third constraint structure of the upper slider 200 may engage with the first constraint structure (e.g., the beam 121) of the first housing 100 to restrict the upper slider 200 from sliding from the first position in the sliding direction and away from the second position.

In some examples, as shown in FIGS. 5B and 11B, the third constraint structure may be in the form of a stop wall 223. The stop wall 223 may engage with the beam 121 of the first housing 100 when the upper slider 200 is in the first position, so as to restrict the upper slider 200 from sliding from the first position in the sliding direction and away from the second position.

As shown in FIG. 11B, the resilient arm 220, for example, may extend from the stop wall 223. In the illustrated example, the fixed end of the resilient arm 220 may be connected to the stop wall 223. For example, the beam 121 of the first housing 100 may be positioned between the resilient arm 220 (e.g., the barb 221 thereof) and the stop wall 223 when the upper slider 200 is in the first position. The cooperation of the beam 121 with the resilient arm 220 and the stop wall 223 may constrain the upper slider 200 in the first position.

It should be appreciated that the form of the third constraint structure may not be limited thereto. In some embodiments, when the upper slider 200 is in the first position, the end portion of the upper slider 200 may engage with the end wall of the sliding groove 120 to restrict the upper slider 200 from sliding from the first position in the sliding direction and away from the second position.

Alternatively or additionally, in some embodiments, the first housing 100 further includes a fourth constraint structure. When the upper slider 200 is in the first position, the second constraint structure of the upper slider 200 may engage with the fourth constraint structure of the first housing 100 to restrict the slider from sliding from the first position in the sliding direction and away from the second position. For example, the barb 221 of the resilient arm 220 may engage with the end wall of the sliding groove 120 to restrict the upper slider 200 from sliding from the first position in the sliding direction and away from the second position.

The sliding groove 120 of the first housing 100 may be shaped to hold the slider 200 and guide the sliding of the slider 200. In some embodiments, as shown in FIG. 7H, when viewed in a cross section perpendicular to the sliding direction, the sliding groove 120 of the first housing 100 corresponding to the upper slider 200 may have a first narrower section 120a and a second wider section 120b extending from the first section 120a. The cross section of the upper slider 200 perpendicular to the sliding direction may match with the cross section of the sliding groove 120 perpendicular to the sliding direction in shape, so that the upper slider 200 is held in the sliding groove 120 and guided by the sliding groove 120 to slide. With such a configuration, the upper slider 200 can be guided to slide in the proper sliding direction in the sliding groove 120.

In some embodiments, the first section 120a of the sliding groove 120 may be recessed into the accommodation portion of the first housing 100 in the vertical direction Z-Z perpendicular to the mating direction from the accommodation space 103 of the first housing 100, and the second section 120b may extend from the first section 120a in the vertical direction Z-Z and away from the accommodation space 103. For example, as shown in FIG. 7H, when viewed from a cross section perpendicular to the sliding direction, the sliding groove 120 corresponding to the lower slider 200 may be in an “L” shape, and the sliding groove 120 corresponding to the upper slider 200 may be in an inverted “L” shape. However, it should be appreciated that the present application may not be limited thereto. In some embodiments, the sliding groove 120 corresponding to the lower slider 200 may have a “T” shape, and the sliding groove 120 corresponding to the upper slider 200 may have an inverted “T” shape. Accordingly, the cross section of the upper slider 200 perpendicular to the sliding direction and the cross section of the sliding groove 120 perpendicular to the sliding direction may match with each other in shape.

In some embodiments, as shown in FIGS. 7A and 7B, the first housing 100 may include a plurality of openings 101a. Each opening 101a may be recessed into the first housing 100 from the mating face 101 in the mating direction and communicate with the sliding groove 120 accommodating the upper slider 200. As shown in FIG. 2C, when the upper slider 200 is in the first position, the entry section 210a of the cam slot 210 may be aligned with the opening 101a in the mating direction to receive the cam pin 25 of the second housing 21. As shown in FIGS. 3C and 4C, when the upper slider 200 slides away from the first position, the entry section 210a of the cam slot 210 may be offset from the opening 101a in the mating direction. With such a configuration, on the one hand, it is possible to provide protection for the upper slider 200 to avoid the upper slider 200 from being damaged when the second housing 21 is inserted into the first housing 100 in a skewed orientation; on the other hand, the cam pin 25 can be prevented from accidentally exiting the cam slot 210 in the mating direction at the beginning of the mating process.

In some embodiments, as shown in FIG. 7A, the first housing 100 may be provided with a window 150 communicating with the sliding groove 120 of the upper slider 200, so that the user can observe the position of the upper slider 200 in the sliding groove 120, for example, during the mating of the first electrical connector 10 with the second electrical connector 20.

As shown in FIGS. 2C, 3C, and 4C, the locking member 300 may be coupled to the upper slider 200 to drive the upper slider 200 to slide between the first position and the second position relative to the first housing 100 in the sliding direction (here, the lateral direction X-X) according to a pivoting operation.

In some embodiments, as shown in FIGS. 1A to 4C, the cover 400 may be mounted to the first housing 100 and the locking member 300 may be pivotably mounted to the cover 400. The locking member 300 may be configured to be pivotable between a pre-locked position shown in FIGS. 2A to 2C and a locked position shown in FIGS. 4A to 4C relative to the cover 400. When the locking member 300 is pivoted between the pre-locked position and the locked position, the upper slider 200 may be driven to slide between the first position and the second position relative to the first housing 100 in the sliding direction. For example, when the locking member 300 is in the pre-locked position shown in FIGS. 2A to 2C, the upper slider 200 is in the first position shown in FIG. 2C, and when the locking member 300 is in the locked position shown in FIGS. 4A to 4C, the upper slider 200 is in the second position shown in FIG. 4C. Further, as shown in FIGS. 3A to 3C, when the locking member 300 is in a locking position between the pre-locked and locked positions, the upper slider 200 is in a third position shown in FIG. 3C between the first and second positions.

By driving the slider 200 with the locking member 300, the mating force required for mating the first electrical connector 10 with the second electrical connector 20 and the unmating force required for unmating them can be reduced by leverage.

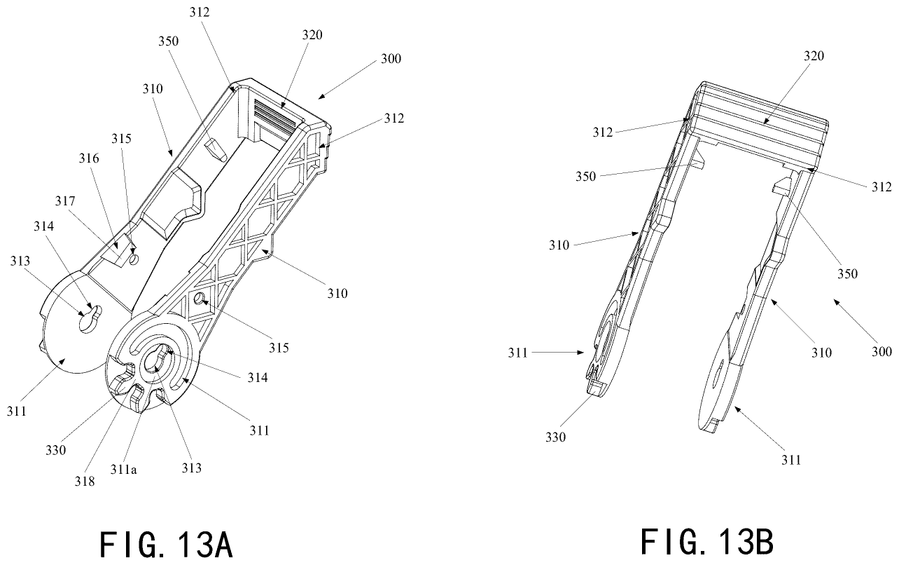

In some embodiments, as shown in FIGS. 13A and 13B, the locking member 300 may be U-shaped and include a pair of arms 310 and a crossbar portion 320 connecting the pair of arms 310. The locking member 300 may be formed from a metallic material, a plastic material, or any other suitable material. The arms 310 of the locking member 300 may be integrally formed with the crossbar portion 320. Each arm 310 may be pivotably mounted to the cover 400 and coupled to a corresponding one of the two sliders 200 to drive the corresponding slider 200 to slide.

Each arm 310 may include a first end 311 and a second end 312 opposite to each other. The second ends 312 of the pair of arms 310 may be connected by the crossbar portion 320 to enable the pair of arms 310 to pivot together. The configurations of the pair of arms 310 may mirror each other. Aspects of the locking member 300 is described herein in connection with the arm 310 coupled to the upper slider 200.

In the present application, unless otherwise stated, the pre-locked position of the locking member 300 and the arms 310 may refer to the position of the locking member 300 and the arms 310 shown in FIGS. 2A to 2C, the locked position of the locking member 300 and the arms 310 may refer to the position of the locking member 300 and the arms 310 shown in FIGS. 4A to 4C, and the locking position of the locking member 300 and the arms 310 may refer to the position of the locking member 300 and the arms 310 shown in FIGS. 3A to 3C.

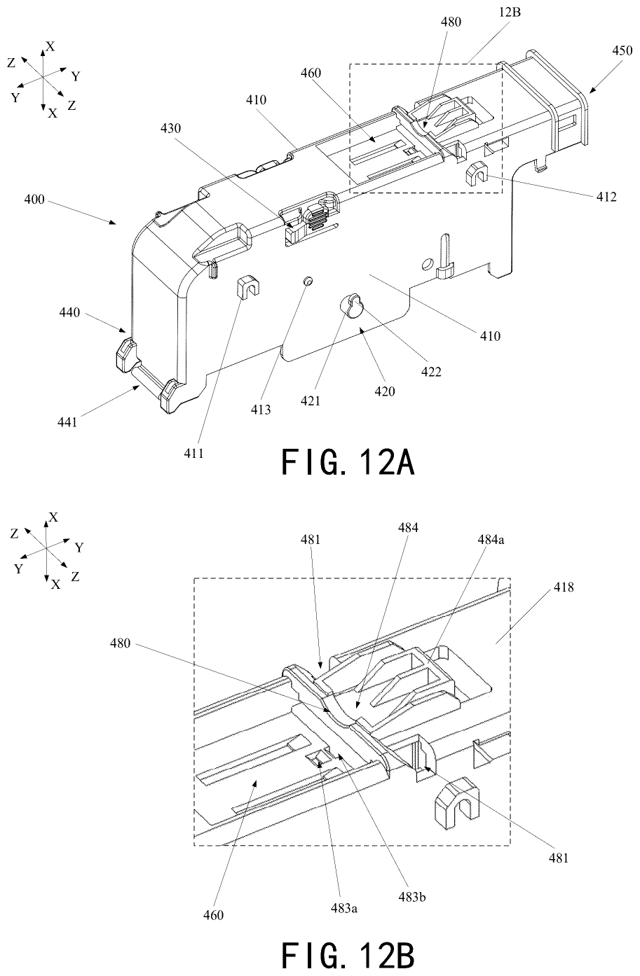

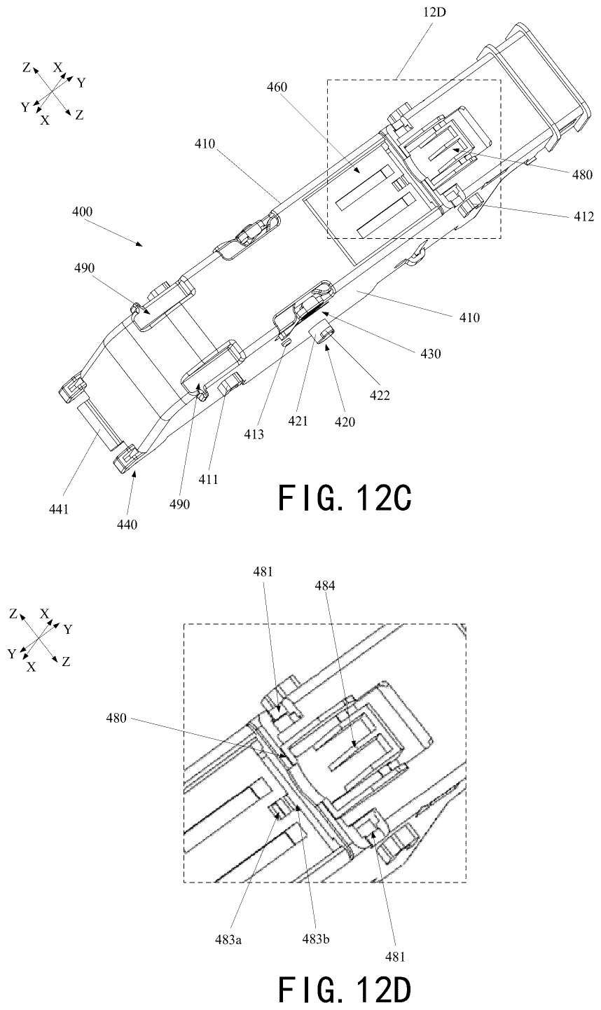

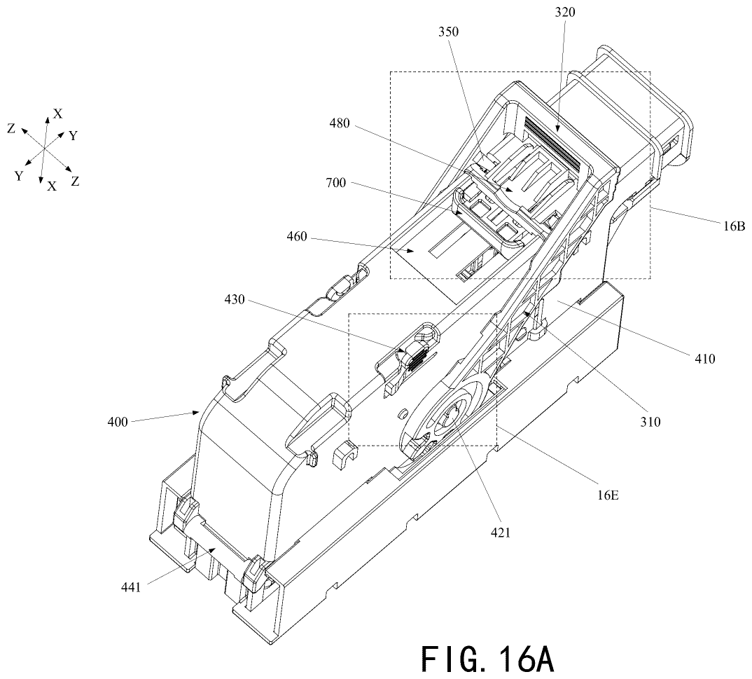

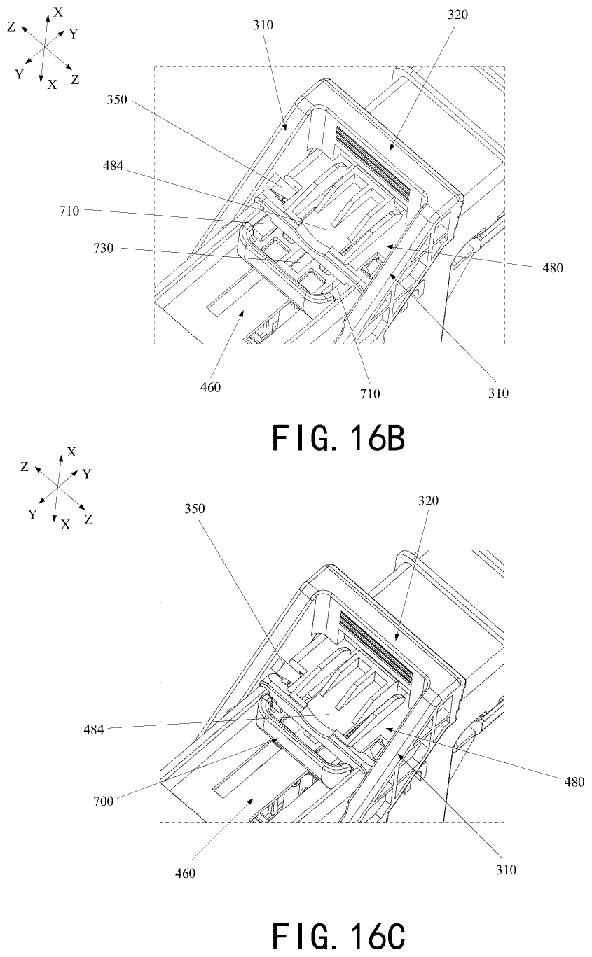

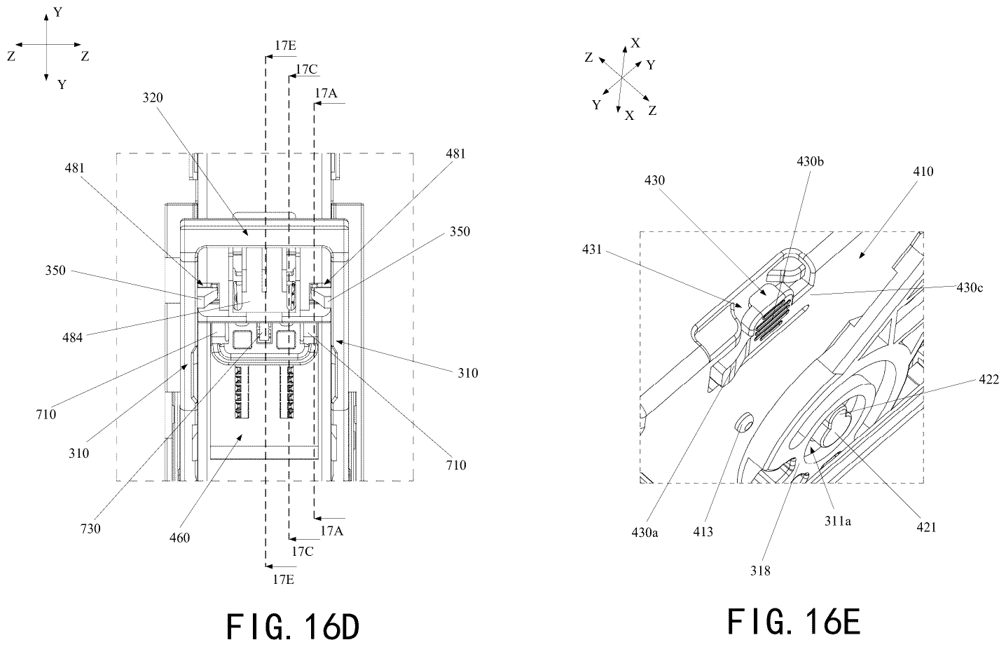

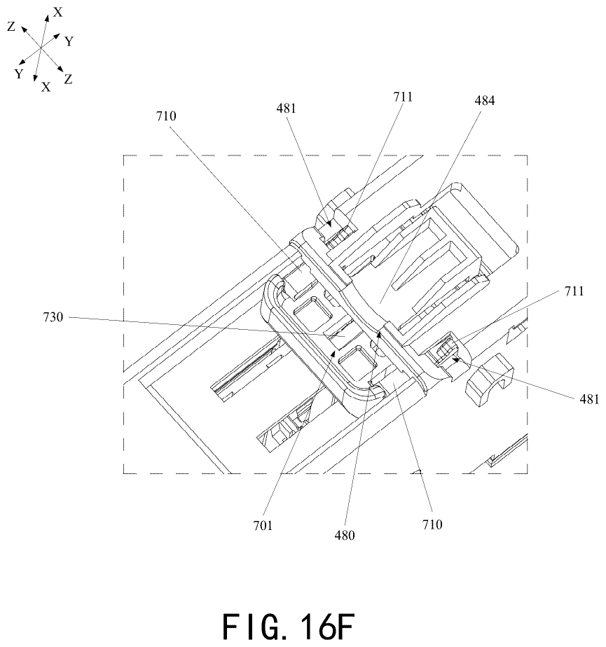

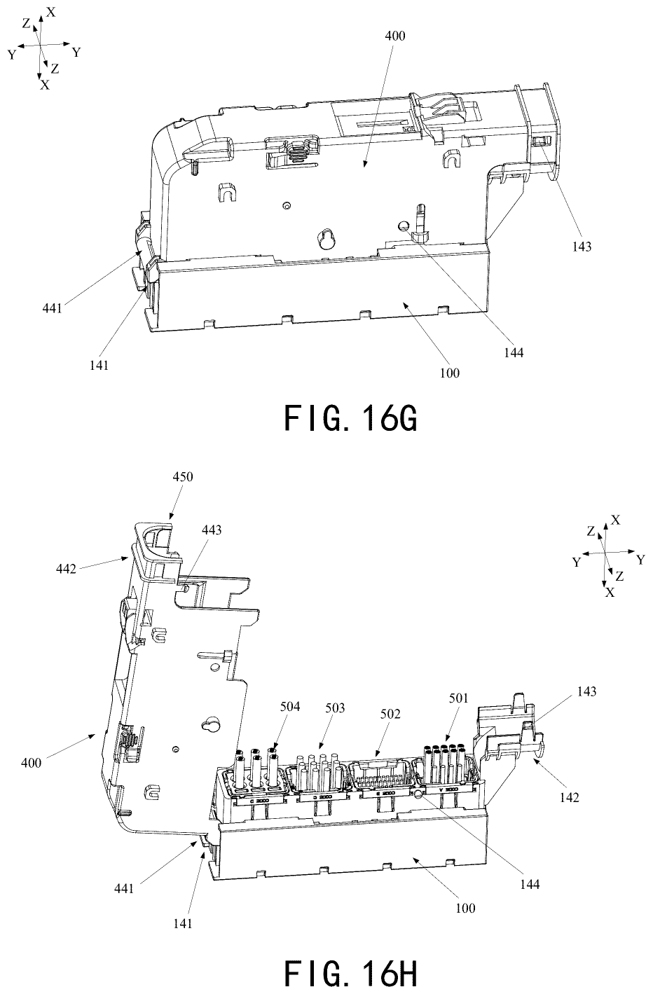

The cover 400 may at least partially surround the rear of the first housing 100. The cover 400 may be formed from a metal material, an insulative material, or any suitable material. For example, the cover 400 may be configured to guide cables (only segments of the cables are shown in the figures) leading from the modules (e.g., the modules 501-504). As shown in FIGS. 12A, 12C, and 16A, the cover 400 may include two side walls 410 opposite to each other in the vertical direction Z-Z. Although one of the side walls 410 of the cover 400 is shown in FIG. 12A, it should be appreciated that the two side walls 410 of the cover 400 may mirror each other. Aspects of the cover 400 and the locking member 300 is described herein in connection with the side wall 410 supporting the arm 310 coupled with the upper slider 200.

As shown in FIGS. 12A, 12C, and 16A, the cover 400 may include a pivot shaft 420 protruding outwardly from the side wall 410. A first end 311 of the corresponding arm 310 is pivotably mounted on the pivot shaft 420 to enable the corresponding arm 310 to pivot about the pivot shaft 420 between the pre-locked position and the locked position. For example, the pivot shaft 420 can include a shaft body 421 defining a pivot axis. The shaft body 421 may extend in the vertical direction Z-Z, and the pivot axis may be oriented parallel to the vertical direction Z-Z. It should be appreciated that the present application may not be limited thereto.

In the present application, unless otherwise stated, “an axial direction” may refer to an extending direction of the pivot axis defined by the pivot shaft 420, and “a radial direction” may refer to that with respect to the pivot axis, e.g., the direction perpendicular to the axial direction.

As shown in FIGS. 13A and 13B, the first end 311 of the arm 310 includes a bearing portion 311a having a bore 313 extending axially through the bearing portion 311a. As shown in FIGS. 16A and 16E, the bearing portion 311a of the first end 311 of the corresponding arm 310 may be disposed on the shaft body 421 of the pivot shaft 420. The shaft body 421 extends axially through the bore 313 of the bearing portion 311a.

As shown in FIGS. 13A and 13B, the first end 311 of the arm 310 may be formed with gear teeth 330. The gear teeth 330 may be formed at an outer periphery of the first end 311. As shown in FIGS. 11B and 11C, the upper slider 200 may be formed with rack teeth 230 at a location opposite to the first end 311 of the arm 310. As shown in FIGS. 2C, 3C, and 4C, the gear teeth 330 of the arm 310 may mesh with the rack teeth 230 of the upper slider 200, so that when the arm 310 is pivoted between the pre-locked position and the locked position, the upper slider 200 is driven to slide between the first position and the second position in the sliding direction relative to the first housing 100.

As described above, the upper slider 200 can be constrained in the first position by the first housing 100 when the upper slider 200 is in the first position and before the second housing 21 is positioned in the initial mating position. When constrained in the first position by the first housing 100, the upper slider 200 may not be driven by the locking member 300. Since the upper slider 200 and the locking member 300 are drivingly coupled to each other by, for example, the gear teeth 330 and rack teeth 230, the locking member 300 may be constrained in the pre-locked position by the upper slider 200. In this case, the locking member 300 may not be pivoted.

With such a configuration, it is possible to reliably hold the locking member 300 in the pre-locked position before the second housing 21 is positioned in the initial mating position. Such a configuration can enable the mating of the first electrical connector 10 with the second electrical connector 20 to be easier to operate, thereby improving the connection and assembly efficiency of the electronic system 1. Such a configuration may enable the first electrical connector 10 to meet the mechanical requirements of specifications, such as USCAR.

It should be appreciated that the form of transmission coupling between the upper slider 200 and the locking member 300 may not be limited to the gear teeth 330 and rack teeth 230. Any suitable form of transmission coupling may be employed so that the upper slider 200 is driven to slide between the first position and the second position when the arm 310 is pivoted between the pre-locked position and the locked position. In this case, it is also possible to reliably hold the locking member 300 in the pre-locked position by the transmission coupling between the upper slider 200 and the locking member 300 before the second housing 21 is positioned in the initial mating position.

In some embodiments, as shown in FIGS. 2A to 2C, 12A, and 12C, the cover 400 may include a first protrusion 411 protruding outwardly from the side wall 410. The first protrusion 411 may be configured to engage with the arm 310 when the arm 310 is in the pre-locked position, so as to restrict the arm 310 from being pivoted beyond the pre-locked position and further away from the locked position.

In some embodiments, as shown in FIGS. 4A to 4C, 12A, and 12C, the cover 400 may include a second protrusion 412 protruding outwardly from the side wall 410. The second protrusion 412 may be configured to engage with the arm 310 when the arm 310 is in the locked position, so as to restrict the arm 310 from being pivoted beyond the locked position and further away from the pre-locked position.

The first protrusion 411 and the second protrusion 412 may function as stopping structures to define a pivot range of the locking member 300. The first protrusion 411 and the second protrusion 412 may define the pivot range of the locking member 300 between the pre-locked position and the locked position. As described above, since the upper slider 200 and the locking member 300 are drivingly coupled to each other by, for example, the gear teeth 330 and the rack teeth 230, the first protrusion 411 and the second protrusion 41 may define the sliding range of the upper slider 200 in the sliding groove 120 by defining the pivot range of the locking member 300.

In some embodiments, as shown in FIGS. 12A and 12C, the cover 400 may include a third protrusion 413 protruding outwardly from the side wall 410. As shown in FIG. 13A, the arm 310 may include an opening 315. For example, opening 315 may be provided on a portion of the arm 310 between the first end 311 and the second end 312. When the arm 310 is pivoted to the pre-locked position, the third protrusion 413 of the cover 400 is received in the opening 315 of the arm 310, providing at least one of audible, visual, and tactile indications indicating that the arm 310 is pivoted to the pre-locked position. With such a configuration, the user may be provided with an explicit indication indicating that the locking member 300 is pivoted to the pre-locked position. This can improve the operability of the first electrical connector 10.

As an example, the third protrusion 413 and the opening 315 may match with each other in shape, to provide a visual indication indicating that the arm 310 is in the pre-locked position. Alternatively or additionally, the third protrusion 413 and the opening 315 may be designed so that when the arm 310 is pivoted to the pre-locked position, the third protrusion 413 is received in the opening 315 and emits an audible indication, such as a “click”. Alternatively or additionally, the third protrusion 413 and the opening 315 may be designed so that when the arm 310 is pivoted to the pre-locked position, the third protrusion 413 is received in the opening 315 and provides force feedback via the arm 310. Such force feedback may be a significant vibration of the arm 310 or significant changes in the pivoting resistance. For example, as shown in FIG. 13A, the arm 310 may include a recess 316 recessed into the arm 310 and a stepped portion 317 formed by the recess 316. The stepped portion 317 may be configured to contact the third protrusion 413 before the third protrusion 413 is received in the opening 315, as the arm 310 is pivoted toward the pre-locked position away from the locked position. The stepped portion 317 may be designed to have a sufficient height to enable a sound, such as a “click”, to be fired when the third protrusion 413 passes over the stepped portion 317 into the opening 315, thereby providing an audible indication, and/or to enable to provide force feedback via the arm 310 to provide a tactile indication.

In some embodiments, as shown in FIGS. 2A to 2C, 12A, 12C, and 16E, the cover 400 may include a resilient tab 430 protruding outwardly from the side wall 410. The resilient tab 430 may be configured to be capable of being depressed by the arm 310 when the arm 310 is pivoted away from the locked position toward the pre-locked position, allowing the arm 310 to pass over the resilient tab 430 to the pre-locked position, and to be capable of resetting and blocking the arm 310 from being pivoted from the pre-locked position toward the locked position when the arm 310 is in the pre-locked position. The resilient tab 430 is also configured to be capable of being manually depressed (e.g., by hand or by a tool) to allow the arm 310 to be pivoted from the pre-locked position toward the locked position.

For example, as shown in FIG. 16E, the cover 400 may include a recess 431 recessed into the side wall 410, and the resilient tab 430 extends into the recess 431 in a cantilever manner and protrudes at least partially outwardly from the surface of the side wall 410. For example, the free end 430a of the resilient tab 430 may protrude from the surface of the side wall 410. When the arm 310 is pivoted away from the locked position toward the pre-locked position, the arm 310 may contact the free end 430a of the resilient tab 430 to depress the resilient tab 430, and pass over the resilient tab 430 to the pre-locked position. When the arm 310 is in the pre-locked position, the resilient tab 430 may reset by its own resiliency, and the free end 430a may block the arm 310 from being pivoted from the pre-locked position toward the locked position. Further, the resilient tab 430 may include an actuation portion 430b, which may be provided between the free end 430a and the fixed end 430c of the resilient tab 430, and may be manually actuated to cause the resilient tab 430 to be depressed. The actuation portion 430b may be textured to facilitate being pressed by the user.

Such a resilient tab 430 can provide a locking function to the locking member 300. For example, the resilient tab 430 may cooperate with the first protrusion 411 to hold the locking member 300 in the pre-locked position. This may help prevent the locking member 300 from being pivoted before shipping of the first electrical connector 10 and before the mating is made. As another example, the resilient tab 430 may cooperate with the upper slider 200 to hold the locking member 300 in the pre-locked position. Furthermore, even if the second housing 21 of the second electrical connector 20 is positioned in the initial mating position so that the upper slider 200 is unconstrained from the first housing 100, the locking member 300 may not be pivoted from the pre-locked position toward the locked position unless the resilient tab 430 is depressed. In this case, the resilient tab 430 may help hold the upper slider 200 in the first position.

In some embodiments, as shown in FIGS. 12A, 12C, and 16E, the pivot shaft 420 of the cover 400 may include a protrusion 422 protruding radially from the shaft body 421. As shown in FIG. 13A, the bearing portion 311a of the first end 311 of the arm 310 may include a notch 314 radially recessed into the bearing portion 311a from the bore 313. The bore 313 and the notch 314 may together form “a gourd shape”, wherein the bore 313 is larger and the notch 314 is smaller. As shown in FIG. 16E, when the first end 311 of the arm 310 is pivotably mounted on the pivot shaft 420, the bearing portion 311a is supported on the shaft body 421 between the protrusion 422 of the pivot shaft 420 and the side wall 410 of the cover 400, and the shaft body 421 extends through the bore 313.

As shown in FIGS. 2B, 3B, and 4B, the notch 314 and the protrusion 422 may match with each other in shape so that the notch 314 and the protrusion 422 are axially aligned with each other only when the arm 310 is in the locking position, thereby allowing the first end 311 of the arm 310 to be mounted to and removed from the pivot shaft 420, and are axially offset from each other when the arm 310 is in other pivot positions to block mounting and removing of the first end 311 of the arm 310 to and from the pivot shaft 420. For example, when the arm 310 is in the locking position and the notch 314 and the protrusion 422 are axially aligned with one another, the first end 311 of the arm 310 may be removed from the corresponding shaft body 421 by expanding the pair of arms 310 to increase the spacing between the first ends 311 of the pair of arms 310. In this case, the crossbar portion 320 may be resiliently deformed. Further, because the locking member 300 has the pair of arms 310, unless an expanding force is applied to increase the spacing between the first ends 311 of the pair of arms 310, the locking member 300 may be held on the cover 400 by the pair of arms 310 even when the locking member 300 is pivoted to the locking position. Further, the locking member 300 may be assembled to the cover in an orientation where the locking member 300 is in the locking position. Such a configuration may enable the locking member 300 to be securely held on the cover 400 with fewer components and simplifies the operations of mounting and removing the locking member 300 to and from the cover 400.

In some embodiments, as shown in FIG. 13A, the first end 311 of the arm 310 may include an annular protrusion 318 surrounding the bearing portion 3111a. The thickness of the annular protrusion 318 in the axial direction (the vertical direction Z-Z) may be greater than the thickness of the bearing portion 311a in the axial direction, thereby providing mechanical strength to the first end 311 of the arm 310. As shown in FIG. 16E, when the arm 310 is mounted on the pivot shaft 420, the annular protrusion 318 may radially surround the protrusion 422 of the pivot shaft 420 and be substantially axially flush with the protrusion 422. This may prevent the arm 310 from inadvertently disengaging from the pivot shaft 420 when pivoted to the locking position.

It should be appreciated that since the configurations of the lower slider 200 and the configurations of the upper slider 200 may mirror each other, the first housing 100 and the locking member 300 may have similar configurations for the lower slider 200 and cooperate with the lower slider 200 in a similar manner.

It should be appreciated that, in some embodiments, the number of the sliders 200 may not be limited to two. For example, the number of the sliders 200 may be single or more than two. The relative configurations of the first housing 100 and the locking member 300 may vary accordingly.

In some embodiments, as shown in FIGS. 16G and 16H, the cover 400 may be pivotably mounted to the first housing 100 and pivotable relative to the first housing 100 between a closed position (FIG. 16G) and an open position (FIG. 16H). The closed position of the cover 400 shown in FIG. 16G corresponds to the position of the cover 400 relative to the first housing 100 of the first electrical connector 10 shown in FIGS. 1A to 4C. As shown in FIG. 16G, the cover 400 may block the rear face 102 of the first housing 100 when in the closed position and allow access to the rear face 102 of the first housing 100 when in the open position to, for example, allow installation and/or replacement of the modules 501-504. With such a configuration, the cover 400 may be integrated with the first housing 100 to improve the integration of the first electrical connector 10. For example, when the cover 400 needs to be opened to replace the modules 501-504, the cover 400 need not be completely removed from the first housing 100. Although the locking member 300 and the CPA device 700 are hidden in FIGS. 16G and 16H, it should be appreciated that the locking member 300 and the CPA device 700 may not be removed from the cover 400 when the cover 400 is pivoted between the closed position and the open position. For example, the locking member 300 may be held in the pre-locked position by the first protrusion 411 and the resilient tab 430. The CPA device 700 may be constrained in a pre-installed position by the cover 400.

With the first electrical connector 10 assembled as shown in FIGS. 1A to 4C, the cover 400 may be held in the closed position by any suitable structure.

In some embodiments, as shown in FIGS. 12A, 12C, 16G, and 16H, the cover 400 may include a first pivot structure 441 at the first corner 440. As shown in FIGS. 7B, 16G, and 16H, a second pivot structure 141 may be provided at the side wall 140 of the first housing 100 extending between the mating face 101 and the rear face 102. The first pivot structure 441 and the second pivot structure 141 may be coupled to each other so that the cover 400 is pivotably mounted to the side wall 140 of the first housing 100. The second pivot structure 141 may, for example, be a pivot shaft extending in the vertical direction Z-Z and defining a pivot axis oriented parallel to the vertical direction Z-Z. The first pivot structure 441 may be a bearing portion removably mounted (e.g., by snap fit) on the pivot shaft. It should be appreciated that aspects of the first pivot structure 441 and the second pivot structure 141 may not be limited thereto.

As described above, the cables of the modules 501-504 may extend out of the first housing 100 at the rear face 102 of the first housing 100. In some embodiments, as shown in FIG. 16H, the cover 400 may include a first exit structure 442 at a second corner 450 arranged diagonally to the first corner 440, and the first housing 100 may be correspondingly provided with a second exit structure 142. The first exit structure 442 and the second exit structure 142 may collectively define a cable exit 11 (FIG. 1A) when the cover 400 is in the closed position. The cables of the modules 501-504 may lead out of the first electrical connector 10 through the cable exit 11.

In some embodiments, the cover 400 may include a snap structure disposed adjacent to and/or at the first exit structure 442. Accordingly, the first housing 100 may include a snap structure for cooperating with the snap structure of the cover 400 to securely hold the cover 400 in the closed position when the cover 400 is in the closed position. For example, as shown in FIG. 16H, the cover 400 may include a snap tab 443 disposed at the first exit structure 442. Additionally or alternatively, the cover 400 may include a tab disposed adjacent to the first exit structure 442. The first housing 100 may be correspondingly provided with a receiving portion (e.g., an opening and/or a recess) for receiving such a snap structure.

In some embodiments, the first housing 100 may include a snap structure disposed adjacent to and/or at the second exit structure 142. Accordingly, the cover 400 may include a snap structure for cooperating with the snap structure of the first housing 100 to securely hold the cover 400 in the closed position when the cover 400 is in the closed position. For example, as shown in FIG. 16H, the first housing 100 may include a snap tab 143 disposed at the second exit structure 142 and a snap protrusion 144 disposed adjacent to the second exit structure 142. The cover 400 may be correspondingly provided with a receiving portion (e.g., an opening and/or a recess) for receiving such a snap structure.

Turning to FIGS. 4A to 4C, when the locking member 300 is pivoted to the locked position, the two sliders 200 are both in the second position. The second electrical connector 20 is moved relative to the first electrical connector 10 to the mated position, and the first electrical connector 10 and the second electrical connector 20 are placed in the mated state. The CPA device 700 may be configured to secure the locking member 300 in the locked position, thereby holding the first electrical connector 10 and the second electrical connector 20 in the mated state. The CPA device 700 can improve the vibration resistance and the impact resistance of the connector assembly or electronic system composed of the first electrical connector 10 and the second electrical connector 20, for example, improve the reliability thereof.

As shown in FIGS. 12A, 12C, and 16A, the cover 400 may include a sliding groove 460 configured to accommodate the CPA device 700. The sliding groove 460 may be recessed into the cover 400 at the rear (relative to the first housing 100) of the cover 400. The sliding groove 460 may include a bottom for carrying the CPA device 700. As shown in FIG. 12A, the sliding groove 460 may be disposed adjacent to a second corner 450 of the cover 400 disposed diagonally from the first corner 440. It should be appreciated that the present application may not be limited thereto.

As shown in FIGS. 16A to 16C, the CPA device 700 may be disposed in the sliding groove 460 and configured to be slidable relative to the cover 400 in the sliding direction between a pre-installed position shown in FIG. 16B and an installed position shown in FIG. 16C. For example, the sliding direction may be oriented parallel to the longitudinal direction Y-Y. Accordingly, the sliding groove 460 may extend in the longitudinal direction Y-Y. It should be appreciated that the present application may not be limited thereto.

In the present application, unless otherwise stated, the pre-installed position of the CPA device 700 may refer to the position of the CPA device 700 shown in FIG. 16B, and the installed position of the CPA device 700 may refer to the position of the CPA device 700 shown in FIG. 16C.

Before the locking member 300 is pivoted to the locked position, the CPA device 700 may be constrained in the pre-installed position by the cover 400, and when the locking member 300 is in the locked position, the locking member 300 may release the CPA device 700 to allow the CPA device 700 to slide from the pre-installed position toward the installed position. With such a configuration, it is possible to reliably hold the CPA device 700 in the pre-installed position before the second electrical connector 20 is moved to the mated position relative to the first electrical connector 10, thereby avoiding the accidental movement of the CPA device 700. Further, such a configuration may enable the user to verify whether the locking member 300 has reached the locked position, by attempting to push the CPA device 700.

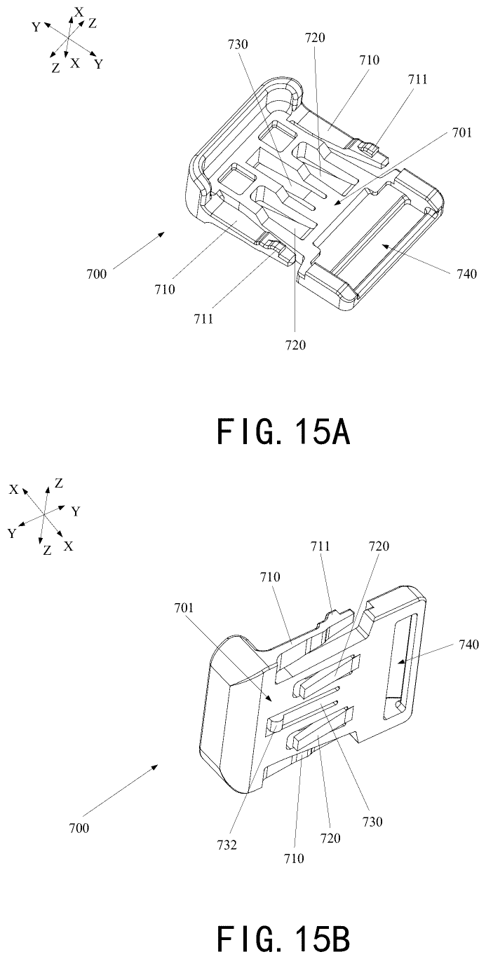

As shown in FIGS. 15A and 15B, the CPA device 700 may include a base 701 and at least one first resilient arm 710 (two in the figures) extending from the base 701. The base 701 may be configured to facilitate the manual operation to be pushed and pulled in the sliding direction. Each of the at least one first resilient arm 710 may extend in a cantilevered manner from the base 701.

As shown in FIGS. 12A to 12D, the cover 400 may include an overhanging structure 480. The overhanging structure 480 may be disposed above the CPA device 700. For example, the sliding groove 460 may be recessed into the cover 400 from the outer surface 418 of the cover 400, and the overhanging structure 480 may be disposed at the outer surface 418 of the cover 400 and at least partially protrude from the outer surface 418. The overhanging structure 480 may extend across the sliding groove 460 in the vertical direction Z-Z and be spaced apart from the bottom of the sliding groove 460 in the lateral direction X-X. The overhanging structure 480 may be, for example, an integrally formed portion of the cover 400.

In some embodiments, the overhanging structure 480 may include at least one (first) stopping structure. Each of the at least one first resilient arm 710 may engage with a corresponding one of the at least one stopping structure when the CPA device 700 is in the pre-installed position and before the locking member 300 is pivoted to the locked position, to restrict the CPA device 700 from sliding from the pre-installed position toward the installed position.

In some embodiments, when the CPA device 700 is in the pre-installed position and the locking member 300 is in the locked position, the locking member 300 can contact the at least one first resilient arm 710 to bias each first resilient arm 710 to disengage from the corresponding stopping structure, thereby allowing the CPA device 700 to slide from the pre-installed position toward the installed position.

As shown in FIGS. 12B and 12D, the at least one stopping structure of the overhanging structure 480 may include at least one opening 481 (two in the figures). When the CPA device 700 is in the pre-installed position and before the locking member 300 is pivoted to the locked position, a portion of each of the at least one first resilient arms 710 may be received in a corresponding one of the at least one openings 481 to restrict the CPA device 700 from sliding from the pre-installed position toward the installed position.

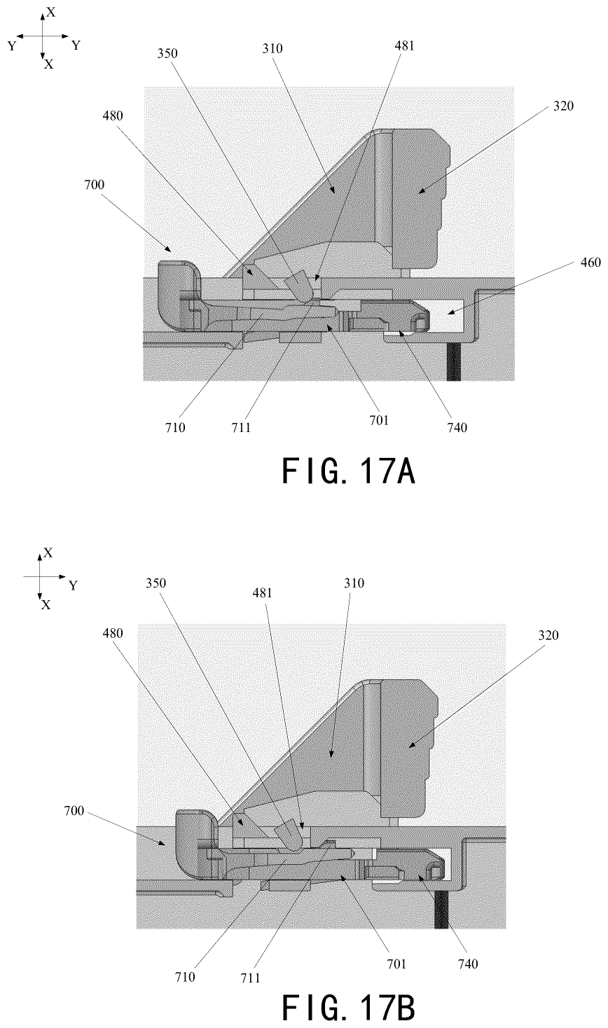

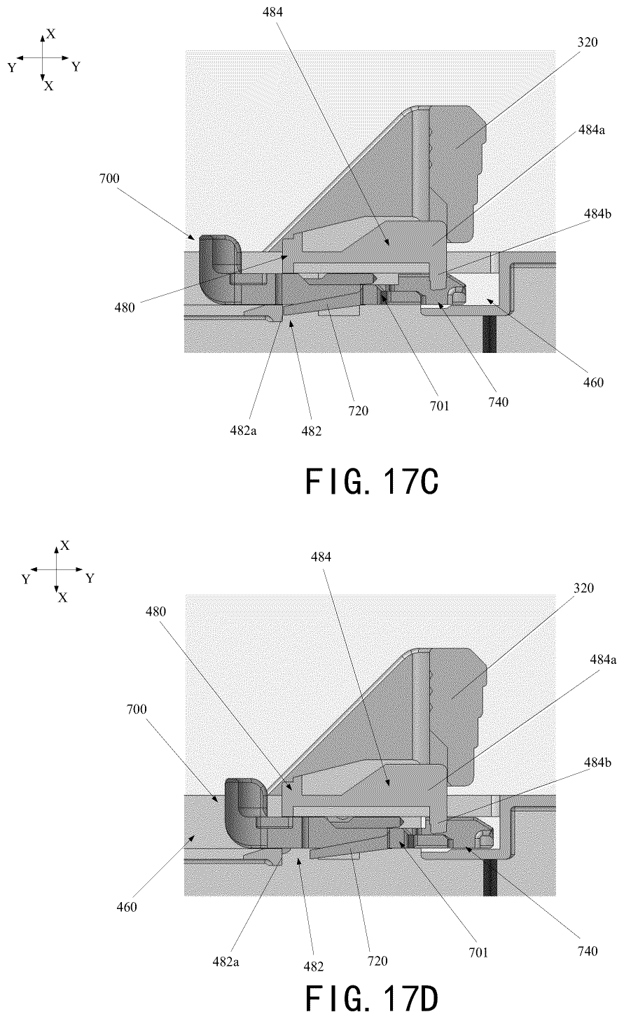

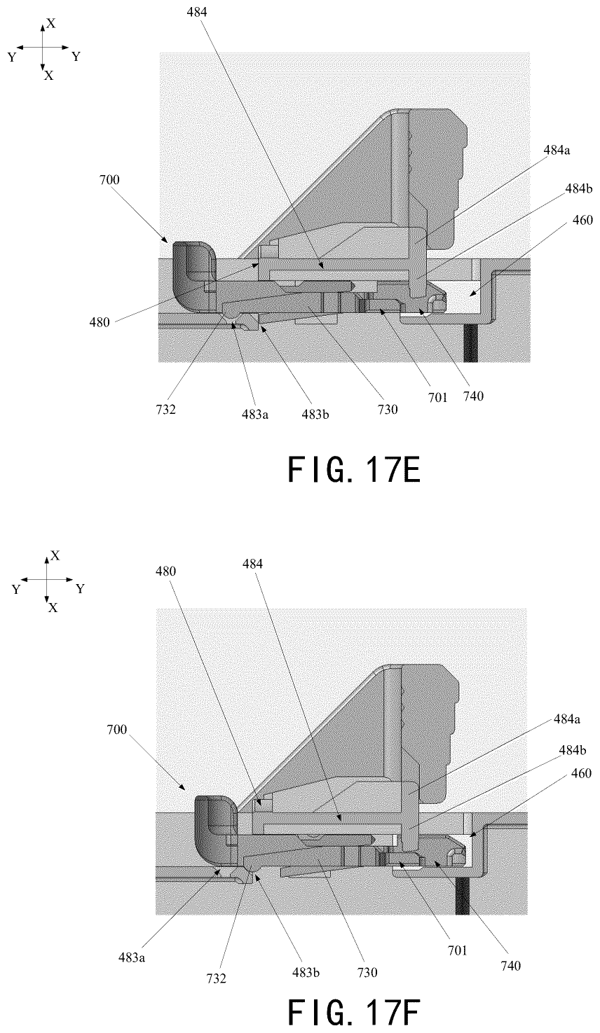

As shown in FIGS. 13A and 13B, the locking member 300 may include at least one release protrusion 350 (two in the figures). As shown in FIGS. 16B and 17A, when the CPA device 700 is in the pre-installed position and the locking member 300 is in the locked position, each of the at least one release protrusion 350 of the locking member 300 enters the corresponding opening 481 and contacts a portion of the corresponding first resilient arm 710 to push a portion of the corresponding first resilient arm 710 out of the opening 481.

In some examples, as shown in FIGS. 15A, 15B, 16F, 17A, and 17B, for each first resilient arm 710, a portion of the first resilient arm 710 is a first protrusion 711 disposed on the first resilient arm 710. The first protrusion 711 may be disposed adjacent to the free end of the first resilient arm 710. The first protrusion 711 may be in the form of a barb. In some examples, the first protrusion 711 may also be located at the free end of the first resilient arm 710.

As shown in FIG. 16F, when the CPA device 700 is in the pre-installed position and before the locking member 300 is pivoted to the locked position, the first protrusion 711 of each first resilient arm 710 is received in the corresponding opening 481 to restrict the CPA device 700 from sliding from the pre-installed position toward the installed position. As shown in FIGS. 16B and 16C, when the CPA device 700 is in the pre-installed position and the locking member 300 is in the locked position, each of the at least one release protrusion 350 of the locking member 300 may enter the corresponding opening 481 and contact the first protrusion 711 of the corresponding first resilient arm 710 to push a portion of the corresponding first resilient arm 710 out of the opening 481. In this way, the first resilient arm 710 may be disengaged from the stopping structure of the overhanging structure 480, thereby allowing the CPA device 700 to slide from the pre-installed position toward the installed position. Further, since the release protrusion 350 is received by the opening 481, the locking member 300 may be restricted from being pivoted beyond the locked position and further away from the pre-locked position. For example, the release protrusion 350 and the opening 481 may also function as a stopping structure restricting the locking member 300 from being pivoted.

In some examples, as shown in FIGS. 13A and 13B, the at least one release protrusion 350 of the locking member 300 may be disposed on the arm 310. A release protrusion 350 is provided on each arm 310. It should be appreciated that the number and arrangement positions of the release protrusions may not be limited thereto. In some embodiments, the release protrusion may be disposed on the crossbar portion 320 of the locking member 300.

In some embodiments, the at least one release protrusion 350 of the locking member 300 may also be configured to engage with the cover 400 when the locking member 300 is in the pre-locked position, so as to restrict the locking member 300 from being pivoted beyond the pre-locked position and further away from the locked position. For example, the at least one release protrusion 350 of the locking member 300 may also function as a stopping structure for restricting the locking member 300 from being pivoted beyond the pre-locked position and further away from the locked position when the locking member 300 is in the pre-locked position.

For example, with reference to FIG. 12C, the cover 400 may include two recesses 490. When the locking member 300 is in the pre-locked position, the two release protrusions 350 of the locking member 300 may be received in the two recesses 490, respectively, thereby restricting the locking member 300 from being pivoted beyond the pre-locked position and further away from the locked position. It should be appreciated that the present application may not be limited thereto. The release protrusion 350 of the locking member 300 may also engage with other portions of the cover 400 when the locking member 300 is in the pre-locked position, so as to restrict the locking member 300 from being pivoted beyond the pre-locked position and further away from the locked position.

In some embodiments, as shown in FIGS. 15A and 15B, the CPA device 700 may include a second resilient arm (or beam) 720 extending from the base 701. Each second resilient arm 720 may extend in a cantilevered manner from the base 701. Although two second resilient arms 720 are shown in the figures, it should be appreciated that the number of the second resilient arms 720 may not be limited thereto, and may be single in some embodiments. As shown in FIGS. 17C and 17D, the cover 400 may include a stop recess 482 recessed into the cover 400 from the bottom of the sliding groove 460. When the CPA device 700 is in the pre-installed position, the second resilient arm 720 engages with the wall 482a of the stop recess 482 to restrict the CPA device 700 from sliding from the pre-installed position away from the installed position. For example, the stop recess 482 may function as a second stopping structure to restrict the CPA device 700 from sliding from the pre-installed position away from the installed position when the CPA device 700 is in the pre-installed position. It should be appreciated that the specific form of the second stopping structure may not be limited thereto, and the second stopping structure may be any suitable structure capable of engaging with the second resilient arm 720 to restrict the CPA device 700 from sliding from the pre-installed position away from the installed position when the CPA device 700 is in the pre-installed position.

With the aforementioned cooperation of the first stopping structure with the first resilient arm 710 of the CPA device 700 and that of the second stopping structure with the second resilient arm 720 of the CPA device 700, the CPA device 700 can be reliably held in the pre-installed position when the CPA device 700 is in the pre-installed position and before the locking member 300 is pivoted to the locked position.

In some embodiments, as shown in FIGS. 15A and 15B, the CPA device 700 may include a third resilient arm (or beam) 730 extending from the base 701. The third resilient arm 730 may extend in a cantilevered manner from the base 701. The third resilient arm 730 may include a second protrusion 732. The second protrusion 732 may have a rounded shape. Although a single third resilient arm 730 is shown in the figures, it should be appreciated that the number of the third resilient arms 730 may not be limited thereto, and may be multiple in some embodiments. As shown in FIGS. 12B and 12D, the cover 400 may include a first receiving recess 483a and a second receiving recess 483b recessed into the cover 400 from the bottom of the sliding groove 460. As shown in FIG. 17E, the second protrusion 732 of the third resilient arm 730 is received in the first receiving recess 483a when the CPA device 700 is in the pre-installed position, and as shown in FIG. 17F, the second protrusion 732 of the third resilient arm 730 is received in the second receiving recess 483b when the CPA device 700 is in the installed position. Since the second protrusion 732 has a rounded shape, when the second protrusion 732 of the third resilient arm 730 is received in the first receiving recess 483a or the second receiving recess 483b, it is possible to provide a certain retention force restricting the sliding of the CPA device 700, so as to prevent the CPA device 700 from sliding freely while allowing the CPA device 700 to be manually actuated (pushed or pulled) to move. With such a configuration, it is possible to provide a certain retention force on the CPA device 700 when the CPA device 700 is in the pre-installed position to hold the CPA device 700 in the pre-installed position. Even though the locking member 300 has released the CPA device 700 from the overhanging structure 480, the CPA device 700 does not slide freely. The CPA device 700 can only be pushed to slide toward the installed position by applying a pushing force on the CPA device 700. Further, with such a configuration, when the CPA device 700 is in the installed position, a certain retention force can be provided to the CPA device 700 to retain the CPA device 700 in the installed position. In this case, the CPA device 700 may not slide freely. The CPA device 700 can only be pulled to slide toward the pre-installed position by applying a pulling force on the CPA device 700. Such a configuration can improve the reliability of the CPA device 700.

In some embodiments, the second receiving recess 483b and the stop recess 482 may be one and the same recess.

The overhanging structure 480 may include a fourth resilient arm (or beam) 484. The fourth resilient arm 484 may be configured to be capable of being depressed by the locking member 300 when the locking member 300 is pivoted away from the pre-locked position and toward the locked position, thereby allowing the locking member 300 to pass over the fourth resilient arm 484 to the locked position, and to be capable of resetting and blocking the locking member 300 from being pivoted from the locked position toward the pre-locked position when the locking member 300 is in the locked position. The fourth resilient arm 484 may also be configured to be capable of being manually depressed to allow the locking member 300 to be pivoted from the locked position toward the pre-locked position. The fourth resilient arm 484 may cooperate with the aforementioned second protrusion 412 of the cover 400 to lock the locking member 300 in the locked position.

As shown in FIGS. 12B, 12D, and 17C to 17F, the fourth resilient arm 484 may extend above the sliding groove 460. The fourth resilient arm 484 may extend in a cantilever manner in the longitudinal direction Y-Y. The fourth resilient arm 484 includes a fixed end fixed above the sliding groove 460 and a free end opposite to the fixed end. The CPA device allows the fourth resilient arm 484 to be depressed when in the pre-installed position and blocks the fourth resilient arm 484 from being depressed when in the installed position. The fourth resilient arm 484 may be provided with a structure suitable for blocking the locking member 300 from being pivoted. For example, the structure is shown as a stop portion 484a. The stop portion 484a may be disposed adjacent to or at the free end and protrude from the fourth resilient arm 484 in a direction away from the bottom of the sliding groove 460. When the locking member 300 is pivoted away from the pre-locked position toward the locked position, the locking member 300 may contact the stop portion 484a to depress the fourth resilient arm 484, and when the locking member 300 is in the locked position, the fourth resilient arm 484 resets and the stop portion 484a blocks the locking member 300 from being pivoted from the locked position toward the pre-locked position.

The CPA device 700 may allow the fourth resilient arm 484 to be depressed when in the pre-installed position, and blocks the fourth resilient arm 484 from being depressed when in the installed position. The CPA device 700 may constrain the stop portion 484a in a position where the locking member 300 is blocked from being pivoted, by blocking the fourth resilient arm 484 from being depressed, thereby blocking the locking member 300 from being pivoted from the locked position toward the pre-locked position. As shown in FIGS. 17C and 17E, the CPA device 700 may allow the fourth resilient arm 484 to be depressed when the CPA device 700 is in the pre-installed position. As shown in FIGS. 17C to 17F, the fourth resilient arm 484 may include an engagement portion 484b. The engagement portion 484b may be disposed adjacent to or at the free end and protrude from the fourth resilient arm 484 toward the bottom of the sliding groove 460. For example, the engagement portion 484b and the stop portion 484a may extend oppositely to each other from the fourth resilient arm 484. As shown in FIGS. 17D and 17F, when the CPA device 700 is in the installed position, the base 701 is positioned below the engagement portion 484b to block the fourth resilient arm 484 from being depressed. As shown in FIGS. 15A and 15B, the base 701 of the CPA device 700 may be provided with an opening 740. As shown in FIGS. 17C and 17E, the opening 740 is aligned with the engagement portion 484b of the fourth resilient arm 484 when the CPA device 700 is in the pre-installed position, allowing the engagement portion 484b to move toward the bottom of the sliding groove 460 and at least partially into the opening 740 when the fourth resilient arm 484 is depressed toward the bottom of the sliding groove 460. This may allow the fourth resilient arm 484 to be depressed toward the bottom of the sliding groove 460. As shown in FIGS. 17D and 17F, when the CPA device 700 is in the installed position, the CPA device 700 is positioned below the fourth resilient arm 484 to block the fourth resilient arm 484 from being depressed. For example, the CPA device 700 is slid so that the opening 740 of the base 701 is offset from the engagement portion 484b of the fourth resilient arm 484, and the base 701 blocks the engagement portion 484b from moving toward the bottom of the sliding groove 460, thereby blocking the fourth resilient arm 484 from being depressed.

In some embodiments, the fourth resilient arm 484 may be pressed against the base 701 of the CPA device 700 when the CPA device 700 is in the installed position. For example, the base 701 may be wedged between the fourth resilient arm 484 (e.g., the engagement portion 484b thereof) and the bottom of the sliding groove 460. For example, the engagement portion 484b of the fourth resilient arm 484 may be pressed against the base 701 of the CPA device 700 when the CPA device 700 is in the installed position. This may facilitate reliably holding the CPA device 700 in the installed position.

In some embodiments, the stop portion 484a of the fourth resilient arm 484 may be configured to be capable of being depressed by the crossbar portion 320 of the locking member 300 when the locking member 300 is pivoted away from the pre-locked position toward the locked position, and to be capable of resetting and blocking the crossbar portion 320 from being pivoted from the locked position toward the pre-locked position when the locking member 300 is in the locked position.

In some embodiments, the stop portion 484a of the fourth resilient arm 484 may be configured to engage with the crossbar portion 320 when the locking member 300 is in the locked position, to apply a certain biasing force on the crossbar portion 320 while blocking the crossbar portion 320 from being pivoted. This can facilitate urging the release protrusion 350 into the corresponding opening 481 of the overhanging structure 480 and pushing the portion of the corresponding first resilient arm 710 out of the opening 481. It should be appreciated that the locking member 300 may also be depressed slightly to cause the release protrusion 350 to push the portion of the corresponding first resilient arm 710 out of the opening 481.

Although the CPA device 700 has been described above together with the first electrical connector 10, it should be appreciated that the CPA device 700 may be a separate component and used for assembly with the first electrical connector 10. In this case, the CPA device 700 may constitute an electronic assembly or electronic system with the first electrical connector 10.

When assembling the first electrical connector 10, each of the plurality of modules 501-504 may be properly positioned in a corresponding one of the plurality of cavities 111-114 of the first housing 100. For example, the plurality of modules 501-504 of the first electrical connector 10 may have different types from each other. Nevertheless, the outer dimensions of the plurality of modules 501-504 may be approximate to each other, and accordingly, the shapes of the first housing 100 for accommodating the modules 501-504 may be approximate to each other. In this case, the modules 501-504 may be positioned in the wrong cavities when the first electrical connector 10 is assembled.

The inventors have recognized and appreciated that this problem may be effectively avoided by providing a plurality of key members 601-604. For example, as shown in FIG. 10E, the plurality of modules 501-504 may be different types of modules. The plurality of modules 501-504 may have first identification features different from each other. For example, each of the plurality of modules 501-504 may have a unique first identification feature. The first identification feature may enable the user to distinguish the plurality of modules 501-504 from each another. Preferably, the user can visually distinguish the plurality of modules 501-504 from each other by the first identification features of the modules 501-504.

As shown in FIGS. 7C to 7H, each of the plurality of cavities 111-114 of the first housing 100 may have an entrance 111a-114a. For example, the first cavity 111, the second cavity 112, the third cavity 113, and the fourth cavity 114 may have entrances 111a, 112a, 113a, and 114a, respectively. The entrances 111a-114a of the plurality of cavities 111-114 may be recessed into the first housing 100 in the lateral direction X-X from the rear face 102 of the first housing 100. The first cavity 111, the second cavity 112, the third cavity 113, and the fourth cavity 114 are configured to accommodate the first module 501, the second module 502, the third module 503, and the fourth module 504, respectively.

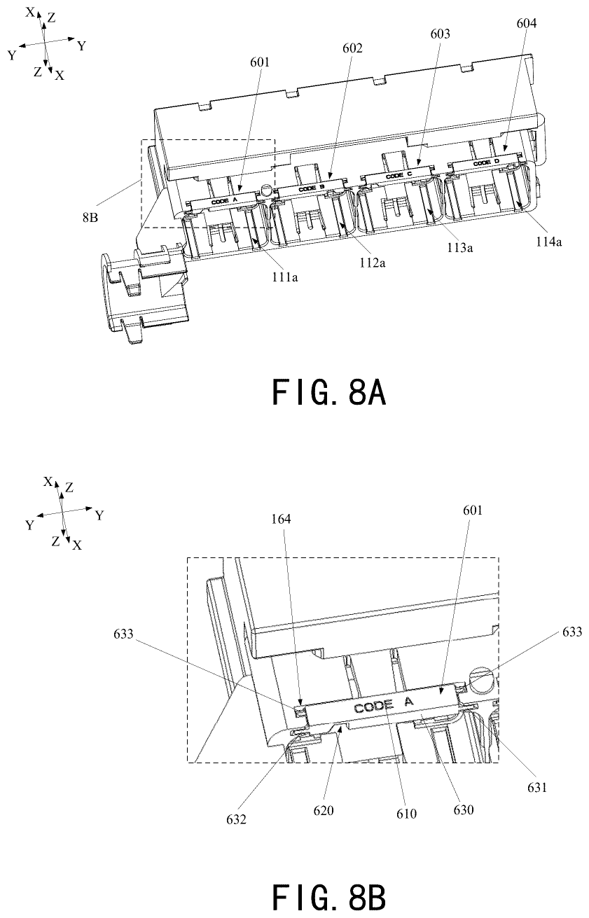

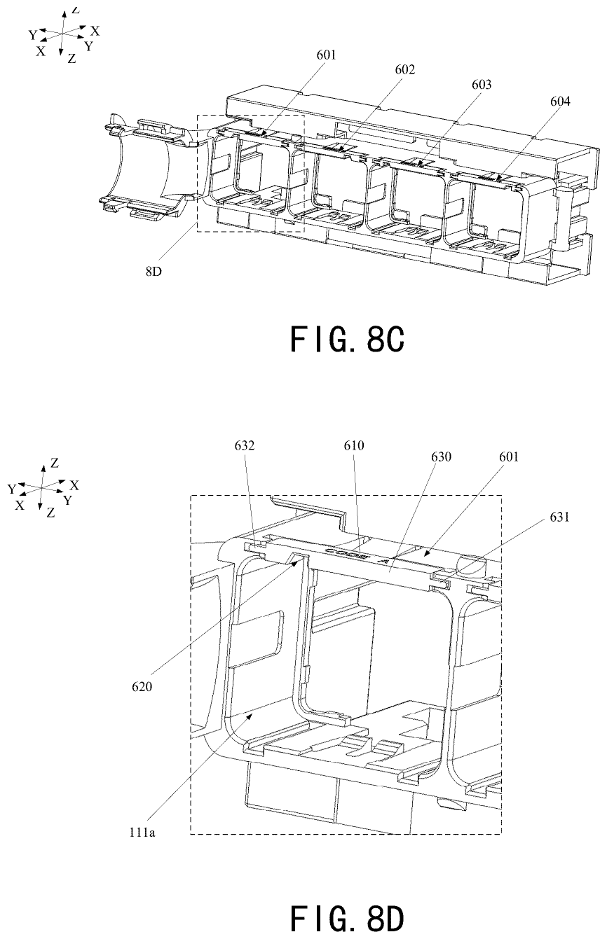

As shown in FIG. 6, the plurality of key members 601-604 may include a first key member 601, a second key member 602, a third key member 603, and a fourth key member 604. The plurality of key members 601-604 may be formed from the same or different material as/from the first housing 100. The plurality of key members 601-604 may have second identification features different from each other. Each of the plurality of key members 601-604 may be disposed at an entrance of a corresponding one of the plurality of cavities 111-114. For example, the first key member 601, the second key member 602, the third key member 603, and the fourth key member 604 may be disposed at the entrances of the corresponding cavities before the modules 501-504 are assembled to the cavities 111-114 of the first housing 100. As shown in FIG. 8A, the first key member 601, the second key member 602, the third key member 603, and the fourth key member 604 may be disposed at the entrances 111a-114a of the cavities 111-114, respectively.

The second identification feature of the key member 601-604 disposed at the entrance 111a-114a of each cavity 111-114 may be associated with the first identification feature of a corresponding one of the plurality of modules 501-504 to be mounted to that cavity (e.g., the module designated for mounting to that cavity), indicating a corresponding mounting relationship between the cavity and the corresponding module. For example, the user may determine to which of the cavities 111-114 each module 501-504 is to be installed, during assembly of the modules 501-504 to the cavities 111-114 of the first housing 100, by comparing the first identification features of the modules 501-504 with the second identification features of the key members 601-604 disposed at the entrances 111a-114a of the cavities 111-114. For example, the user may verify whether the module should be assembled into the cavity by comparing the first identification feature of the module with the second identification feature of the key member disposed at the entrance of the cavity. By comparing the first identification features of the modules 501-504 with the second identification features of the key members 601-604 to be disposed at the entrances 111a-114a of the cavities 111-114, the user can determine a one-to-one corresponding mounting relationship between the modules 501-504 and the cavities 111-114. Preferably, the user can make this determination visually.

Such a configuration may enable the user to determine the one-to-one corresponding mounting relationship more easily and quickly between the modules 501-504 and the cavities 111-114 of the first housing 100 when assembling and/or maintaining the first electrical connector 10, thereby accurately assembling the modules 501-504 into the corresponding cavities. Such a configuration can improve the assembly and/or maintenance efficiency of the first electrical connector 10 at a low cost.

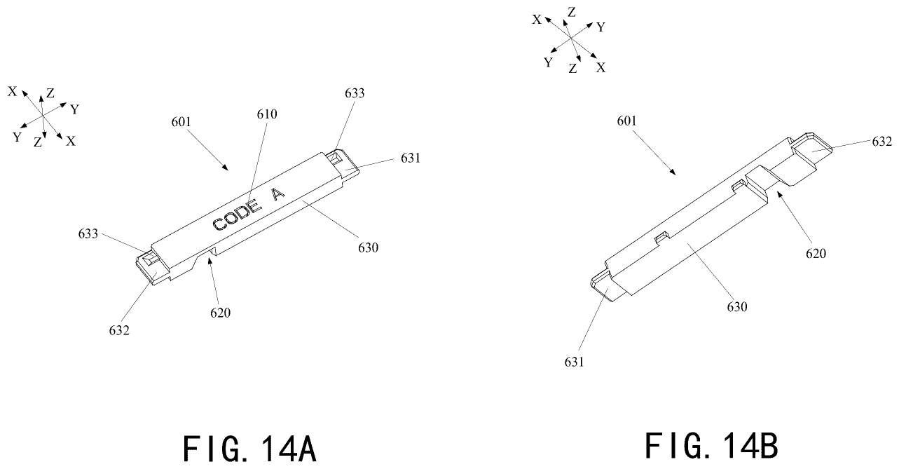

In some embodiments, the first identification features of the plurality of modules 501-504 may be in the form of colors, symbols, graphics, texts, or combinations thereof. Accordingly, the second identification features of the plurality of key members 601-604 may also be in the form of colors, symbols, graphics, texts, or combinations thereof. As an example, the colors of the plurality of key members 601-604 can correspond to the colors of the corresponding modules, respectively. As another example, as shown in FIG. 14A, the first key member 601 may be provided with a text feature 610. The text feature 610 may be, for example, “CODE A”. The first module 501 to be assembled to the first cavity 111 may also have a corresponding text feature, for example, “CODE A”. Alternatively, the text feature 610 is associated with the module type of the first module 501 to be assembled into the first cavity 111. Similarly, as shown in FIG. 8A, the key members 602-604 may also be provided with different textual features, such as “CODE B”, “CODE C”, and “CODE D”, respectively, to be respectively associated with the modules 502-504.

It should be appreciated that the second identification features of the plurality of key members 601-604 may be in any form capable of being visually associated with the first identification features of the plurality of modules 501-504 in a one-to-one correspondence. Such a correspondence may be predefined by the manufacturer or user. It should be appreciated that the first identification features of the plurality of modules 501-504 and the second identification features of the plurality of key members 601-604 may be different types of identification features, e.g., text corresponding to colors, symbols corresponding to graphics, etc.

In some examples, the modules 501-504 need not be deliberately manufactured with specific identification features. Instead, the visible module types of the modules 501-504 may be directly associated with the first identification features of the plurality of modules 501-504 in a one-to-one corresponding relationship. For example, the user can easily identify the module types of the modules 501-504 through the structural features of the modules 501-504 disposed at the mating faces (e.g., the shape and arrangement of the mating ends of the conductive terminals, the structural features such as the guide structures recessed into the modules from the mating faces or protruding from the mating faces, the size of the conductive terminals indicated at the mating faces).

In some embodiments, for each module 501-504, the first identification feature is a first structural feature provided at the module housing (e.g., the module housing 510 shown in FIG. 10B) of the module. For each key member 601-604, the second identification feature is a second structural feature. The second structural feature is configured to define a portion of a periphery of the entrance of the corresponding cavity. For example, the second structural feature may partially define the shape of the entrance of the corresponding cavity. The second structural feature of each key member 601-604 may be complementary in shape to the first structural feature of the corresponding module, so as to only allow the corresponding module to enter the corresponding cavity through the entrance of the cavity.

Taking the first module 501, the first key member 601, and the first cavity 111 as an example, as shown in FIGS. 10A, 10B, and 10E, the first structural feature of the first module 501 may be in the form of a protrusion 501a protruding outwardly from the module housing 510. The protrusion 501a may be a rib extending in the lateral direction X-X. Similar to the first module 501, the second module 502, the third module 503, and the fourth module 504 may include a protrusion 502a, a protrusion 503a, and a protrusion 504a, respectively, protruding outwardly from the module housing. The difference between the protrusions 501a-504a may be in that they differ in locations on the corresponding module housings.

As shown in FIGS. 8B and 8D, the second structural feature of the first key member 601 may be a groove 620 recessed into the first key member 601. The groove 620 may extend through the first key member 601 in the lateral direction X-X. When the first key member 601 is disposed at the first entrance 111a of the first cavity 111, the first key member 601 defines a portion of a perimeter of the entrance of the corresponding cavity. The groove 620 is in communication with the first entrance 111a. The groove 620 of the first key member 601 may be complementary in shape to the protrusion 501a of the first module 501, so that when the user inserts the first module 501 into the first cavity 111, the protrusion 501a of the first module 501 may smoothly pass through the groove 620, thereby allowing the first module 501 to be assembled into the first cavity 111 through the first entrance 111a of the first cavity 111. The groove 620 of the first key member 601 is not complementary in shape to the protrusion 502a of the second module 502, the protrusion 503a of the third module 503, and the protrusion 504a of the fourth module 504, so that when the user attempts to insert the modules 502-504 into the first cavity 111, the protrusions 502a-504a of the modules 502-504 may be blocked by the first key member 601, and the modules 502-504 may not enter the first cavity 111 through the first entrance 111a.

It should be appreciated that although the differences between the protrusions 501a-504a are described herein in that the protrusions 501a-504a are positioned in different locations on the corresponding module housings, it should be appreciated that the present application may not be limited thereto. Alternatively or additionally, the differences between the protrusions 501a-504a may be different sizes, shapes, and/or different numbers.

It should be appreciated that the specific forms of the first structural features and the second structural features may not be limited thereto. For example, the first structural features of the modules 501-504 may be in the form of protrusions protruding outwardly from the module housing, grooves recessed into the module housing, or a combination thereof. Accordingly, the second structural features of the key members 601-604 may also be in the form of protrusions protruding outwardly from the key members 601-604, grooves recessed into the key members 601-604, or a combination thereof.

In some embodiments, each of the plurality of key members 601-604 may be removably disposed at the entrance of a corresponding one of the plurality of cavities 111-114. With such a configuration, it may allow adjustment of the key members disposed at the entrances of the cavities when the module configuration of the first electrical connector 10 is changed. Taking the first key member 601 and the first cavity 111 as an example, as shown in FIGS. 7D and 7F, the first housing 100 may include a notch 160 recessed into the first housing 100 at the entrance 111a of the first cavity 111, and a first retention portion 161 and a second retention portion 162 opposing to each other across the notch 160. As shown in FIGS. 8B and 8D, the first key member 601 may be disposed in the notch 160 at the entrance 111a of the first cavity 111 and held by the first retention portion 161 and the second retention portion 162 therebetween. Such configurations of the first key member 601 and the first cavity 111 does not change or significantly change the dimensions of the first housing 100 in the lateral direction X-X, the longitudinal direction Y-Y, and the vertical direction Z-Z. For example, the first key member 601 may be removably disposed at the entrance 111a of the first cavity 111 without changing or significantly changing the dimension of the first housing 100.

As shown in FIGS. 7D, 7F, and 7H, the entrance 111a of the first cavity 111 is recessed into the first housing 100 in the lateral direction X-X. The first retention portion 161 and the second retention portion 162 may be opposed to each other in the longitudinal direction Y-Y, and may each include a slot 163 extending in the lateral direction X-X and a bayonet 164 disposed at the slot 163.

As shown in FIGS. 14A and 14B, the first key member 601 may include an elongated body 630. The groove 620 may be recessed into the body 630 in the vertical direction Z-Z and extend through the body 630 in the lateral direction X-X. The first key member 601 may further include a first insertion portion 631 and a second insertion portion 632 protruding from opposite ends of the body 630 in the longitudinal direction Y-Y, respectively. The first insertion portion 631 and the second insertion portion 632 may each have a protrusion 633 protruding in the vertical direction Z-Z. The first insertion portion 631 and the second insertion portion 632 of the first key member 601 may be inserted into the slots 163 of the first retention portion 161 and the second retention portion 162 at the entrance 111a of the first cavity 111, respectively, so that the protrusion 633 of the first insertion portion 631 and the protrusion 633 of the second insertion portion 632 snap into the bayonet 164 of the first retention portion 161 and the bayonet 164 of the second retention portion 162, respectively. In this way, the first key member 601 may be removably held in the notch 160.

The configurations of the key members 602-604 may be similar to those of the first key member 601, and the configurations of the first housing 100 at the entrances 112a-114a of the cavities 112-114 may be similar to those at the entrance 111a of the first cavity 111 to enable the key members 602-604 to be removably disposed at the entrances of the corresponding cavities, respectively.

The first housing 100 may removably hold the first module 501 in the first cavity 111. In the illustrated example, the first module 501 may be removably assembled in the first cavity 111. In some embodiments, as shown in FIGS. 7D and 7F, the first housing 100 may include a flange structure 170. The flange structure 170 protrudes into the first cavity 111 to engage with the module housing 510 of the first module 501 when the first module 501 is assembled into the first cavity 111, thereby restricting the first module 501 from moving further toward the mating face 101 of the first housing 100. Alternatively or additionally, the first housing 100 includes latches 171 and 172. The latches 171 and 172 may each protrude into the first cavity 111 to engage with the module housing 510 of the first module 501 when the first module 501 is assembled into the first cavity 111, thereby restricting the first module 501 from moving back toward the entrance 111a. It should be appreciated that the first housing 100 may have any other suitable structure to removably hold the first module 501 in the first cavity 111. Further, it should be appreciated that the first housing 100 may removably hold the second module 502, the third module 503, and the fourth module 504 in corresponding cavities in a similar manner.

Although the above describes configurations related to assembling the modules 501-504 of the first electrical connector 10 into the first housing 100, it should be appreciated that these configurations may also be applicable to the second electrical connector 20. As an example, the modules 51-54 of the second electrical connector 20 may be removably held in the second housing 21 in a similar manner as the first electrical connector 10. Details of these repeated parts will not be described herein again.

As another example, FIG. 21A illustrates an alternative version of the second electrical connector 20. This version is labeled with “2120” in FIG. 21A. The second electrical connector 2120 differs from the aforementioned second electrical connector 20 in that the second electrical connector 2120 may include key members 81, 82, 83, and 84 that are similar in configurations and function to the key members 601-604 described above. The key members 81-84 may be configured to ensure that the modules 51-54 are properly installed into the corresponding cavities of the second housing 21, respectively.

According to aspects of the present disclosure, a method for assembling an electrical connector having a plurality of modules may include: providing key members described herein, and disposing the key members at the entrances of the cavities of the housing of the electrical connector for accommodating the modules; comparing the first identification features of the modules with the second identification features of the key members, when mounting the modules to the cavities of the housing, to determine which of the cavities each module is to be mounted to; and mounting the modules to the corresponding cavities, respectively.

Although the locking member 300 has been described as being pivotably mounted to the cover 400, it should be appreciated that the present application may not be limited thereto. In some embodiments, the locking member 300 may be pivotably mounted to the first housing 100. In some examples, the first electrical connector 10 may be devoid of the cover 400, or the cover 400 may be integrally formed with the first housing 100 as a single housing.

Although the locking member 300 has been described above as being coupled to the slider 200 and driving the slider 200 to slide according to a pivoting operation, thereby urging the cam pin 25 of the second housing 21 to slide in the cam slot 210 of the slider 200, it should be appreciated that the present application may not be limited thereto. In some embodiments, the locking member 300 may be provided with a cam slot to receive the cam pin 25 of the second housing 21, and drive the cam pin 25 to slide in the cam slot when the locking member 300 is pivoted, thereby driving the second electrical connector 20 to move in the mating direction. In this case, the first electrical connector 10 may be devoid of the slider 200.

Although it has been described that the first electrical connector 10 and the second electrical connector 20 each have a plurality of modules, it should be appreciated that aspects of the present application may not be limited thereto, and in some embodiments, the first electrical connector 10 and the second electrical connector 20 may each include a single module.

The inventors have also recognized and appreciated another module that may be used in the aforementioned electrical connector. Such a module may carry multiple types of conductive terminals, thereby integrating multiple types of mating ports at one and the same mating interface. The types and orders of the conductive terminals in such a module may be customized according to user's needs.

FIGS. 22A to 27 illustrate an exemplary version of the module 509. The module 509 may be used in the first electrical connector 10. The function of the module 509 may be similar to those of the modules 501-508 described above, for example, for being (e.g., removably) disposed in the first housing 100 (e.g., a corresponding one of the cavities 111-114) of the first electrical connector 10, and for establishing an electrical connection with the mating module of the second electrical connector 20.

Similar to the module 501, as shown in FIGS. 22A to 22E, the module 509 may include a module housing 800. The exterior shape of the module housing 800 is similar to the exterior shape of the module housing 510 of the module 501, and can be assembled and disposed into the first housing 100 of the first electrical connector 10 in a similar manner (e.g., by means of identification features and/or in a removable manner). For brevity, details of the similar parts may not be repeated.

Unlike the module 501, as shown in FIGS. 22A to 22E, the conductive terminals of the module 509 may be disposed directly in the module housing 800 to be held by the module housing 800. The terminals may be formed from a conductive material. The module housing 800 may be formed from an insulative material. Examples of insulative materials suitable for forming the module housing 800 include, but are not limited to, plastic, nylon, liquid crystal polymer (LCP), polyphenylene sulfide (PPS), high temperature nylon or polyphenylene oxide (PPO) or polypropylene (PP).

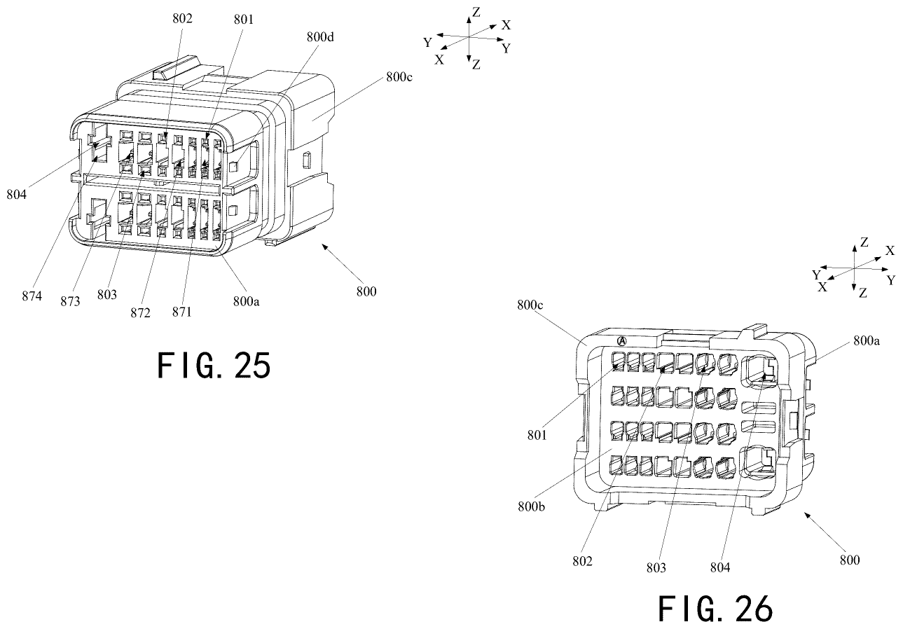

As shown in FIGS. 25 and 26, the module housing 800 includes a mating face 800a and a rear face 800b opposite to each other in a mating direction (here, the lateral direction X-X) and a plurality of terminal channels 801-804. Each of the plurality of terminal channels 801-804 may extend through the module housing 800 in the mating direction from the rear face 800b to the mating face 800a. Each terminal channel 801-804 may have a first opening at the mating face 800a and a second opening at the rear face 800b.

As shown in FIGS. 22A to 24H, the module 509 may be divided into an upper half and a lower half in the vertical direction Z-Z. The module 509 may have identical housing and terminal configurations in the upper and lower halves. Aspects of the module 509 is described herein in connection with the housing and terminal configurations of the module 509 in the upper half.

As shown in FIGS. 22C to 24H, the module 509 may include multiple types of terminals 810-840 in the upper half. As shown in FIG. 22E, the multiple types of terminals 810-840 may include a first terminal 810, a second terminal 820, a third terminal 830, and a fourth terminal 840. Each terminal 810-840 may have a mating end, a tail end opposite to the mating end, and an intermediate portion joining the mating and tail ends. The mating end of each terminal 810-840 may be at least partially disposed in a corresponding one of the plurality of terminal channels 801-804 so that the terminal is held by the module housing 800. For example, the multiple types of terminals 810-840 of the module 509 are all directly held by one and the same insulative module housing. Such a configuration can reduce the number of components of the module 509, thereby improving the integration of the module 509.

As shown in FIG. 22C, each third terminal 830 includes a mating end 831, a tail end 832 opposite to the mating end 831, and an intermediate portion 833 joining the mating end 831 and the tail end 832. The mating end 831 is configured to mate with a mating end of a mating terminal of a mating module of the second electrical connector 20. The mating end 831 provides a port for establishing an electrical connection at the mating face 800a. The tail end 832 may be configured to be in the form of a crimp for attaching a cable (the cable 809 in FIG. 22C). The intermediate portion 833 extends between the mating end 831 and the tail end 832. Each of the first terminal 810, the second terminal 820, and the fourth terminal 840 may be configured similarly to the third terminal 830. For brevity, details of the similar parts may not be repeated.

The sizes of the mating ends of the first terminal 810, the second terminal 820, the third terminal 830, and the fourth terminal 840 may be different to provide connection ports of different sizes at the mating face 800a. In some embodiments, the size of the mating end 841 of the fourth terminal 840 may be greater than the size of the mating end 831 of the third terminal 830, the size of the mating end 831 of the third terminal 830 may be greater than the size of the mating end 821 of the second terminal 820, and the size of the mating end 821 of the second terminal 820 may be greater than the size of the mating end 811 of the first terminal 810. As shown in FIG. 22C, the mating end 831 of the third terminal 830 has a third width WD3 in the longitudinal direction Y-Y perpendicular to the mating direction. For example, the mating end 831 may be configured to be in the form of a receptacle, and the third width WD3 of the mating end 831 in the longitudinal direction Y-Y is an inner width of the receptacle in the longitudinal direction Y-Y. Accordingly, turning to FIG. 22E, the mating end 811 of the first terminal 810 has a first width WD1 in the longitudinal direction Y-Y, the mating end 821 of the second terminal 820 has a second width WD2 in the longitudinal direction Y-Y, and the mating end 841 of the fourth terminal 840 has a fourth width WD4 in the longitudinal direction Y-Y. The fourth width WD4 may be greater than the third width WD3, the third width WD3 may be greater than the second width WD2, and the second width WD2 may be greater than the first width WD1. For example, the widths of the mating ends 811-841 of the terminals 810-840 are different from each other. It should be appreciated that although the width of the mating end of the terminal is described herein as the inner width of the receptacle, the present application may not be limited thereto. In some embodiments, the width of the mating end of the terminal may be an outer width of the receptacle.

With such a configuration, terminals of different sizes for different applications can be integrated into one and the same module 509, so that the module 509 can provide multiple types of connection ports at one and the same mating interface. The module 509 may enable electrical connections for different applications with a high degree of integration.

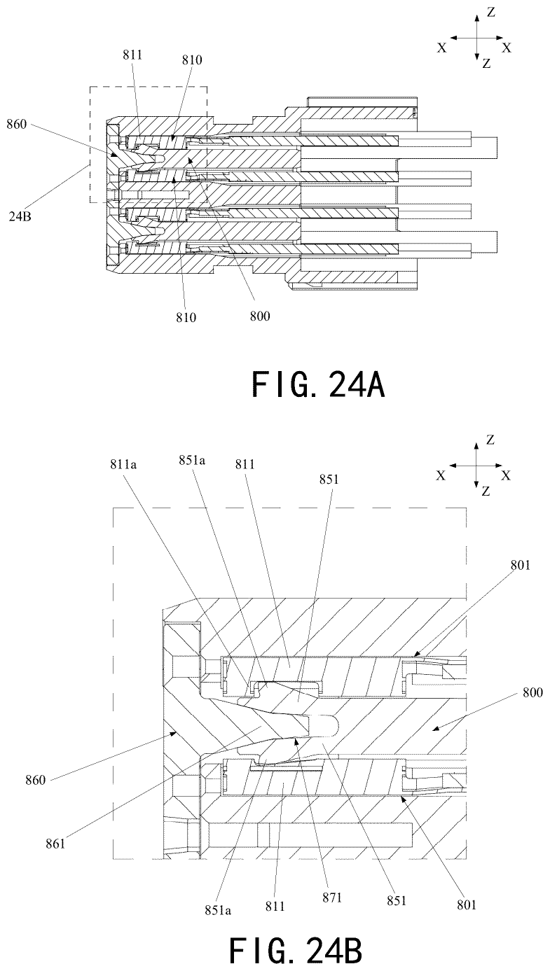

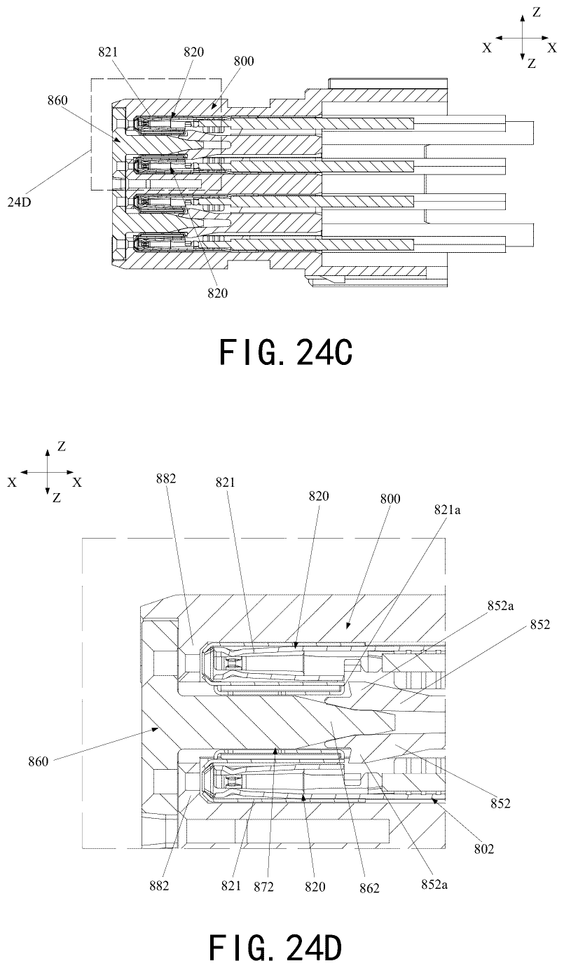

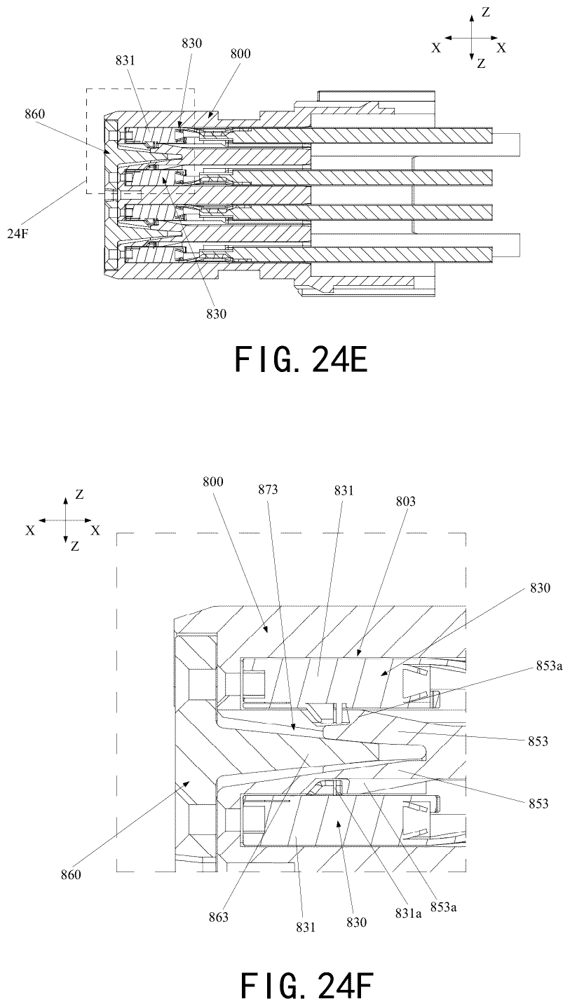

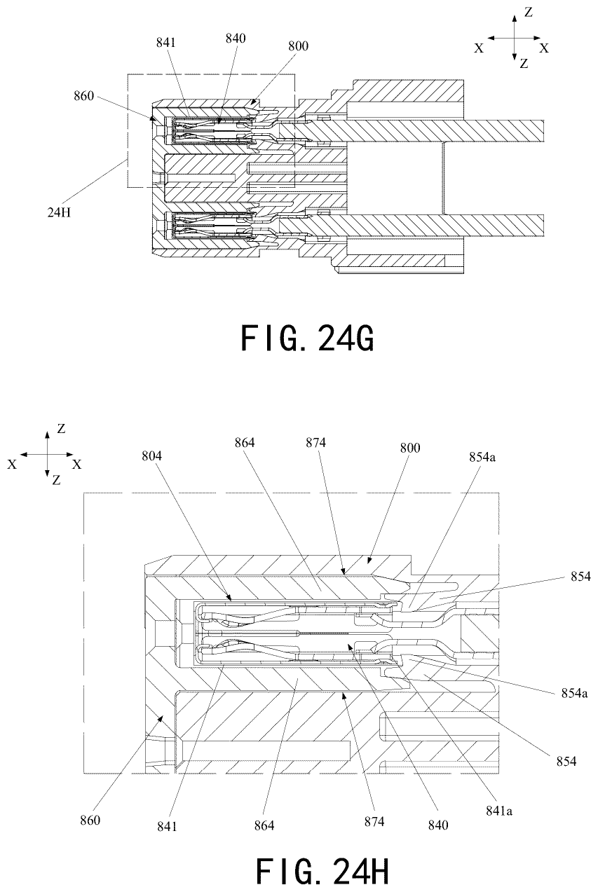

As shown in FIGS. 24A to 26, the module housing 800 may include a first terminal channel 801, a second terminal channel 802, a third terminal channel 803, and a fourth terminal channel 804 each configured for disposing at least a portion of the mating end 811-841 of the terminal 810-840 thercin. As shown in FIGS. 24A to 24H, the mating ends 811-841 of the terminals 810-840, respectively, are entirely disposed in corresponding terminal channels. It should be appreciated that the present application may not be limited thereto, and in some embodiments, the mating ends of the terminals 810-840 may partially protrude from the mating face 800a.

In some embodiments, as shown in FIG. 22E, the multiple types of terminals 810-840 may be arranged in a plurality of groups spaced apart from each other in the longitudinal direction Y-Y. For example, the plurality of groups are arranged in a row in the longitudinal direction Y-Y. In the row, the plurality of groups are spaced apart from each other in the longitudinal direction Y-Y. Each group has a single terminal or a pair of terminals, wherein the pair of terminals are of the same type, and the mating ends of the pair of terminals are aligned with and spaced apart from each other in the vertical direction Z-Z perpendicular to the mating direction (here, the lateral direction X-X) and the longitudinal direction Y-Y. For example, for a pair of terminals in one and the same group, the mating ends thereof are aligned with and spaced apart from each other in the vertical direction Z-Z. Since the mating ends of a pair of terminals in one and the same group have the same sizes and are aligned with each other in the vertical direction Z-Z, the width of the space occupied by the mating ends of all terminals (e.g., a single or a pair) of each group in the longitudinal direction may be equal to the size of the mating end of each terminal of the group in the longitudinal direction.

The plurality of groups may include at least one first group, at least one second group, at least one third group, and at least one fourth group. In some embodiments, as shown in FIGS. 22E and 23 to 24H, each first group has a pair of first terminals 810, and the mating ends 811 of the pair of first terminals 810 are aligned with and spaced apart from each other in the vertical direction Z-Z. Each second group has a pair of second terminals 820, and the mating ends 821 of the pair of second terminals 820 are aligned with and spaced apart from each other in the vertical direction Z-Z. Each third group has a pair of third terminals 830, and the mating ends 831 of the pair of third terminals 830 are aligned with and spaced apart from each other in the vertical direction Z-Z. Each fourth group has a single fourth terminal 840.

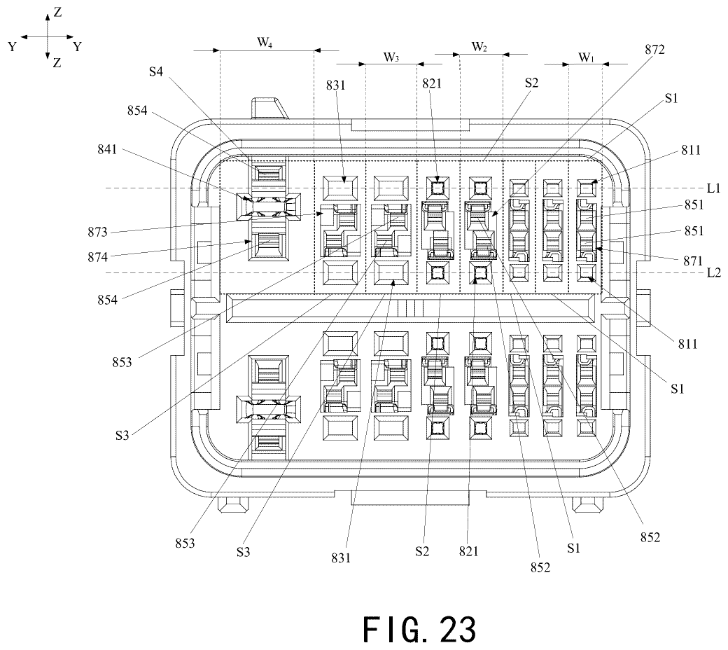

In some embodiments, as shown in FIG. 23, the mating end 811 of one first terminal 810 of each first group, the mating end 821 of one second terminal 820 of each second group, and the mating end 831 of one third terminal 830 of each third group may be aligned along a first line L1 (e.g., their centers are aligned along the first line L1). The first line L1 may be parallel to the longitudinal direction Y-Y. The mating end 811 of the other first terminal 810 of each first group, the mating end 821 of the other second terminal 820 of each second group, and the mating end 831 of the other third terminal 830 of each third group may be aligned along a second line L2 (e.g., their centers are aligned along the second line L2) parallel to the first line L1. The second line L2 may also be parallel to the longitudinal direction Y-Y. The mating end 841 of the (single) fourth terminal 840 of each fourth group may be disposed between the first line L1 and the second line L2 in the vertical direction Z-Z. The mating ends 840 of the fourth terminals 840 may be entirely located between the first line L1 and the second line L2.

In some embodiments, the module housing 800 may include a stopping structure extending into each terminal channel, the stopping structure engages with the mating end of the terminal disposed in the terminal channel to restrict movement of the mating end in the mating direction, thereby securely holding the mating end in the terminal channel.

For example, the mating end of each terminal 810-840 may be configured to be inserted into a corresponding terminal channel from the rear face 800b of the module housing 800 (e.g., through the second opening of the corresponding terminal channel). The mating end of each terminal 810-840 may include a first stop portion. The stopping structure of the module housing 800 may include a plurality of resilient arms (or beams). Each resilient arm may have a second stop portion and protrude into a corresponding one of the plurality of terminal channels 801-804, so that the second stop portion engages with the first stop portion of the mating end of the corresponding terminal to restrict the mating end from being withdrawn in the mating direction toward the rear face 800b of the module housing 800. The second stop portion may be in the form of a barb protruding from the resilient arm in the vertical direction Z-Z. However, it should be appreciated that the present application may not be limited thereto, and the second stop portion may be configured to be in any suitable form, for example, configured as a protrusion having any suitable shape.

Taking the third terminal 830 as an example, as shown in FIG. 22C, the mating end 831 of each third terminal 830 may include a first stop portion 831a protruding from a body of the mating end 831 in the vertical direction Z-Z. The first stop portion 831a may be in the form of a barb. Although the first stop portion 831a is described herein as being in the form of a barb, it should be appreciated that the present application may not be limited thereto, and the first stop portion 831a may be configured to be in any suitable form, for example, as a protrusion having any suitable shape. In some embodiments, the first stop portion 831a may be in the form of a recess recessed into the body of the mating end 831 in the vertical direction Z-Z.

Similar to the third terminal 830, the mating end of each of the first terminal 810, the second terminal 820, and the fourth terminal 840 may have a first stop portion 811a (FIG. 24B), 821a (FIG. 24D), and 841a (FIG. 24H), and the configurations of the first stop portions 811a, 821a, and 841a are similar to that of the first stop portion 831a of the mating end 831 of the third terminal 830. For brevity, details of the similar parts may not be repeated.

In some embodiments, as shown in FIGS. 23, 24A, and 24B, the plurality of resilient arms of the module housing 800 may include a pair of first resilient arms 851 disposed between the mating ends 811 of a pair of first terminals 810 of the first group in the vertical direction Z-Z. Each first resilient arm 851 may have a second stop portion 851a. The second stop portion 851a may be in the form of a barb protruding from the first resilient arm 851 in the vertical direction Z-Z. The pair of first resilient arms 851 may be spaced apart from each other in the vertical direction Z-Z and protrude into the corresponding terminal channels 801 toward the mating ends 811 of the corresponding first terminals 810, respectively, so that the second stop portions 851a engage with the first stop portions 811a (which are shown here as recesses) of the mating ends 811 of the corresponding first terminals 810, thereby restricting the mating ends 811 from being withdrawn toward the rear face 800b of the module housing 800 in the mating direction.

In some embodiments, as shown in FIGS. 23, 24C, and 24D, the plurality of resilient arms of the module housing 800 may include a pair of second resilient arms 852 disposed between the mating ends 821 of the pair of second terminals 820 of the second group in the vertical direction Z-Z. Each second resilient arm 852 may have a second stop portion 852a. The second stop portion 852a may be in the form of a barb protruding from the second resilient arm 852 in the vertical direction Z-Z. The pair of second resilient arms 852 may be spaced apart from each other in the vertical direction Z-Z and protrude into the corresponding terminal channels 802 toward the mating ends 821 of the corresponding second terminals 820, respectively, so that the second stop portions 852a engage with the first stop portions 821a (which are shown here as recesses) of the mating ends 821 of the corresponding second terminals 820, thereby restricting the mating ends 821 from being withdrawn toward the rear face 800b of the module housing 800 in the mating direction.

In some embodiments, as shown in FIGS. 23, 24E, and 24F, the plurality of resilient arms of the module housing 800 may include a pair of third resilient arms 853 disposed between the mating ends 831 of the pair of third terminals 830 in the third group in the vertical direction Z-Z. Each third resilient arm 853 may have a second stop portion 853a. The second stop portion 853a may be in the form of a barb protruding from the third resilient arm 853 in the vertical direction Z-Z. The pair of third resilient arms 853 may be spaced apart from each other in the vertical direction Z-Z and protrude into the corresponding terminal channels 803 toward the mating ends 831 of the corresponding third terminals 830, respectively, so that the second stop portions 853a engage with the first stop portions 831a (which are shown here as barbs) of the mating ends 831 of the corresponding third terminals 830, thereby restricting the mating ends 831 from being withdrawn toward the rear face 800b of the module housing 800 in the mating direction.

In some embodiments, as shown in FIGS. 23, 24G, and 24H, the plurality of resilient arms of the module housing 800 may include a pair of fourth resilient arms 854 disposed on both sides of the mating end 841 of the (single) fourth terminal 840 of the fourth group in the vertical direction Z-Z. For example, the pair of fourth resilient arms 854 may be separated in the vertical direction Z-Z by the mating ends 841 of the fourth terminals 840. The mating end 841 of the fourth terminal 840 may be provided with a first stop portion 841a on each of two sides thereof. Each fourth resilient arm 854 may have a second stop portion 854a. The second stop portion 854a may be in the form of a barb protruding from the fourth resilient arm 854 in the vertical direction Z-Z. The pair of fourth resilient arms 854 respectively protrude into the terminal channel 804 toward the mating end 841 of the fourth terminal 840, so that the pair of second stop portions 854a respectively engage with the pair of first stop portions 841a (which are shown here as recesses) of the mating end 841 of the (single) fourth terminal 840, thereby restricting the mating end 841 from being withdrawn toward the rear face 800b of the module housing 800 in the mating direction.

In some embodiments, as shown in FIGS. 22C and 22D, the module 509 may include a TPA (terminal position retention) device 860 mounted to the module housing 800 to help hold the terminals 810-840 in the module housing 800.

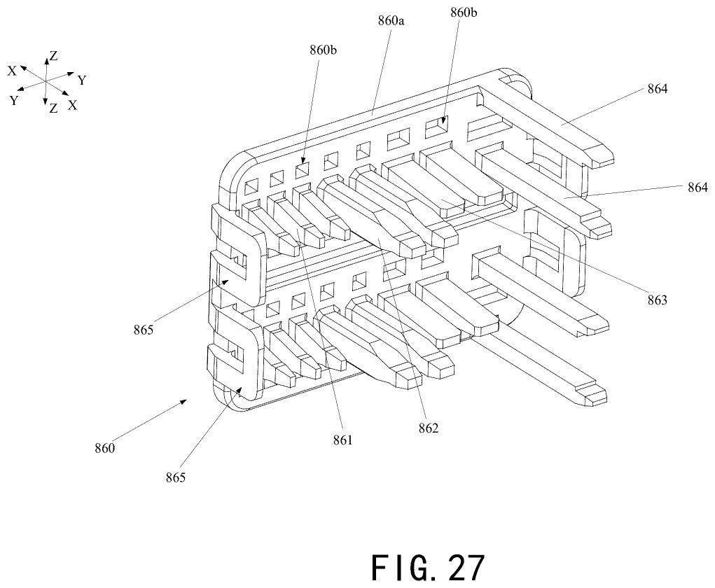

As shown in FIG. 27, the TPA device 860 may include a body 860a and a plurality of openings 860b extending through the body 860a in the mating direction. The TPA device 860 may be mounted to the module housing 800 so that the body 860a is placed on the mating face 800a and so that each of the plurality of openings 860b is aligned with a first opening of a corresponding one of the plurality of terminal channels 801-804 (e.g., the opening of the terminal channel at the mating face 800a) in the mating direction. With such a configuration, the TPA device 860 may provide protection to the first openings of the terminal channels 801-804 of the module housing 800 when the module 509 is mated with the mating module.

With continued reference to FIG. 27, the TPA device 860 may further include a plurality of projections (or beams) 861-864 extending from the body 860a in the mating direction. Each projection 861-864 may be in contact with a corresponding one or a corresponding pair of resilient arms of the module housing 800 to restrict deflection of the resilient arm or the pair of resilient arms away from the mating end of the corresponding terminal. With such a configuration, the TPA device 860 can securely hold the terminals 810-840 in corresponding terminal channels of the module housing 800.

In some embodiments, as shown in FIGS. 23, 24A, and 24B, the module housing 800 may include a first receiving channel 871 extending from the mating face 800a to a position between the pair of first resilient arms 851. The first receiving channel 871 may extend to a position between the pair of first resilient arms 851 in the vertical direction Z-Z. When the TPA device 860 is mounted to the module housing 800, the first projection 861 (a single one in this embodiment) of the TPA device 860 is inserted into the first receiving channel 871 of the module housing 800 and is in contact with the pair of first resilient arms 851 to restrict deflection of the pair of first resilient arms 851 away from the mating end 811 of the corresponding first terminal 810. With such a configuration, the second stop portion 851a of each first resilient arm 851 can be prevented from disengaging from the first stop portion 811a of the mating end 811 of the corresponding first terminal 810.

In some embodiments, as shown in FIGS. 23, 24C, and 24D, the module housing 800 may include a second receiving channel 872 extending from the mating face 800a to a position between the pair of second resilient arms 852. The second receiving channel 872 may extend to a position between the pair of second resilient arms 852 in the vertical direction Z-Z. When the TPA device 860 is mounted to the module housing 800, the second projection 862 (a single one in this embodiment) of the TPA device 860 is inserted into the second receiving channel 872 of the module housing 800 and is in contact with the pair of second resilient arms 852 to restrict deflection of the pair of second resilient arms 852 away from the mating end 821 of the corresponding second terminal 820. With such a configuration, the second stop portion 852a of each second resilient arm 852 may be prevented from disengaging from the first stop portion 821a of the mating end 821 of the corresponding second terminal 820.

In some embodiments, as shown in FIGS. 23, 24E, and 24F, the module housing 800 may include a third receiving channel 873 extending from the mating face 800a to a position between the pair of third resilient arms 853. The third receiving channel 873 may extend to a position between the pair of third resilient arms 853 in the vertical direction Z-Z. When the TPA device 860 is mounted to the module housing 800, the third projection 863 (a single one in this embodiment) of the TPA device 860 is inserted into the third receiving channel 873 of the module housing 800 and is in contact with the pair of third resilient arms 853 to restrict deflection of the pair of third resilient arms 853 away from the mating end 831 of the corresponding third terminal 830. With such a configuration, the second stop portion 853a of each third resilient arm 853 may be prevented from disengaging from the first stop portion 831a of the mating end 831 of the corresponding third terminal 830.

In some embodiments, as shown in FIGS. 23, 24G, and 24H, the module housing 800 may include a pair of fourth receiving channels 874, and each of the pair of fourth receiving channels 874 extends from the mating face 800a to a side of a corresponding one of the pair of fourth resilient arms 854 facing away from the mating end of the fourth terminal 840. Each of the pair of fourth projections 864 of the TPA device 860 is inserted into a corresponding one of the pair of fourth receiving channels 874 and is in contact with a corresponding fourth resilient arm 854 to restrict deflection of the corresponding fourth resilient arm 854 away from the mating end 841 of the fourth terminal 840. With such a configuration, the second stop portion 854a of each fourth resilient arm 854 may be prevented from disengaging from the first stop portion 841a of the mating end 841 of the corresponding fourth terminal 840.

In some embodiments, as shown in FIG. 27, the TPA device 860 may include a snap 865 extending from the body 860a and configured for attaching the TPA device 860 to the module housing 800. For example, the snap 865 may be attached to a mating protrusion 800d (FIG. 25) of the module housing 800. It should be appreciated that the present application may not be limited thereto, and the TPA device 860 may be mounted to the module housing 800 by any suitable means or device.

In some embodiments, the module housing 800 may include a third stop portion extending into the terminal channel at the first opening of each terminal channel 801-804 (e.g., the opening of the terminal channel at the mating face 800a). This may result in the first opening of each terminal channel is narrower than the channel body. The third stop portion engages with a tip portion of the mating end of the terminal disposed in the terminal channel to restrict removal of the mating end from the first opening in the mating direction. With such a configuration, the mating ends of the terminals 810-840 may be securely held in corresponding terminal channels of the module housing 800.

Taking the second terminal 820 as an example, as shown in FIG. 24D, the module housing 800 may include a third stop portion 882 extending into the terminal channel 802 at the first opening of the terminal channel 802. The third stop portion 882 engages with the tip portion of the mating end 821 of the second terminal 820 disposed in the terminal channel 802 to restrict the mating end 821 from being removed from the first opening in the mating direction. Similar to the second terminal 820, the mating end of each of the first terminal 810, the third terminal 830, and the fourth terminal 840 can cooperate with the module housing 800 in a similar manner. For brevity, details of the similar parts may not be repeated.

In some embodiments, as shown in FIGS. 25 and 26, the module housing 800 may include an extension 800c extending from the rear face 800b in the mating direction (here, the lateral direction X-X). As shown in FIG. 22B, each of the terminals 810-840 may be entirely (e.g., including the mating end, the intermediate portion, and the tail end) disposed in a corresponding terminal channel, and the cables 809 may protrude out of the rear face 800b of the module housing 800. The extension 800c may partially surround the cables 809 to prevent the crimped portion of the terminals 810-840 and the cables 809 from being damaged due to the cables 809 being undesirably bent.

In some embodiments, as shown in FIG. 22C, the module housing 800 may include a slot 880 recessed into the module housing 800 from the mating face 800a in the mating direction (here, the lateral direction X-X) and elongated in the longitudinal direction Y-Y. The slot 880 may be configured to receive a protruding portion (e.g., the protruding portion 970) of a mating module when the module 509 is mated with the mating module. The TPA device 860 may be provided with an opening 866 corresponding to the slot 880.

In some embodiments, the first terminal 810 may be a signal terminal, the second terminal 820 may be a signal terminal or a power terminal, and the third terminal 830 and the fourth terminal 840 may be power terminals. The module 509 may be a hybrid module. It should be appreciated that the types of the terminals 810-840 are not limited thereto, but may be selected according to user's needs. For example, the first terminal 810 may be a power terminal, the third terminal 830 may be a signal terminal, and the fourth terminal 840 may be a signal terminal. In some embodiments, the module 509 may be a signal module or a power module.

In some embodiments, as shown in FIG. 23, the housing portion (here, the upper half of the module housing 800) of the module housing 800 provided with the terminals 810-840 may be divided into a plurality of sub-portions S1-S4 when viewed from the mating direction. The plurality of sub-portions S1-S4 are indicated by dashed lines. The plurality of sub-portions S1-S4 are continuous in the longitudinal direction Y-Y. It should be appreciated that the plurality of sub-portions S1-S4 are imaginary portions divided from the module housing 800. The plurality of sub-portions S1-S4 may be integral. Each sub-portion of the plurality of sub-portions S1-S4 forms a terminal channel(s) for disposing the mating end(s) of the terminal(s) of a corresponding one of the plurality of groups described above. For example, each sub-portion defines a terminal channel(s) therein for the terminal(s) of the corresponding group.

As shown in FIG. 23, the first sub-portion S1 of the module housing 800 forms terminal channels 801 for disposing the mating ends 811 of the first terminals 810 (in this embodiment, a pair of first terminals 810) of the first group of the plurality of groups. The second sub-portion S2 of the module housing 800 forms terminal channels 802 for disposing the mating ends 821 of the second terminals 820 (in this embodiment, a pair of second terminals 820) of the second group of the plurality of groups. The third sub-portion S3 of the module housing 800 forms terminal channels 803 for disposing the mating ends 831 of the third terminals 830 (in this embodiment, a pair of third terminals 830) of the third group of the plurality of groups. The fourth sub-portion S4 of the module housing 800 forms a terminal channel 804 for disposing the mating end 841 of the fourth terminal 840 (in this embodiment, a single fourth terminal 840) of the fourth group of the plurality of groups.

With continuing reference to FIG. 23, a minimum width of each first sub-portion S1 in the longitudinal direction Y-Y is W₁. The minimum width of the first sub-portion S1 refers to the minimum width required by the first sub-portion S1 in the longitudinal direction Y-Y when the module housing 800 is formed (e.g., molded) to form the terminal channels 801 for the mating ends 811 of the first terminals 810 of the first group. For example, the width may be the minimum width required to ensure structural strength of the module housing 800. Similarly, the minimum width of the second sub-portion S2 in the longitudinal direction Y-Y is W₂, the minimum width of the third sub-portion S3 in the longitudinal direction Y-Y is W₃, and the minimum width of the fourth sub-portion S4 in the longitudinal direction Y-Y is W₄.

The numbers of the first group, the second group, the third group, and the fourth group may satisfy the following equation:

$$A * {W}_{1} + B * {W}_{2} + C * {W}_{3} + D * {W}_{4} \leq {W}_{Max} \qquad [ Eq . 1 ]$$

where A is the number of the first group, B is the number of the second group, C is the number of the third group, D is the number of the fourth group, and W_{Max} is the maximum width of the housing portion of the module housing 800 in the longitudinal direction Y-Y for allowing to dispose the terminal channels. In this embodiment, A, B, C, and D are all positive integers.

Such a configuration of the module 509 may enable the user to customize the number and orders of the plurality of groups (e.g., the first, second, third, and fourth groups) in the longitudinal direction Y-Y as desired.

In some embodiments, W_{Max} may be 22.86 mm. In some embodiments, the mating ends of the terminals 810-840 are in the form of receptacles, as described above. The width of the mating end of the pin terminal for mating with each first terminal 810 may be 0.5 mm, the width of the mating end of the pin terminal for mating with each second terminal 820 may be 0.63 mm, the width of the mating end of the pin terminal for mating with each third terminal 830 may be 1.2 mm, and the width of the mating end of the pin terminal for mating with each fourth terminal 840 may be 2.8 mm. The inner width of the mating ends of the terminals 810-840 in the form of receptacles may be slightly larger than the width of the mating ends of the pin terminals with which they are mated. Furthermore, W₁ may be 2 mm, W₂ may be 2.54 mm, W₃ may be 3 mm, and W₄ may be 5.5 mm.

For example, as shown in FIG. 23, in the upper half of the module 509, three first groups, two second groups, two third groups, and one fourth group may be included. The width of the housing portion occupied by these groups in the longitudinal direction Y-Y is: 3*2+2*2.54+2*3+1*5.5=22.58 mm, which is less than W_{Max}. It should be appreciated that the number and orders of the plurality of groups may not be limited to the number and orders shown in FIG. 23, and may be customized according to actual needs of the user, as long as the width of the housing occupied by the plurality of groups in the longitudinal direction Y-Y does not exceed W_{Max}. This will be described in detail below in connection with the method for manufacturing the module housing 800.

Although it has been described above that each first group has a pair of first terminals 810, each second group has a pair of second terminals 820, each third group has a pair of third terminals 830, and each fourth group has a single fourth terminal 840, it should be appreciated that the present application may not be limited thereto. In some embodiments, each first group may have a single first terminal 810, each second group may have a single second terminal 820, each third group may have a single third terminal 830, and/or each fourth group may have a pair of fourth terminals 840.

Although it has been described above that the upper half of the module 509 includes four types of terminals, for example, the first terminal 810, the second terminal 820, the third terminal 830, and the fourth terminal 840, it should be appreciated that the present application may not be limited thereto. In some embodiments, the module 509 may include only one, two, or three of the first terminal 810, the second terminal 820, the third terminal 830, and the fourth terminal 840, and/or may include other types of terminals.

The housing and terminal configurations of the module 509 in the upper half have been described above in connection with specific examples. It should be appreciated that the module 509 may have the same or similar housing and terminal configurations in the lower half. It also should be appreciated that the lower half of the module 509 may include different numbers and/or types of terminals, which may in combination have a similar width to the terminals in the upper half of the module 509. For brevity, details of the similar parts may not be repeated.

The module 509 may be manufactured by any suitable method. The method for manufacturing the module 509 may include the steps of: (i) providing the aforementioned multiple types of terminals 810-840 and terminating these terminals 810-840 with the corresponding cables 809; (ii) providing the aforementioned module housing 800; (iii) providing the aforementioned TPA device 860; (iv) first assembling the terminals 810-840 terminated with the corresponding cables 809 into the corresponding terminal channels 801-804 of the module housing 800 according to the aforementioned assembly relationship, and then installing the TPA device 860 to the module housing 800 to reliably hold the terminals 810-840 in the module housing 800.

The terminals 810-840 may be manufactured using any suitable technique, such as stamping. Further, the module housing 800 and TPA device 860 may be manufactured using any suitable technique, such as injection molding.

The inventors have recognized and appreciated a method and a tool kit suitable for manufacturing the module housing 800. Such a method and a tool kit enable module housings for different terminal configurations to be manufactured by one and the same set of tool kit, thereby significantly reducing the labor associated with mold development. Such a method and a tool kit may enable flexible customization of the module housing as desired by the user using one and the same tool kit. Such a method may enable the reuse of the tool kit. In this way, the development and manufacturing costs of the module 509 can be reduced.

The module housing 800 of the module 509 may be formed by flowing a housing material (e.g., the insulative material described herein) into a mold provided with or including such a tool kit (e.g., an injection molding technique). As described, the module 509 may have the same housing configurations in the upper and lower halves. The module 509 may have the same or different terminal configurations in the upper and lower halves. The method for manufacturing the upper half of the module housing 800 and the corresponding components of the tool kit 1000 will be described in detail below in connection with FIGS. 30A to 35. It should be appreciated that the lower half of the module housing 800 may be formed simultaneously in one and the same process (e.g., one and the same injection molding step) by using the same or similar components of the tool kit.

The tool kit 1000 may constitute a portion of, and/or may be disposed in, a mold for forming the module housing 800. The components of the tool kit 1000 may be assembled together to define at least a portion of the cavity configured to form the module housing 800. The shape of the cavity corresponds to the shape of the module housing 800 described above, enabling the module housing 800 to be formed by flowing housing material into the cavity.

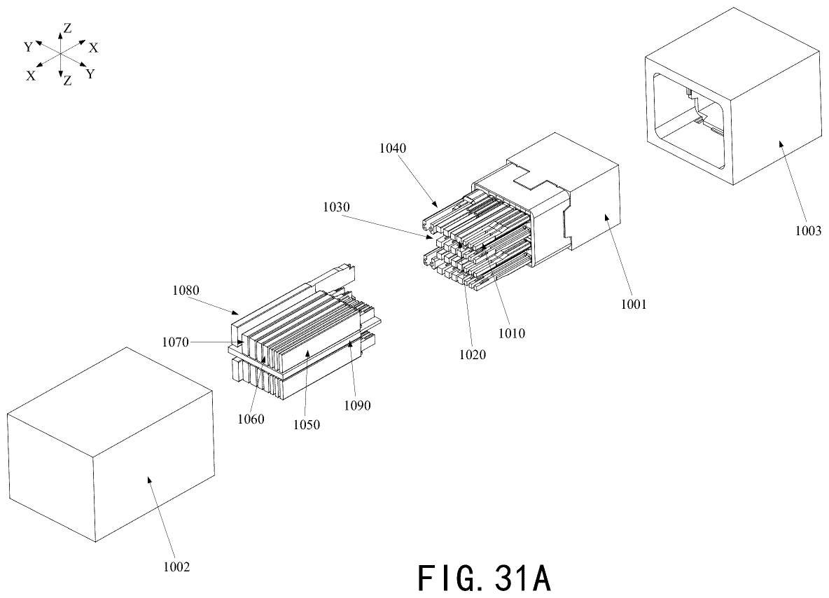

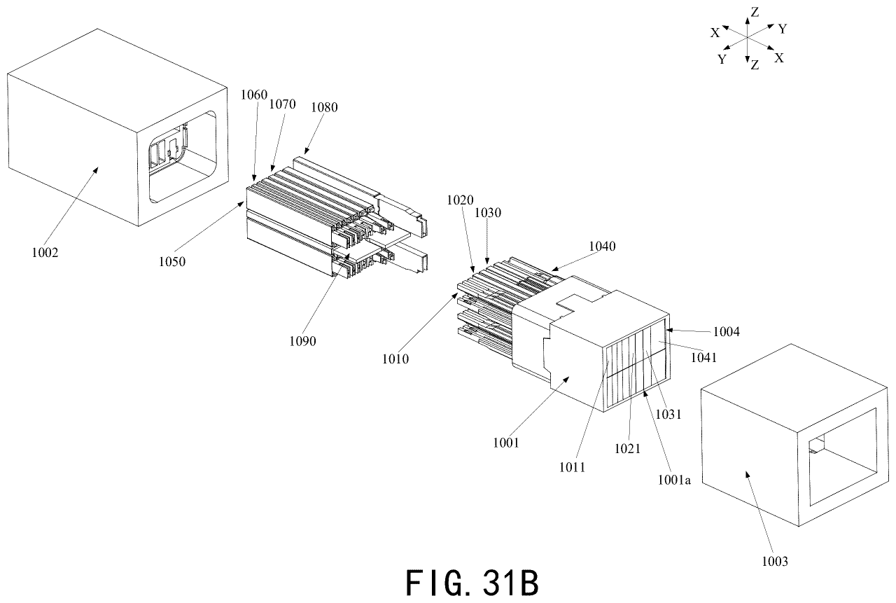

As shown in FIGS. 31A to 34D, the tool kit 1000 may include multiple types of tool pins 1010-1040. The multiple types of tool pins 1010-1040 may be configured to form at least the terminal channels 801-804 of the module housing 800. Each type of tool pin may correspond to one of the multiple types of terminals 810-840 to be disposed in the module housing 800. As described, in some embodiments, the multiple types of terminals 810-840 may include the first terminal 810, the second terminal 820, the third terminal 830, and the fourth terminal 840. Accordingly, the multiple types of tool pins 1010-1040 may include a first tool pin 1010, a second tool pin 1020, a third tool pin 1030, and a fourth tool pin 1040 corresponding to the first terminal 810, the second terminal 820, the third terminal 830, and the fourth terminal 840, respectively.

The method for manufacturing the upper half of the module housing 800 may include (i) providing the multiple types of tool pins 1010-1040; (ii) aligning the multiple types of tool pins 1010-1040 according to terminal locations (e.g., terminal locations shown in FIGS. 22E and 23) at which the multiple types of terminals 810-840 are to be disposed in the module housing 800; and (iii) flowing a housing material around the aligned tool pins 1010-1040 to form the module housing 800.

The multiple types of tool pins 1010-1040 may be arranged at terminal locations in the module housing 800 at which the multiple types of terminals 810-840 are to be disposed, e.g., as desired by the user. This may enable module housings for different terminal configurations to be manufactured with one and the same set of tooling kit, thereby significantly reducing the labor associated with mold development. Such a method and a tool kit enable flexible customization of the module housing as desired by the user using one and the same tool kit. Such a method may enable the reuse of the tool kit. In this way, the development and manufacturing costs of the module 509 can be reduced.

The multiple types of tool pins 1010-1040 may be arranged and held in the mold in any suitable manner. In some embodiments, during manufacturing, the housing material in a molten state may be injected into the mold to flow around the multiple types of tool pins 1010-1040. The cured housing material may then be removed from the mold to obtain the module housing 800.

In some embodiments, as shown in FIGS. 30C to 33, the first tool pin 1010, the second tool pin 1020, the third tool pin 1030, and the fourth tool pin 1040 may include a base 1011, a base 1021, a base 1031, and a base 1041, respectively. The bases 1011-1041 may each have a substantial plate or blade shape. The bases 1011-1041 may have substantially the same base lengths in the lateral direction X-X (e.g., the mating direction) and may have substantially the same base thicknesses in the vertical direction Z-Z. The bases 1011-1041 may have different base widths in the longitudinal direction Y-Y. It should be appreciated that the mating direction, the lateral direction X-X, the longitudinal direction Y-Y, and the vertical direction Z-Z are used herein for case of description, but the manufacturing method and the tool kit 1000 according to the present application may not be limited by these directions.

As shown in FIGS. 30C to 33, the tool kit 1000 may also include a first organizer 1001. The first organizer 1001 is configured to carry and hold the tool pins 1010-1040. The first organizer 1001 includes a slot (or cavity) 1001a extending in the longitudinal direction Y-Y. The bases 1011-1041 of the multiple types of tool pins 1010-1040 may be configured for being stacked in the slot 1001a in the longitudinal direction Y-Y. “Stacked” may refer to that the bases may be placed next to each other in a manner that one is above another.

Aligning the multiple types of tool pins 1010-1040 according to the terminal locations at which the multiple types of terminals 810-840 are to be disposed in the module housing 800 may include providing the first organizer 1001, and stacking the multiple types of tool pins 1010-1040 in the longitudinal direction Y-Y in the slot 1001a of the first organizer 1001 according to the terminal locations. Such a configuration may improve the “typesetting” efficiency of the tool pins 1010-1040, thereby enabling rapid adjustment of the mold for forming module housings for different terminal configurations.

Each tool pin 1010-1040 may also include at least one beam extending from the base in the lateral direction X-X (the mating direction). Each of the at least one beam is contoured to conform to a shape of a terminal channel for disposing a mating end of a terminal corresponding to the tool pin. Flowing the housing material around the multiple types of tool pins 1010-1040 may include flowing the housing material around the beams of the multiple types of tool pins 1010-1040 to form the plurality of terminal channels 801-804 of the module housing 800.

In some embodiments, as shown in FIG. 22E, the multiple types of terminals 810-840 may be arranged in a plurality of groups spaced apart from each other in the longitudinal direction Y-Y. Each group may have a single terminal or a pair of terminals, wherein the pair of terminals may be of the same type, and the mating ends of the pair of terminals may be aligned with and spaced apart from each other in the vertical direction Z-Z. The plurality of groups may include at least one first group, at least one second group, at least one third group, and at least one fourth group. Each first group may have a pair of first terminals 810, each second group may have a pair of second terminals 820, each third group may have a pair of third terminals 830, and each fourth group may have a single fourth terminal 840.

Each tool pin 1010-1040 may correspond to a group of the plurality of groups, and the number of at least one beam of each tool pin 1010-1040 may correspond to the number of the mating ends of the terminals in the corresponding group. For example, each first tool pin 1010 may correspond to a first group and include a pair of first beams 1012. Each first beam 1012 is contoured to conform to the shape of the terminal channel 801 for disposing the mating end 811 of a corresponding one of the pair of first terminals 810 of the first group. Each second tool pin 1020 may correspond to a second group and include a pair of second beams 1022. Each second beam 1022 is contoured to conform to the shape of the terminal channel 802 for disposing the mating end 821 of a corresponding one of the pair of second terminals 820 in the second group. Each third tool pin 1030 may correspond to a third group and include a pair of third beams 1032. Each third beam 1032 is contoured to conform to the shape of the terminal channel 803 for disposing the mating end 831 of a corresponding one of the pair of third terminals 830 in the third group. Each fourth tool pin 1040 may correspond to a fourth group and include a single fourth beam 1042. The fourth beam 1042 is contoured to conform the shape of the terminal channel 804 for disposing the mating end 841 of the (single) fourth terminal 840 in the fourth group. The beams 1012-1042 enable the plurality of terminal channels 801-804 to be formed in the module housing 800 when the housing material flows around the beams 1012-1042 of the tool pins 1010-1040.

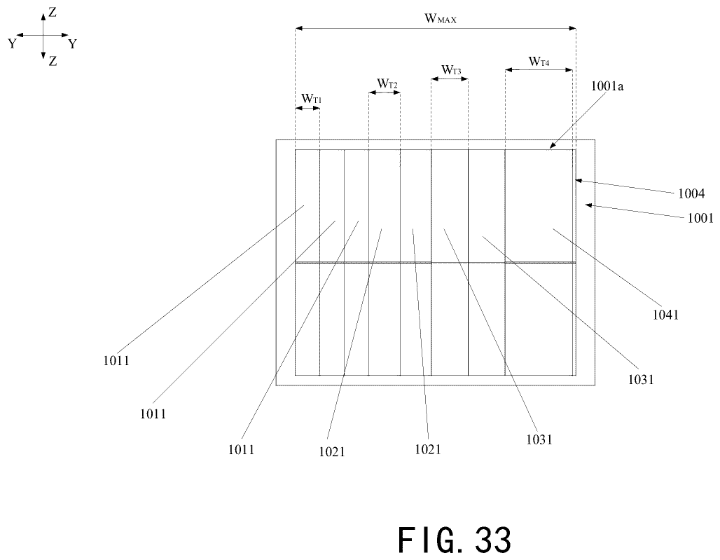

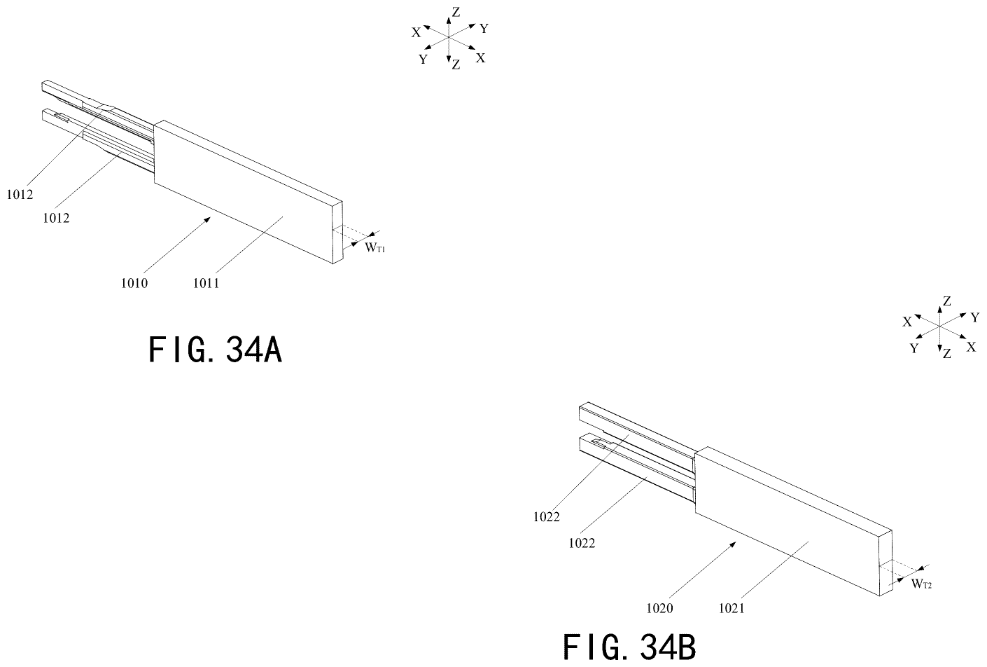

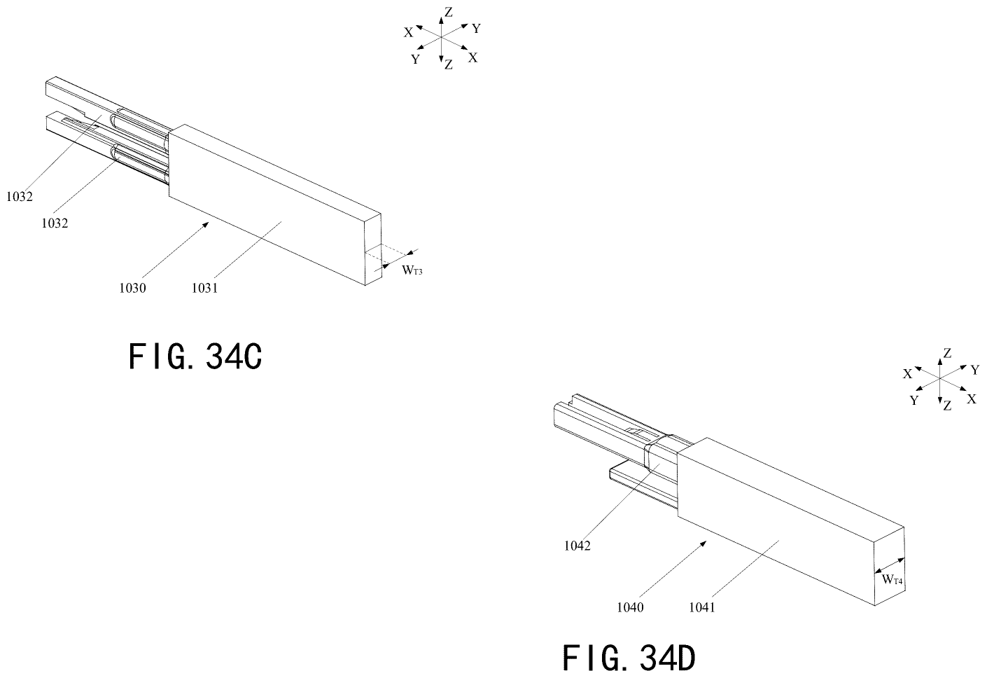

As shown in FIGS. 33 to 34D, the base 1011 of the first tool pin 1010 has a base width W_{T1} in the longitudinal direction Y-Y, the base 1021 of the second tool pin 1020 has a base width W_{T2} in the longitudinal direction Y-Y, the base 1031 of the third tool pin 1030 has a base width W_{T3} in the longitudinal direction Y-Y, and the base 1041 of the fourth tool pin 1040 has a base width W_{T4} in the longitudinal direction Y-Y. The base widths W_{T1}, W_{T2}, W_{T3}, and W_{T4} are different from each other and are each fixed. The slot 1001a has a fixed slot width in the longitudinal direction Y-Y. Stacking the bases 1011-1041 of the tool pins 1010-1040 in the longitudinal direction Y-Y in the slot 1001a according to the terminal positions may include making the width of the stack of the bases 1011-1041 of the tool pins 1010-1040 in the longitudinal direction Y-Y (e.g., a sum of the base widths of all bases 1011-1041) less than or equal to a slot width of the slot 1001a. Such a configuration may enable the tool pins 1010-1040 to be “typeset” as desired in the slot 1001a having a fixed width (e.g., providing a desired number of the tool pins 1010-1040 and stacking them in a desired order) to produce module housings with different terminal channel layouts.

The slot width of the slot 1001a may be equal to the maximum width, in the longitudinal direction Y-Y, of the housing portion in the module housing 800 allowing for disposing the plurality of terminal channels 801-804. As shown in FIG. 23, the housing portion may be divided into the plurality of sub-portions S1-S4. Each sub-portion of the plurality of sub-portions S1-S4 forms a terminal channel(s) for disposing the mating end(s) of the terminal(s) of a corresponding one of the plurality of groups described above.

For each tool pin 1010-1040, the base width of the base is equal to the minimum width of a sub-portion (e.g., S1-S4) of the housing portion in the longitudinal direction Y-Y, where the sub-portion is configured to form the terminal channel(s) for disposing the mating end(s) of the terminal(s) corresponding to the tool pin. For example, the base width W_{T1} of the base 1011 of the first tool pin 1010 is equal to the minimum width W₁ of the first sub-portion S1 of the housing portion. The base width W_{T2} of the base 1021 of the second tool pin 1020 is equal to the minimum width W₂ of the second sub-portion S2 of the housing portion, the base width W_{T3} of the base 1031 of the third tool pin 1030 is equal to the minimum width W₃ of the third sub-portion S3 of the housing portion, and the base width W_{T4} of the base 1041 of the fourth tool pin 1040 is equal to the minimum width W₄ of the fourth sub-portion S4 of the housing portion.

With such a configuration, “typesetting” of the plurality of terminal channels 801-804 of the module housing 800 may be easily and quickly achieved by aligning the bases 1011-1041 of the tool pins 1010-1040 in the slots 1001a of the first organizer 1001. This may significantly reduce the labor associated with mold development, thereby reducing the development and manufacturing costs of the module 509.

Providing the multiple types of tool pins 1010-1040 may include providing the multiple types of tool pins 1010-1040 according to the following equation:

$$A * {W}_{T 1} + B * {W}_{T 2} + C * {W}_{T 3} + D * {W}_{T 4} \leq {W}_{Max} \qquad [ Eq . 2 ]$$

where A is the number of the first tool pin 1010 (corresponding to the first group), B is the number of the second tool pin 1020 (corresponding to the second group), C is the number of the third tool pin 1030 (corresponding to the third group), and D is the number of the fourth tool pin 1040 (corresponding to the fourth group). W_{Max} is the slot width of the slot 1001a, for example, the maximum width, in the longitudinal direction Y-Y, of the housing portion of the module housing 800 allowing for disposing the terminal channel(s). In this embodiment, A, B, C, and D are all positive integers.

In some embodiments, W_{Max} may be 22.86 mm. In some embodiments, the mating ends of the terminals 810-840 are in the form of receptacles, as described above. The width of the mating end of the pin terminal for mating with each first terminal 810 may be 0.5 mm, and the minimum width W₁ of the first sub-portion S1 may be 2 mm; the width of the mating end of the pin terminal for mating with each second terminal 820 may be 0.63 mm, and the minimum width W₂ of the second sub-portion S2 may be 2.54 mm; the width of the mating end of the pin terminal for mating with each third terminal 830 may be 1.2 mm, and the minimum width W₃ of the third sub-portion S3 may be 3 mm; and the width of the mating end of the pin terminal for mating with each fourth terminal 840 may be 2.8 mm, and the minimum width W₄ of the fourth sub-portion S4 may be 5.5 mm. Accordingly, the base width W_{T1} of the base 1011 of the first tool pin 1010 may be 2 mm, the base width W_{T2} of the base 1021 of the second tool pin 1020 may be 2.54 mm, the base width W_{T3} of the base 1031 of the third tool pin 1030 may be 3 mm, and the base width W_{T4} of the base 1041 of the fourth tool pin 1040 may be 5.5 mm.

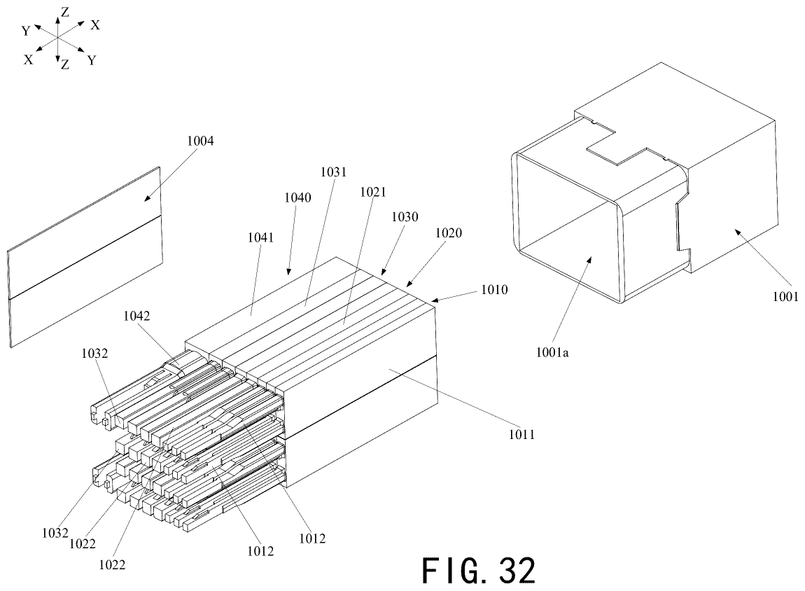

In some embodiments, as shown in FIGS. 32 and 33, the tool kit 1000 may also include a spacer 1004. The spacer 1004 is configured to be disposed in slot 1001a to fill a gap between the stack of the bases 1011-1041 of the tool pins 1010-1040 and an end wall of the slot 1001a when the width of the stack is less than the slot width of the slot 1001a. As best shown in FIG. 33, the bases 1011 of three first tool pins 1010, the bases 1021 of two second tool pins 1020, the bases 1031 of two third tool pins 1030, and the base 1041 of one fourth tool pin 1040 may be stacked in the slot 1001a of the first organizer 1001 in the longitudinal direction Y-Y. The stack of these bases 1011-1041 has a width in the longitudinal direction Y-Y of 3*2+2*2.54+2*3+1*5.5=22.58 mm. This value is less than the slot width of the slot 1001a, which is 22.86 mm, so there is a gap of 0.3 mm between the stack and the end wall of slot 1001a in the longitudinal direction Y-Y. The width of the spacer 1004 in the longitudinal direction Y-Y may be 0.3 mm. The spacer 1004 may be disposed between the stack and the end wall of the slot 1001a at one end of the slot 1001a to fill the gap therebetween to ensure that the stack is securely held by the first organizer 1001.

Although only a single spacer 1004 is shown in FIG. 33, it should be appreciated that the tool kit 1000 may include more than one spacer 1004. Furthermore, the thickness of the spacer 1004 may not be limited to 0.3 mm, but may be any suitable value, for example, 0.01 mm, 0.02 mm, 0.05 mm, 0.1 mm, 0.2 mm, 0.5 mm, 1 mm, etc.

In some embodiments, as shown in FIGS. 30C to 32 and 35, the tool kit 1000 may also include multiple types of complementary tool pins 1050-1080. Each type of complementary tool pin 1050-1080 may cooperate with a corresponding type of tool pin 1010-1040 to define a space or gap therebetween for forming features of the module housing 800, such as the resilient arms 851-854, the mating face 800a including the first opening, and the receiving channels 871-874. When the housing material flows into the corresponding space or gaps, corresponding features of the module housing 800 may be formed. The complementary tool pins 1050-1080 may further reduce the labor associated with mold development, thereby further reducing the development and manufacturing costs of the module 509.

The multiple types of complementary tool pins 1050-1080 may include a first complementary tool pin 1050, a second complementary tool pin 1060, a third complementary tool pin 1070, and a fourth complementary tool pin 1080 corresponding to and mating with the first tool pin 1010, the second tool pin 1020, the third tool pin 1030, and the fourth tool pin 1040, respectively.

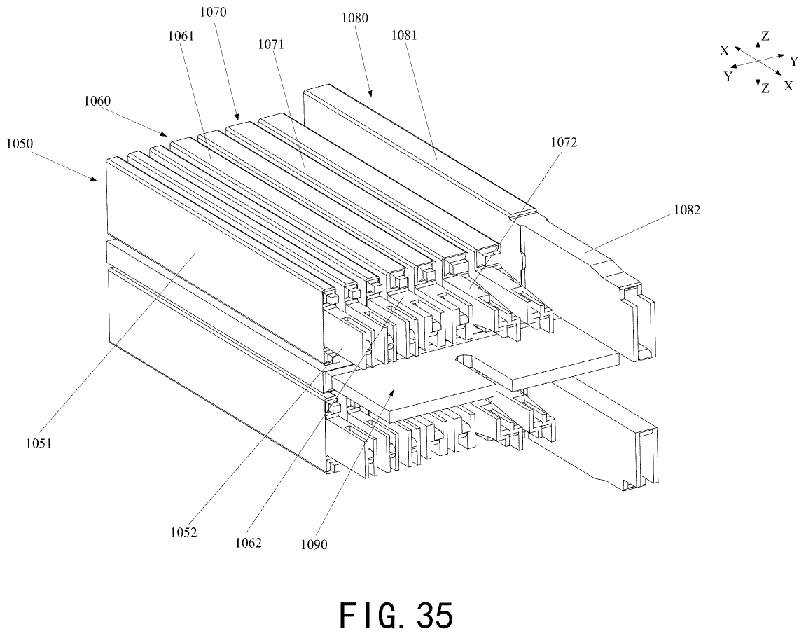

In some embodiments, as shown in FIG. 35, similar to the tool pins 1010-1040, each complementary tool pin 1050-1080 may include a base 1051, 1061, 1071, and 1081 and a beam 1052, 1062, 1072, and 1082 extending from the base 1051-1081 in the lateral direction X-X (the mating direction). The tool kit 1000 may also include a second organizer 1002 for carrying and holding the complementary tool pins 1050-1080. As shown in FIGS. 31B and 35, the complementary tool pins 1050-1080 may be spaced apart from each other in the longitudinal direction Y-Y, and the second organizer 1002 has a separate seat for disposing each complementary tool pin 1050-1080. The configurations of the bases 1051-1081 of the complementary tool pins 1050-1080 may be similar to the configurations of the bases 1011-1041 of the tool pins 1010-1040, the configurations of the second organizer 1002 may be similar to the configurations of the first organizer 1001, and the bases 1051-1081 of the complementary tool pins 1050-1080 may be stacked in the slot of the second organizer 1002 in the longitudinal direction Y-Y in a similar manner. For brevity, details of the similar parts may not be repeated.

The beam 1052-1082 of each complementary tool pin 1050-1080 may cooperate with the beam 1012-1042 of a corresponding tool pin 1010-1040 to define a space or gap therebetween for forming a feature of the module housing 800, such as the resilient arms 851-854 and the receiving channels 871-874.

Taking the cooperation between the first tool pin 1010 and the first complementary tool pin 1050 as an example, as best shown in FIGS. 30E and 30F, the first portion 1052a of the beam 1052 of the first complementary tool pin 1050 may be positioned between the pair of first beams 1012 of the first tool pin 1010 in the vertical direction Z-Z to define a first space SPI between each first beam 1012 and the first portion 1052a. The shape of each first space SPI corresponds to the shape of the corresponding first resilient arm 851 of the module housing 800. Forming the module housing 800 includes flowing housing material into the two first spaces SPI to form a pair of first resilient arms 851 (FIG. 30F). Further, after the first portion 1052a of the first complementary tool pin 1050 is removed, a first receiving channel 871 extending between the pair of first resilient arms 851 may be provided in the module housing 800. For brevity, the structures and functions of the first resilient arm 851 and the first receiving channel 871 will not be repeated.

The second resilient arm 852 and the second receiving channel 872 may be formed in the module housing 800 by a similar method via the cooperation between the second tool pin 1020 and the second complementary tool pin 1060, and the third resilient arm 853 and the third receiving channel 873 may be formed in the module housing 800 by a similar method via the cooperation between the third tool pin 1030 and the third complementary tool pin 1070. For brevity, details of the similar parts may not be repeated.

The fourth resilient arm 854 and the fourth receiving channel 874 may be formed in the module housing 800 by a similar method via the cooperation between the fourth tool pin 1040 and the fourth complementary tool pin 1080. For example, a first portion and a second portion of the beam 1082 of the fourth complementary tool pin 1080 may be positioned on both sides of the fourth beam 1042 of the fourth tool pin 1040 in the vertical direction Z-Z, respectively, to define a first space between the first portion and the fourth beam 1042, and a second space between the second portion and the fourth beam 1042. The shapes of the first space and the second space respectively correspond to the shapes of the pair of fourth resilient arms 854 of the module housing 800. Forming the module housing 800 includes flowing housing material into the first space and the second space to form the pair of fourth resilient arms 854. Further, after the first and second portions of the fourth complementary tool pin 1080 are removed, a pair of fourth receiving channels 874 may be provided in the module housing 800. For brevity, the structures and functions of the fourth resilient arm 854 and the fourth receiving channel 874 may not be repeated.

In some embodiments, as shown in FIGS. 31B and 35, the tool kit 1000 may further include a tool insert plate 1090 configured to form the aforementioned slot 880 of the module housing 800 when flowing the housing material around the tool insert plate 1090.

In some embodiments, as shown in FIGS. 30A to 31B, the tool kit 1000 may further include an outer mold 1003 configured to surround the first organizer 1001 and define a space therebetween. The space may be configured to form the extension 800c of the module housing 800 when flowing the housing material thereinto. It should be appreciated that the tool kit 1000 may include an outer mold having any suitable shape for forming external structures and features of the module housing 800.

Although the tool kit 1000 has been described above as including the first to fourth tool pins 1010-1040 and the first to fourth complementary tool pins 1050-1080, it should be appreciated that the present application may not be limited thereto. In some embodiments, the types of tool pins and complementary tool pins may vary depending on the types of terminals to be disposed in the module housing 800.

The method and tool kit for manufacturing the upper half of the module housing 800 have been described above in connection with specific examples. It should be appreciated that the lower half of the module housing 800 may be formed simultaneously in one and the same process (e.g., one and the same injection molding step) using the same or similar components of the kit. For brevity, details of the similar parts may not be repeated.

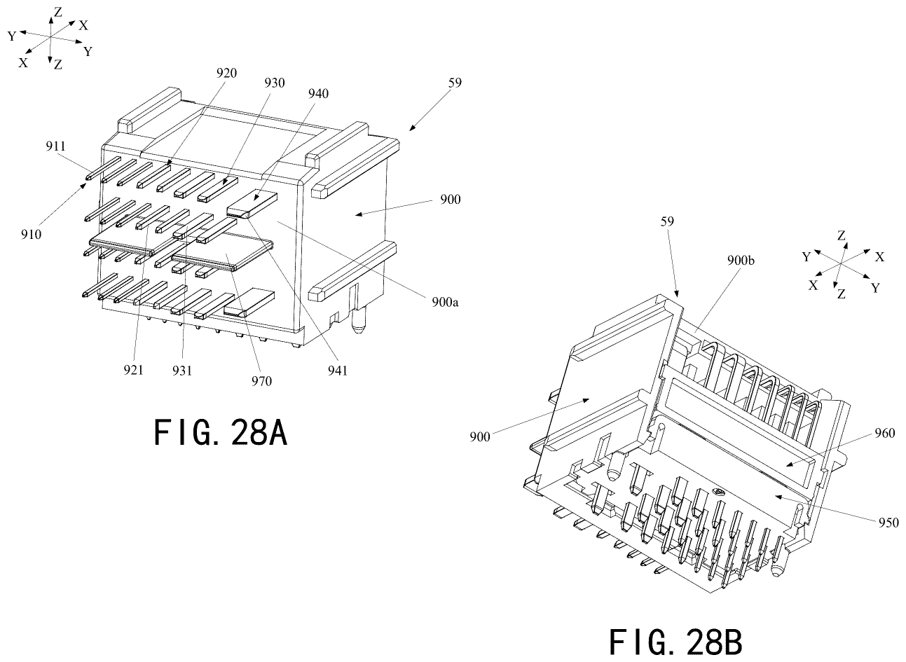

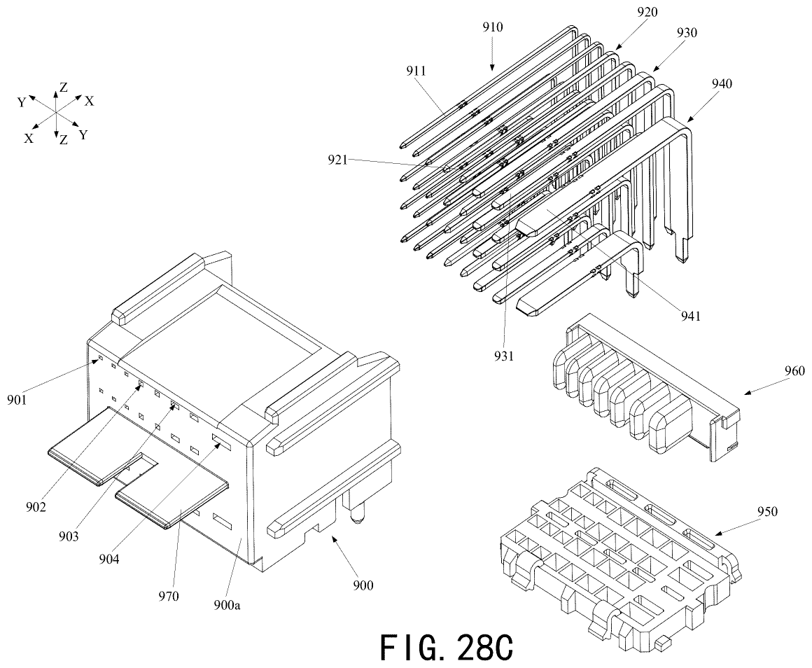

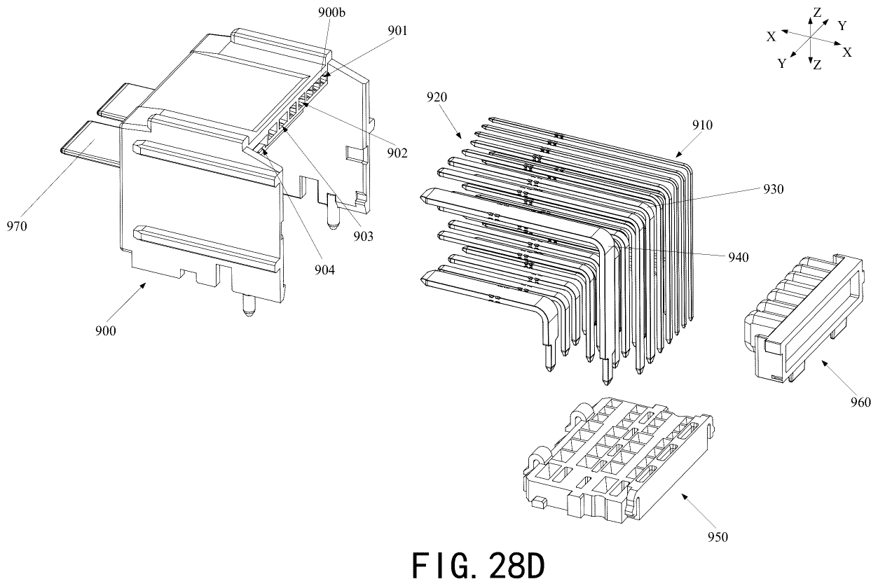

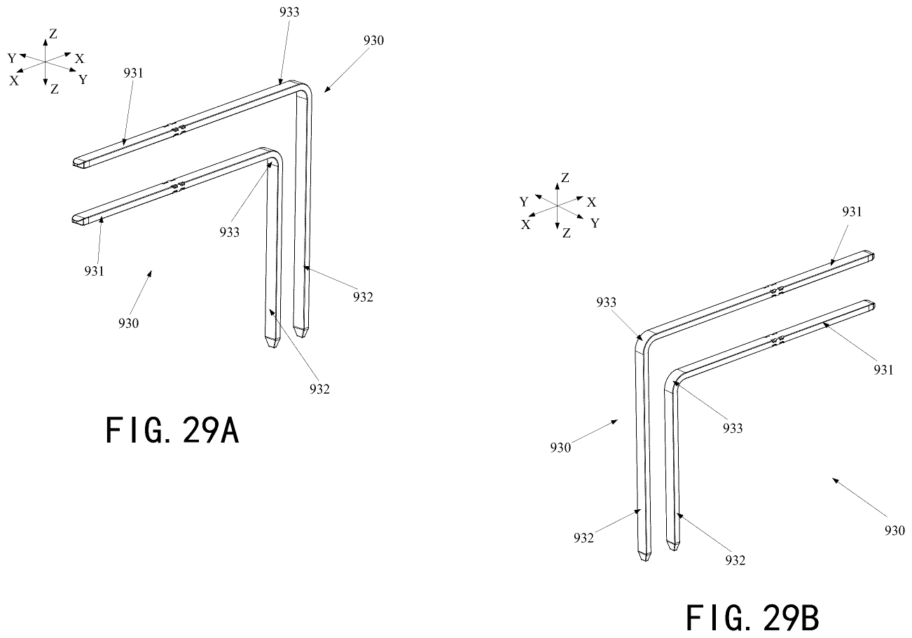

It should be appreciated that the techniques described above for configuring and manufacturing the module 509 may also be used to configure and manufacture a module for mating with the module 509. FIGS. 28A to 29B illustrate an exemplary version of such a module 59.

The module 59 may be used in the second electrical connector 20. The functions of the module 59 are similar to those of the module 51-57 described above, e.g., for being (e.g., removably) disposed in the second housing 21 (e.g., one of the cavities 71-74) of the second electrical connector 20, and for establishing an electrical connection with the mating module of the first electrical connector 10. For example, the module 59 may be configured to mate with the module 509 described above. The configurations of the module 59 may be similar to the configurations of the module 509 (e.g., complementary to each other to enable mating) and may be manufactured in a similar process to the module 509. For brevity, details of the similar parts may not be repeated, and the unique features of the module 59 will be highlighted below by comparing the module 59 with the module 509.

Similar to the module 509, the module 59 may include an insulative module housing 900 and multiple types of conductive terminals 910-940 disposed in the module housing 900. The module housing 900 may also be formed from the insulative materials described above. The module housing 900 includes a mating face 900a and a rear face 900b opposite to each other in the mating direction (here, the lateral direction X-X) and a plurality of terminal channels 901-904. Each of the plurality of terminal channels 901-904 may extend through the module housing 900 from the rear face 900b to the mating face 900a in the mating direction.

As shown in FIGS. 28C and 28D, the multiple types of terminals 910-940 may include a first terminal 910, a second terminal 920, a third terminal 930, and a fourth terminal 940. Each terminal 910-940 may have a mating end, a tail end opposite to the mating end, and an intermediate portion joining the mating end and the tail end. The mating end of each terminal 910-940 is partially disposed in a corresponding one of the plurality of terminal channels 901-904 so that the terminal is held by the module housing 900. For example, the multiple types of terminals 910-940 of the module 59 are all directly held by one and the same insulative module housing. Such a configuration may reduce the number of components of the module 59, thereby improving the integration of the module 59.

The first difference between the module 59 and the module 509 is in that the mating ends 911-941 of the terminals 910-940 of the module 59 are respectively configured to mate with the mating ends 811-841 of the terminals 810-840 of the module 509. For example, FIGS. 29A and 29B illustrate aspects of the pair of third terminals 930. The pair of third terminals 930 are configured to mate with the pair of third terminals 830 of the module 509 as shown in FIG. 22C. As shown in FIGS. 29A and 29B, each third terminal 930 includes a mating end 931, a tail end 932 opposite to the mating end 931, and an intermediate portion 933 joining the mating end 931 and the tail end 932. The mating end 931 may be configured to partially protrude from the mating face 900a and to mate with the mating end 831 of the third terminal 830 of the module 509. The shape of the mating end 931 may match with (e.g., complementary to) the shape of the mating end 831 of the third terminal 830. The mating end 931 may be configured in the form of a pin, and the width of the mating end 931 in the longitudinal direction Y-Y may be the width of the pin in the longitudinal direction Y-Y, so that the mating end 931 is complementary to the mating end 831 in the form of a socket.

The second difference between the module 59 and the module 509 is in that the tail ends of the terminals 910-940 of the module 59 are respectively configured to be mounted on the circuit board 30 for establishing an electrical connection with the circuit board 30. For example, as shown in FIGS. 29A and 29B, the tail end 932 of each third terminal 930 may be configured to establish an electrical connection (e.g., SMT or THT technology) with a conductive structure, such as a conductive through hole or a conductive pad, of the circuit board 30. The intermediate portion 933 extends between the mating end 931 and the tail end 932, and is curved so that the tail end 932 and the mating end 931 are oriented substantially perpendicularly to one another. When the mating end 931 is oriented in the mating direction (here, the lateral direction X-X), the tail end 932 is oriented in the vertical direction Z-Z.

The configuration of each of the first terminal 910, the second terminal 920, and the fourth terminal 940 of the module 59 is similar to that of the third terminal 930. For brevity, details of the similar parts may not be repeated.

The third difference between the module 59 and the module 509 is that the module 59 may include a first retention member 950 and a second retention member 960. The first retention member 950 and the second retention member 960 may each be an insulative member. The first retention member 950 may be mounted to the module housing 900 and hold a portion of the tail end 932 of each of the terminals 910-940. The second retention member 960 may be mounted to the module housing 900 and hold portions of the tail ends 932 of some of the terminals 910-940. The first retention member 950 and the second retention member 960 can help hold the terminals 910-940 in position relative to the module housing 900.

Similar to the module 509, the mating ends of the terminals 910-940 of the module 59 may have different sizes from each other to provide connection ports of different sizes at the mating face 900a. For example, the size of the mating end 941 of the fourth terminal 940 may be greater than the size of the mating end 931 of the third terminal 930, the size of the mating end 931 of the third terminal 930 may be greater than the size of the mating end 921 of the second terminal 920, and the size of the mating end 921 of the second terminal 920 may be greater than the size of the mating end 911 of the first terminal 910.

Further, the number and arrangement of the terminals 910-940 of the module 59 in the module housing 900 may correspond to the number and arrangement of the terminals 810-840 of the module 509 in the module housing 800, so that the module 59 and the module 509 can be mated with each other. For example, the terminals 910-940 of the module 59 may be arranged in a similar manner into a plurality of groups spaced apart in the longitudinal direction Y-Y, with each group having a single terminal or a pair of terminals, wherein the pair of terminals are terminals of the same type, and the mating ends of the pair of terminals are aligned with and spaced apart from each other in the vertical direction Z-Z. The plurality of groups may satisfy the equation [1] described above. The number, locations, and orders of the plurality of groups of the module 59 may correspond to the number, locations, and orders of the plurality of groups of the module 509. Further, the module 59 may be manufactured in a similar process to the module 509. For brevity, details of the similar parts may not be repeated.

The fourth difference between the module 59 and the module 509 is in that the module housing 900 of the module 59 may include a protruding portion 970 protruding from the mating face 900a beyond the mating ends of the terminals 910-940 in the mating direction and elongated in the longitudinal direction Y-Y. Similar to the protruding portions 52b, 56b, and 57b of the modules 52, 56, and 57 described above, the protruding portion 970 of the module 59 is also configured to protect the mating ends of the terminals 910-940 in the form of pins. When the module 59 is disposed in the second housing 21 of the second electrical connector 20, the protruding portion 970 may define a sufficiently small gap between the protruding portion 970 and an inner wall (e.g., the inner wall 61a shown in FIG. 20E) of the accommodation space (e.g., “61-64”) of the second housing 21, so as to prevent the user's finger or similar tool from touching the terminal mating end when extending into the second housing 21 from the opening at the mating face 21a, thereby protecting the terminal mating end from being damaged.

Various aspects are described in this disclosure, which include, but may not be limited to, the following aspects:

1. An electrical connector comprising: a housing comprising a groove elongated in a longitudinal direction, a first constraint structure at least partially in the groove, and a space with openings at a front and a rear of the housing; a cover attached to the rear of the housing; a locking member attached to the cover and pivotable between a pre-locked position and a locked position; and a slider disposed in the groove of the housing and movable in the longitudinal direction between a first position and a second position by the locking member, the slider comprising a second constraint structure configured to engage the first constraint structure of the housing such that the slider is constrained to the first position before the second constraint structure of the slider is disengaged from the first constraint structure of the housing.

2. The electrical connector of aspect 1, wherein the first constraint structure of the housing and the second constraint structure of the slider are configured to be disengaged from each other by a mating component to the electrical connector.

3. The electrical connector of aspect 2, wherein the first constraint structure protrudes into the groove of the housing; and the second constraint structure comprises a resilient arm latched to the first constraint structure at the first position of the slider.

4. The electrical connector of aspect 1, wherein the slider comprises a plurality of cam slots extending at an angle to the longitudinal direction, the plurality of cam slots each open at the front of the housing at the first position of the slider so as to receive cam pins of a mating component to the electrical connector, and blocked at the front of the housing at the second position of the slider so as to retain the cam pins of the mating component therein.

5. The electrical connector of aspect 1, wherein the cover comprises a side wall, first and second protrusions protruding outwardly from the side wall and positioned such that the locking member is pivotable between the first and second protrusions.

6. The electrical connector of aspect 5, wherein the cover comprises a third protrusion configured to engage the locking member and generate an indication that the locking member is at the pre-locked position.

7. The electrical connector of any of aspects 1-6, wherein the cover comprises a groove and an overhanging structure above the groove; and the electrical connector comprises a connector position assurance (CPA) device disposed in the groove of the cover and partially below the overhanging structure, the CPA device movable between a pre-installed position and an installed position.

8. The electrical connector of aspect 7, wherein the CPA device is configured to be held in the pre-installed position by the cover and movable to the installed position by pivoting the locking member to the locked position.

9. The electrical connector of aspect 8, wherein the CPA device comprises a resilient arm configured to engage the overhanging structure of the cover so as to be held in the pre-installed position and disengage from the overhanging structure of the cover by the locking member pivoted to the locked position.

10. The electrical connector of any of aspects 1-6, comprising a plurality of modules disposed in the space of the housing, each of the plurality of modules comprising a module housing and a plurality of conductive terminals held by the module housing, wherein the housing comprises a plurality of latches each configured to engage a respective modules of the plurality of modules.

11. The electrical connector of aspect 10, wherein the cover is hinged to the housing so as to permit opening the rear of the housing to exchange a module without disengaging the hinge.

12. An electrical connector comprising a housing comprising a plurality of cavities each having opening at a front and a rear of the housing, and a plurality of latches each extending into a respective cavity of the plurality of cavities; a plurality of types of modules, each module of the plurality of types of modules comprising a module housing and a plurality of conductive terminals held by the module housing, each module of the plurality of types of modules engaging a respective latch of the plurality of latches in the respective cavity of the plurality of cavities of the housing; and a plurality of key members removably held by the housing above the plurality of cavities, each of the plurality of key members comprising an identification feature indicating the type of module in a respective cavity of the plurality of cavities.

13. The electrical connector of aspect 12, wherein the plurality of key members are disposed adjacent the openings of the plurality of cavities and configured to shape respective openings for respective modules so as to prevent wrong modules from being inserted.

14. The electrical connector of aspect 13, wherein the plurality of key members are aligned in a first row in a longitudinal direction and adjacent the rear of the housing; and the plurality of latches of the housing are aligned in a second row adjacent and parallel to the first row.

15. The electrical connector of aspect 14, wherein the housing comprises a groove elongated in the longitudinal direction; the electrical connector comprises a slider disposed in the groove of the housing and movable in the longitudinal direction between a first position and a second position; and the slider comprises a plurality of cam slots extending at an angle to the longitudinal direction.

16. The electrical connector of aspect 14, wherein the housing comprises a plurality of cam pins aligned in a third row parallel to the first row and separated from the first row of key members by the second row of latches; and each of the plurality of cam pins is disposed between adjacent cavities of the plurality of cavities.

17. An electrical connector comprising a housing member; a plurality of conductive terminals at least partially disposed in the housing member; a locking member attached to the housing member and pivotable between a pre-locked position and a locked position; and a connector position assurance (CPA) device disposed on the housing member, wherein the CPA device is constrained in a pre-installed position by the housing member and movable to an installed position by pivoting the locking member to the locked position.

18. The electrical connector of aspect 17, wherein the housing member comprises a groove and an overhanging structure above the groove; and the CPA device comprises a first resilient arm configured to engage the overhanging structure of the housing member so as to be held in the pre-installed position and disengage from the overhanging structure of the housing member by the locking member pivoted to the locked position.

19. The electrical connector of aspect 18, wherein the overhanging structure is configured to restrain the locking member in the locked position.

20. The electrical connector of aspect 18, wherein the locking member comprises protrusions configured to engage the first resilient arm of the CPA device so as to disengage the first resilient arm of the CPA device from the overhanging structure of the housing member and release the CPA device from the pre-installed position.

21. The electrical connector of aspect 18, wherein the housing member comprises a recess configured to limit the movement of a second resilient arm of the CPA so as to restrain the CPA device in the locked position.

22. The electrical connector of aspect 21, wherein the overhang structure of the housing member comprises an engagement portion configured to extending into an opening of the CPA device so as to restrain the CPA device in the locked position.

23. A module for an electrical connector, comprising a housing comprising a plurality of channels extending therethrough; and a plurality of terminals disposed in the plurality of channels of the housing, each of the plurality of terminals comprising a mating end, a tail end, and an intermediate portion between the mating end and the tail end, wherein the plurality of terminals comprise a plurality of types of power terminals, comprising a first type having a first width in a longitudinal direction perpendicular to a mating direction of the module, and a second type having a second width less than the first width in the longitudinal direction; and a plurality of signal terminals having a third width less than the second width in a longitudinal direction.

24. The module of aspect 23, wherein the housing comprises a plurality of resilient arms extending into respective channels of the plurality of channels and engaging respective terminal disposed in the respective channels so as to retain the respective terminals in the respective channels.

25. The module of aspect 23, comprising a terminal position assurance (TPA) device attached to a front of the housing, the TPA device comprising a plurality of projections extending to contact respective resilient arms of the housing to restrict deflection of the respective resilient arms.

26. The module of aspect 25, wherein the plurality of resilient arms of the housing are disposed in pairs with a first resilient arm extending into an upper channel and a second resilient arm extending into a lower channel; and the plurality of projections of the TPA device extend between the first and second resilient arms of same pairs.

27. A method for manufacturing a module housing for an electrical connector, comprising providing a plurality of types of tool pins, each type of the plurality of types of tool pins corresponding to one of a plurality of types of terminals configured to be disposed in the module housing; aligning the plurality of types of tool pins according to desired locations of the plurality of types of terminals; and flowing a housing material around the aligned plurality of types of tool pins to form the module housing.

28. The method of aspect 27, wherein aligning the plurality of types of tool pins according to desired locations of the plurality of types of terminals comprises stacking the plurality of types of tool pins in an organizer.

29. The method of aspect 28, wherein stacking the plurality of types of tool pins in an organizer comprises providing one or more spacers to fill any gap between the plurality of types of tool pins and the organizer.

30. The method of any of aspects 27-28, wherein the plurality of types of tool pins comprise a first plurality of types of tool pin, each type of the first plurality of types of tool pins corresponding to one of a first plurality of types of terminals configured to be disposed in a first portion of the module housing, and a second plurality of types of tool pins, each type of the second plurality of types of tool pins corresponding to one of a second plurality of types of terminals configured to be disposed in a second portion of the module housing.

31. The method of aspect 30, wherein the first plurality of types of tool pins are stacked in a first direction; the second plurality of types of tool pins are stacked in the first direction; the first portion and the second portion of the module housing are stacked in a second direction perpendicular to the first direction; and the second plurality of types of tool pins are the same or different from the first plurality of types of tool pins.

32. The method of aspect 31, wherein providing the plurality of types of tool pins comprises providing the plurality of types of tool pins according to the equation:

$$A * {W}_{T 1} + B * {W}_{T 2} + C * {W}_{T 3} + D * {W}_{T 4} \leq {W}_{Max}$$

wherein A is the number of a first-type tool pin, B is the number of a second-type tool pin, C is the number of a third-type tool pin, D is the number of a fourth type tool pin, W_{T1} is a width of the first-type tool pin in the first direction, W_{T2} is a width of the second-type tool pin in the first direction, W_{T3} is a width of the third-type tool pin in the first direction, W_{T4} is a width of the fourth-type tool pin in the first direction, and W_{Max} is equal to a width of a slot of the organizer in the first direction.

33. The method of aspect 32, wherein each of W_{T1}, W_{T2}, W_{T3}, W_{T4} is in a range of 1 mm to 6 mm.

34. The method of aspect 32, wherein W_{Max} is in a range of 20 mm to 25 mm.

Having thus described several aspects of several embodiments, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a housing comprising a groove elongated in a longitudinal direction, a first constraint structure at least partially in the groove, and a space with openings at a front and a rear of the housing;
a cover attached to the rear of the housing;
a locking member attached to the cover and pivotable between a pre-locked position and a locked position; and
a slider disposed in the groove of the housing and movable in the longitudinal direction between a first position and a second position by the locking member, the slider comprising a second constraint structure configured to engage the first constraint structure of the housing such that the slider is constrained to the first position before the second constraint structure of the slider is disengaged from the first constraint structure of the housing.

2. The electrical connector of claim 1, wherein:
the first constraint structure of the housing and the second constraint structure of the slider are configured to be disengaged from each other by a mating component to the electrical connector.

3. The electrical connector of claim 2, wherein:
the first constraint structure protrudes into the groove of the housing; and
the second constraint structure comprises a resilient arm latched to the first constraint structure at the first position of the slider.

4. The electrical connector of claim 1, wherein:
the slider comprises a plurality of cam slots extending at an angle to the longitudinal direction, the plurality of cam slots each open at the front of the housing at the first position of the slider so as to receive cam pins of a mating component to the electrical connector, and blocked at the front of the housing at the second position of the slider so as to retain the cam pins of the mating component therein.

5. The electrical connector of claim 1, wherein:
the cover comprises a side wall, first and second protrusions protruding outwardly from the side wall and positioned such that the locking member is pivotable between the first and second protrusions; and a third protrusion configured to engage the locking member and generate an indication that the locking member is at the pre-locked position.

6. The electrical connector of claim 1, wherein:
the cover comprises a groove and an overhanging structure above the groove; and
the electrical connector comprises a connector position assurance (CPA) device disposed in the groove of the cover and partially below the overhanging structure, the CPA device movable between a pre-installed position and an installed position.

7. The electrical connector of claim 6, wherein:
the CPA device is configured to be held in the pre-installed position by the cover and movable to the installed position by pivoting the locking member to the locked position.

8. The electrical connector of claim 7, wherein:
the CPA device comprises a resilient arm configured to engage the overhanging structure of the cover so as to be held in the pre-installed position and disengage from the overhanging structure of the cover by the locking member pivoted to the locked position.

9. The electrical connector of claim 1, comprising:
a plurality of modules disposed in the space of the housing, each of the plurality of modules comprising a module housing and a plurality of conductive terminals held by the module housing, wherein:
the housing comprises a plurality of latches each configured to engage a respective modules of the plurality of modules; and
the cover is hinged to the housing so as to permit opening the rear of the housing to exchange a module without disengaging the hinge.

10. An electrical connector comprising:
a housing comprising a plurality of cavities each having opening at a front and a rear of the housing, and a plurality of latches each extending into a respective cavity of the plurality of cavities;
a plurality of types of modules, each module of the plurality of types of modules comprising a module housing and a plurality of conductive terminals held by the module housing, each module of the plurality of types of modules engaging a respective latch of the plurality of latches in the respective cavity of the plurality of cavities of the housing; and
a plurality of key members removably held by the housing above the plurality of cavities, each of the plurality of key members comprising an identification feature indicating the type of module in a respective cavity of the plurality of cavities.

11. The electrical connector of claim 10, wherein:
the plurality of key members are disposed adjacent the openings of the plurality of cavities and configured to shape respective openings for respective modules so as to prevent wrong modules from being inserted.

12. The electrical connector of claim 11, wherein:
the plurality of key members are aligned in a first row in a longitudinal direction and adjacent the rear of the housing; and
the plurality of latches of the housing are aligned in a second row adjacent and parallel to the first row.

13. The electrical connector of claim 12, wherein:
the housing comprises a groove elongated in the longitudinal direction;
the electrical connector comprises a slider disposed in the groove of the housing and movable in the longitudinal direction between a first position and a second position; and
the slider comprises a plurality of cam slots extending at an angle to the longitudinal direction.

14. The electrical connector of claim 12, wherein:
the housing comprises a plurality of cam pins aligned in a third row parallel to the first row and separated from the first row of key members by the second row of latches; and
each of the plurality of cam pins is disposed between adjacent cavities of the plurality of cavities.

15. An electrical connector comprising:
a housing member;
a plurality of conductive terminals at least partially disposed in the housing member;
a locking member attached to the housing member and pivotable between a pre-locked position and a locked position; and
a connector position assurance (CPA) device disposed on the housing member, wherein the CPA device is constrained in a pre-installed position by the housing member and movable to an installed position by pivoting the locking member to the locked position.

16. The electrical connector of claim 15, wherein:
the housing member comprises a groove and an overhanging structure above the groove; and
the CPA device comprises a first resilient arm configured to engage the overhanging structure of the housing member so as to be held in the pre-installed position and disengage from the overhanging structure of the housing member by the locking member pivoted to the locked position.

17. The electrical connector of claim 16, wherein:
the overhanging structure is configured to restrain the locking member in the locked position.

18. The electrical connector of claim 16, wherein:
the locking member comprises protrusions configured to engage the first resilient arm of the CPA device so as to disengage the first resilient arm of the CPA device from the overhanging structure of the housing member and release the CPA device from the pre-installed position.

19. The electrical connector of claim 16, wherein:
the housing member comprises a recess configured to limit movement of a second resilient arm of the CPA so as to restrain the CPA device in the locked position.

20. The electrical connector of claim 19, wherein:
the overhang structure of the housing member comprises an engagement portion configured to extending into an opening of the CPA device so as to restrain the CPA device in the locked position.
